(19) United States
(12) Patent Application Publication
(10) Pub. No.: US 2025/0382150 A1
(43) Pub. Date: Dec. 18, 2025

(54) MEDIUM PROCESSING APPARATUS AND IMAGE FORMING SYSTEM

(71) Applicants: Kohta ABE, Kanagawa (JP); Kei SASAKI, Kanagawa (JP); Nobuyoshi SUZUKI, Kanagawa (JP); Mitsuhiro SUGAWARA, Kanagawa (JP); Keisuke SUGIYAMA, Kanagawa (JP); Kazuki SETO, Kanagawa (JP); Shohei SAITO, Kanagawa (JP); Sachika TAMAKI, Kanagawa (JP); Takashi YAMAMOTO, Kanagawa (JP)

(72) Inventors: Kohta ABE, Kanagawa (JP); Kei SASAKI, Kanagawa (JP); Nobuyoshi SUZUKI, Kanagawa (JP); Mitsuhiro SUGAWARA, Kanagawa (JP); Keisuke SUGIYAMA, Kanagawa (JP); Kazuki SETO, Kanagawa (JP); Shohei SAITO, Kanagawa (JP); Sachika TAMAKI, Kanagawa (JP); Takashi YAMAMOTO, Kanagawa (JP)

(73) Assignee: Ricoh Company, Ltd., Tokyo (JP)

(21) Appl. No.: 19/222,608

(22) Filed: May 29, 2025

(30) Foreign Application Priority Data
Jun. 12, 2024 (JP) 2024-095442

(51) Int. Cl. B65H 37/04; G03G 15/00

(52) U.S. Cl. CPC B65H 37/04; G03G 15/6544; B65H 2301/51611; B65H 2301/51616; G03G 2215/00827

(57) ABSTRACT

A medium processing apparatus includes a liquid application member to contact a medium to apply liquid to the medium, a movement mechanism to move the liquid application member close to or away from the medium, and a liquid-application sensor to determine whether the liquid application member has passed through a detection area of the liquid-application sensor when the liquid application member is moved close to or away from the medium. When the liquid application member is moved close to the medium, the movement mechanism moves the liquid application member at a first speed to get close to the medium after the liquid application member has passed through the detection area, and moves the liquid application member at a second speed slower than the first speed to get close to the medium until the liquid application member passes through the detection area.

### CROSS-REFERENCE TO RELATED APPLICATION

This patent application is based on and claims priority pursuant to 35 U.S.C. § 119 (a) to Japanese Patent Application No. 2024-095442, filed on Jun. 12, 2024, in the Japan Patent Office, the entire disclosure of which is hereby incorporated by reference herein.

### BACKGROUND

### Technical Field

The present disclosure relates to a medium processing apparatus and an image forming system.

### Background Art

A plurality of sheet media are stacked on top of each other to form a sheet bundle, and medium processing apparatuses have been proposed that perform given processing on a sheet bundle. Some medium processing apparatuses bind a sheet bundle with metal staples, and such binding with metal staples is referred to as stapling. Currently, medium processing apparatuses have been proposed that perform binding without metal staples from the viewpoint of saving resources and reducing environmental load. In such binding without metal staples, for example, a sheet bundle is pressed and deformed, and such binding is referred to as crimp binding.

Sheets of paper are widely known as an example of sheet media. In the following description, a bundle of sheets may be referred to as a sheet bundle.

For the purposes of increasing the binding strength, some medium processing apparatuses that perform crimp binding have a function to apply liquid to sheets that are not yet bound.

For the purposes of increasing the number of sheets of a sheet bundle that can be bound with strength whose level is equal to or greater than a certain level, some apparatuses that perform crimp binding and liquid application apply liquid to a sheet bundle to be bound.

### SUMMARY

The present disclosure described herein provides a medium processing apparatus including a liquid application member to contact a medium to apply liquid to the medium, a movement mechanism to move the liquid application member close to or away from the medium, and a liquid-application sensor to determine whether the liquid application member has passed through a detection area of the liquid-application sensor when the liquid application member is moved close to or away from the medium. When the liquid application member is moved close to the medium, the movement mechanism moves the liquid application member at a first speed to get close to the medium after the liquid application member has passed through the detection area, and moves the liquid application member at a second speed slower than the first speed to get close to the medium until the liquid application member passes through the detection area.

### BRIEF DESCRIPTION OF THE DRAWINGS

A more complete appreciation of embodiments and the many attendant advantages thereof will be readily obtained as the same becomes better understood by reference to the following detailed description when considered in connection with the accompanying drawings.

FIG. 1 is a diagram illustrating an overall configuration of an image forming system.

FIG. 2 is a diagram illustrating an internal structure of a post-processing apparatus according to a first embodiment of the present disclosure.

FIG. 3 is a schematic view of an upstream side of an edge binder of the post-processing apparatus of FIG. 2 in a conveyance direction.

FIG. 4 is a schematic view of an edge binder viewed from a liquid applier in a main scanning direction.

FIG. 5A and FIG. 5B are schematic diagrams illustrating a configuration of a crimper of an edge binder.

FIG. 6 is a diagram illustrating an edge binder according to a modification.

FIG. 7A to FIG. 7C are diagrams illustrating a liquid application crimper of an edge binder according to a modification.

FIG. 8A to FIG. 8C are diagrams illustrating a liquid applying operation and crimping and binding operation performed by the liquid application crimper of FIG. 7A to FIG. 7C.

FIG. 9 is a schematic view of a staple binder viewed from an upstream side in a conveyance direction.

FIG. 10 is a schematic view of a staple binder according to a modification, viewed from an upstream side in a conveyance direction.

FIG. 11 is a block diagram illustrating the hardware configuration of controlling operations of the post-processing apparatus according to the first embodiment.

FIG. 12 is a flowchart of the binding performed by an edge binder.

FIG. 13A to FIG. 13D are diagrams illustrating the positions of a liquid applier and a crimper during the binding performed by an edge binder.

FIG. 14A to FIG. 14H are diagrams illustrating the positions of a liquid applier and a crimper during the binding performed by an edge binder.

FIG. 15 is a schematic view of an edge binder of a post-processing apparatus according to a modification of the first embodiment, viewed from an upstream side of the edge binder in the conveyance direction.

FIG. 16 is a schematic view of an edge binder of a post-processing apparatus according to a modification of the first embodiment, viewed from an upstream side of the edge binder in the main scanning direction.

FIG. 17 is a diagram illustrating operating status of an edge binder according to the first embodiment.

FIG. 18 is a diagram illustrating operating status of an edge binder according to the first embodiment.

FIG. 19 is a diagram illustrating operating status of an edge binder according to the first embodiment.

FIG. 20 is a diagram illustrating operating status of an edge binder according to the first embodiment.

FIG. 21 is a diagram illustrating speed control of an edge binder according to the related art.

FIG. 22 is a diagram illustrating the relative positions of a liquid application member and a sheet and the relative positions of the liquid application member and a target position when no liquid is applied.

FIG. 23 is a diagram illustrating speed control of an edge binder according to a first example.

FIG. 24 is a flowchart of speed control according to the first example.

FIG. 25 is a diagram illustrating speed control according to a second example.

FIG. 26A and FIG. 26B are diagrams illustrating a user interface used for speed control, according to the second embodiment.

FIG. 27 is a flowchart of speed control according to the second example.

FIG. 28 is a diagram illustrating speed control according to a third example.

FIG. 29 is a diagram illustrating speed control according to a fourth example.

FIG. 30 is a flowchart of speed control according to the fourth example.

FIG. 31 is a flowchart of speed control according to the fourth example.

FIG. 32 is a diagram illustrating an internal structure of a post-processing apparatus according to a second embodiment.

FIG. 33A to FIG. 33C are schematic views of an internal tray according to the second embodiment, viewed from the thickness direction of a sheet.

FIG. 34 is a schematic view of a crimper of the post-processing apparatus of FIG. 32 according to the second embodiment, viewed from an upstream side in a conveyance direction.

FIG. 35A and FIG. 35B are schematic views of a liquid applier of a post-processing apparatus according to the second embodiment, viewed from the thickness direction of a sheet.

FIG. 36A to FIG. 36C are sectional views of a liquid applier, taken along a line XXV-XXV of FIG. 35A.

FIG. 37A to FIG. 37C are sectional views of a liquid applier taken along a line XXVI-XXVI of FIG. 35A.

FIG. 38 is a block diagram illustrating a hardware configuration of a post-processing apparatus according to the second embodiment to control the operation of the post-processing apparatus.

FIG. 39 is a flowchart of post-processing performed by a post-processing apparatus according to the second embodiment.

FIG. 40 is a diagram illustrating an overall configuration of an image forming system according to a modification.

FIG. 41A and FIG. 41B are diagrams each of which illustrates a post-processing apparatus including a controller, according to a first modification.

FIG. 42A and FIG. 42B are diagrams each of which illustrates a post-processing apparatus including a controller, according to a second modification.

FIG. 43 is another diagram illustrating speed control according to the second example.

The accompanying drawings are intended to depict embodiments of the present disclosure and should not be interpreted to limit the scope thereof. The accompanying drawings are not to be considered as drawn to scale unless explicitly noted.

### DETAILED DESCRIPTION

The terminology used herein is for the purpose of describing particular embodiments only and is not intended to limit the present disclosure. As used herein, the singular forms “a”, “an”, and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

In describing embodiments illustrated in the drawings, specific terminology is employed for the sake of clarity. However, the present disclosure is not intended to be limited to the specific terminology so selected and it is to be understood that each specific element includes all technical equivalents that have the same structure, operate in a similar manner, and achieve a similar result.

An image forming system 1 is described below with reference to the accompanying drawings.

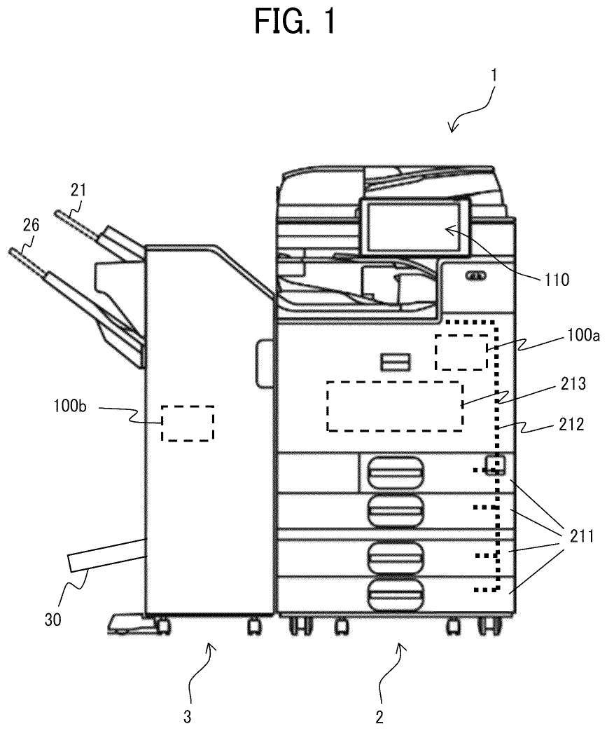

FIG. 1 is a diagram illustrating an overall configuration of the image forming system 1.

The image forming system 1 has, for example, an image forming function of forming an image on a sheet P as an example of a sheet medium and a post-processing function of performing predetermined post-processing on the sheet P on which the image has been formed. As illustrated in FIG. 1, the image forming system 1 includes an image forming apparatus 2 having the image forming function and a post-processing apparatus 3 that is an example of a medium processing apparatus having the post-processing function, according to an embodiment of the present disclosure. In the image forming system 1, the image forming apparatus 2 and the post-processing apparatus 3 operate in conjunction with each other.

In the present embodiment, the sheet medium to be processed in the image forming system 1 is assumed to be a sheet of paper. However, the object to be processed according to the present embodiment is not limited to a sheet of paper. For example, any type of medium can be used as long as an image can be formed on the medium according to an image forming process. Examples of the medium include a medium that can be an object of folding or binding, and the material and specification of the medium are not limited to any particular material and specification.

The image forming apparatus 2 forms an image on the sheet P and ejects the sheet P having the image to the post-processing apparatus 3. The image forming apparatus 2 includes an accommodation tray 211 that accommodates sheets P, a conveyor 212 that conveys a sheet P from the accommodation tray 211, and an image forming device 213 that forms an image on the sheet P conveyed by the conveyor 212. The image forming device 213 may be an inkjet system that forms an image using an inkjet system or an electrophotographic system that forms an image with toner. The image forming apparatus 2 also includes a controller 100a that controls various kinds of operations of the conveyor 212 and the image forming device 213.

Sheets of paper are widely used as sheet media. In the following description, a sheet-shaped medium as a medium to be processed is referred to as a “sheet P.” Further, in the following description, a bundle of sheets of paper as a plurality of media is an example of a sheet bundle Pb.

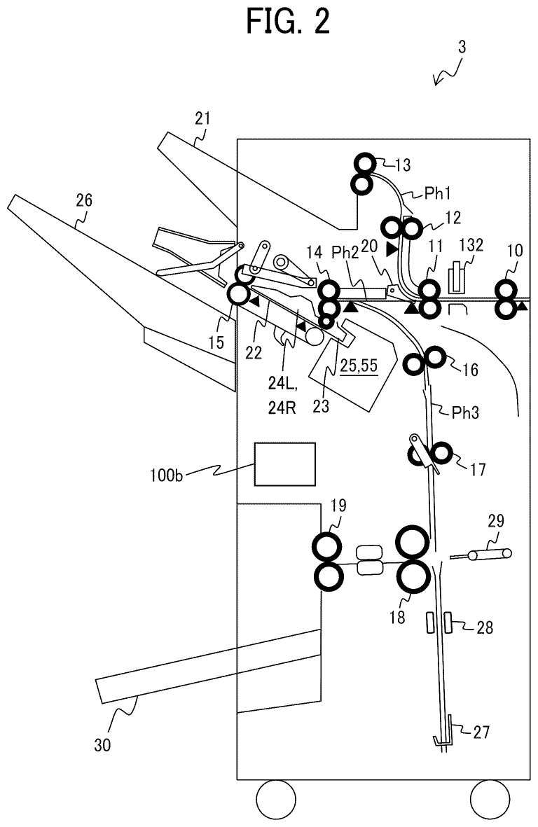

FIG. 2 is a diagram illustrating an internal structure of the post-processing apparatus 3 according to the first embodiment.

The post-processing apparatus 3 has a function to perform predetermined post-processing on the sheet P on which an image has been formed by the image forming apparatus 2. An example of the post-processing according to the present embodiment is crimp binding that binds, without staples, a plurality of sheets P on each of which an image is formed as a bundle of sheets, which may be referred to as a sheet bundle. Another example of the post-processing according to the present embodiment is binding as a stapling that binds, with staples, a plurality of sheets P on each of which an image is formed as a bundle of sheets P (i.e., sheet bundle). A bundle of sheets P that is an example of a medium bundle may be referred to as a sheet bundle Pb in the following description.

In the present embodiment, how the liquid is applied when crimp binding is to be performed is described. However, liquid application performed in a stapling process is similar to the liquid application in the crimp binding. In the following description, the term binding indicates both crimping and the stapling, and is not limited to a particular binding method that adopts staples or pressure-deforming.

More specifically, in the crimp binding according to the present embodiment, pressure is applied to the binding position that corresponds to a part of a sheet bundle Pb to deform or pressure-deform the binding position and bind the sheet bundle Pb. The binding that is executed by the post-processing apparatus 3 includes edge binding and saddle binding. The edge binding is a process to bind an end or edge of the sheet bundle Pb. The saddle binding, which may be referred to as saddle stitching in the following description, is a process to bind the central portion of the sheet bundle Pb.

The post-processing apparatus 3 includes conveyance roller pairs 10 to 19 (an example of conveyors), a switching member 20, and a controller 100b (an example of a control device). The controller 100b controls the operations of, for example, the conveyance roller pairs 10 to 19 (an example of conveyors), and the switching member 20. The controller 100b will be described later in detail. The conveyance roller pairs 10 to 19 convey, inside the post-processing apparatus 3, a sheet P supplied from the image forming apparatus 2. More specifically, the conveyance roller pairs 10 to 13 convey the sheet P along a first conveyance path Ph1. The conveyance roller pairs 14 and 15 convey the sheet P along a second conveyance path Ph2. The conveyance roller pairs 16 to 19 convey the sheet P along a third conveyance path Ph3. A hole punch 132 is disposed between the conveyance roller pairs 10 and 11. The hole punch 132 performs punching on the sheet P conveyed by the conveyance roller pairs 10 and 11.

The first conveyance path Ph1 is a passage extending to a first output tray 21 from a supply port through which the sheet P is supplied from the image forming apparatus 2. The second conveyance path Ph2 is a passage branching from the first conveyance path Ph1 between the conveyance roller pairs 11 and 14 in a conveyance direction and extending to a second output tray 26 via an internal tray 22. The third conveyance path Ph3 is a passage branching from the first conveyance path Ph1 between the conveyance roller pairs 11 and 14 in the conveyance direction and extending to an output tray 30.

The switching member 20 is arranged at a branching position of the first conveyance path Ph1 and the second conveyance path Ph2. The switching member 20 can be switched between a first position and a second position. The switching member in the first position guides the sheet P to be ejected to the first output tray 21 through the first conveyance path Ph1. The switching member 20 in the second position guides the sheet P conveyed through the first conveyance path Ph1 to the second conveyance path Ph2. When a trailing end of the sheet P entering the second conveyance path Ph2 passes through the conveyance roller pair 11, the conveyance roller pair 14 is rotated in reverse to guide the sheet P to the third conveyance path Ph3. The post-processing apparatus 3 further includes a plurality of sensors that detects the positions of the sheet P in the first conveyance path Ph1, the second conveyance path Ph2, and the third conveyance path Ph3. Each of the multiple sensors is indicated by a black triangle in FIG. 2.

The post-processing apparatus 3 includes the first output tray 21. The sheet P that is ejected through the first conveyance path Ph1 rests on the first output tray 21. Among the sheets P supplied from the image forming apparatus 2, the sheets P that are not bound are ejected to the first output tray 21.

The post-processing apparatus 3 further includes the internal tray 22 as a receptacle, an end fence 23, side fences 24L and 24R, an edge binder 25, a staple binder 55, and the second output tray 26. The internal tray 22, the end fence 23, the side fences 24L and 24R, the edge binder 25, and the staple binder 55 perform edge binding on the sheet bundle Pb including multiple sheets P conveyed from the second conveyance path Ph2 to the internal tray 22. Among the sheets P supplied from the image forming apparatus 2, the sheet bundle Pb subjected to the edge binding is ejected to the second output tray 26.

The edge binding in the present embodiment includes parallel stitching, oblique stitching, and vertical stitching. The parallel binding is a process to perform stitching along one side of the sheet bundle Pb parallel to the main scanning direction. The oblique stitching is a process to perform stitching at a corner of the sheet bundle Pb. The vertical binding is a process to perform binding at a plurality of positions spaced apart from each other in the width direction along one side of the sheet bundle Pb parallel to the conveyance direction.

In the following description, a direction in which the sheet P is conveyed from the conveyance roller pair 15 toward the end fence 23 is defined as a “conveyance direction.” In other words, the “conveyance direction” herein corresponds to a direction in which the sheet P that has been output from the image forming apparatus 2 is moved toward the second output tray 26 by, for example, the conveyance roller pair 10, is changed to move toward the end fence 23 by the conveyance roller pair 15 in a direction different from the above-described direction. The direction that is orthogonal to both the conveyance direction and a thickness direction of the sheet P is defined as a “main scanning direction” or a “width direction of the sheet P.”

The sheets P that are sequentially conveyed through the second conveyance path Ph2 are temporarily placed on the internal tray 22 as a receptacle. The end fence 23 aligns the position, in the conveyance direction, of the sheet P or the sheet bundle Pb placed on the internal tray 22. The side fences 24L and 24R align the position, in the main scanning direction, of the sheet P or the sheet bundle Pb placed on the internal tray 22. The edge binder 25 and the staple binder 55 bind an end of the sheet bundle Pb aligned by the end fence 23 and the side fences 24L and 24R. Then, the conveyance roller pair 15 ejects the sheet bundle Pb subjected to the edge binding to the second output tray 26.

The post-processing apparatus 3 further includes an end fence 27, a saddle binder 28, a sheet folding blade 29, and the output tray 30. The end fence 27, the saddle binder 28, and the sheet folding blade 29 perform saddle binding on a sheet bundle Pb foamed of the sheets P that are conveyed through the third conveyance path Ph3. Among the sheets P supplied from the image forming apparatus 2, the sheet bundle Pb subjected to the saddle binding is ejected to the output tray 30.

The end fence 27 aligns the positions of the sheets P that are sequentially conveyed through the third conveyance path Ph3, in a conveyance direction in which the sheets P are conveyed. The end fence 27 can move between a binding position where the end fence 27 causes the center of the sheet bundle Pb to face the saddle binder 28 and a folding position where the end fence 27 causes the center of the sheet bundle Pb to face the sheet folding blade 29. The saddle binder 28 binds the center of the sheet bundle Pb aligned by the end fence 27 at the binding position. The sheet folding blade 29 folds, in half, the sheet bundle Pb placed on the end fence 27 at the folding position and causes the conveyance roller pair 18 to nip the sheet bundle Pb. The conveyance roller pairs 18 and 19 eject the sheet bundle Pb subjected to the saddle binding to the output tray 30.

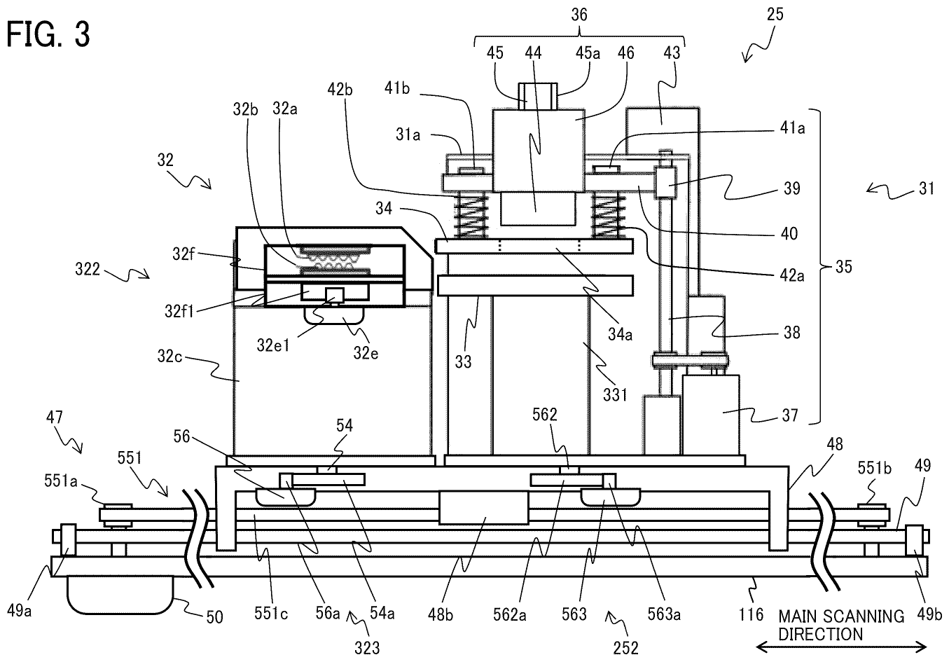

FIG. 3 is a schematic diagram illustrating an upstream side of the edge binder in the conveyance direction. The edge binder 25 performs liquid application and crimp binding illustrated in FIG. 2.

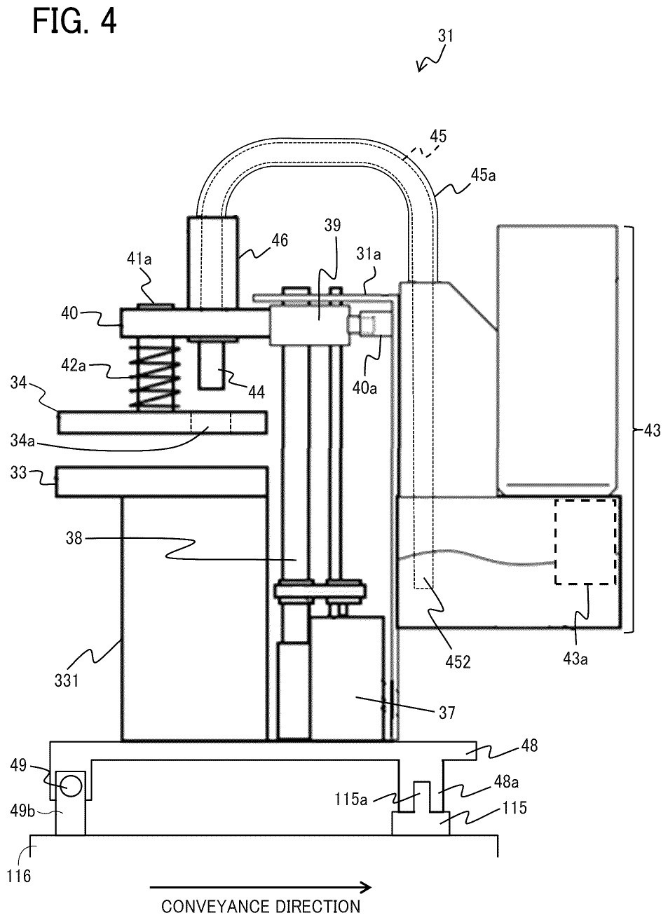

FIG. 4 is a schematic view of a liquid applier 31 of the edge binder 25 in the main scanning direction.

As illustrated in FIG. 3 and FIG. 4, the edge binder 25 includes a liquid applier 31 that applies liquid to the sheets P, and a crimper 32 that is an example of a postprocessor and performs crimping binding on the sheet bundle Pb. The liquid applier 31 and the crimper 32 are disposed adjacent to each other in the main scanning direction downstream from the internal tray 22 in the conveyance direction.

As illustrated in FIG. 4, the liquid applier 31 applies the liquid stored in the first liquid storage tank 43 to the sheet P or the sheet bundle Pb placed on the internal tray 22. In the following description, applying liquid to a sheet P or a sheet bundle Pb by the liquid applier 31 and the operation of the liquid applier 31 when the liquid is applied may be referred to as liquid application. The liquid application operation of the liquid applier 31 accompanied by the control process is referred to as a “liquid application process.”

More specifically, the liquid that is stored in the first liquid storage tank 43 as liquid for the “liquid application” includes, as a main component, the liquid state of a compound of hydrogen and oxygen compound represented by the chemical formula H2O. The temperature condition is not limited, and the liquid hydrogen-oxygen compound may be so-called warm water or hot water. The liquid hydrogen-oxygen compound is not limited to pure water. The liquid hydrogen-oxygen compound may be purified water or may contain ionized salts. The metal ion content ranges from so-called soft water to ultrahard water. In other words, the liquid hydrogen-oxygen compound is at any hardness.

The liquid may include an additive in addition to the main component. The liquid may include residual chlorine used as tap water. Preferably, for example, the liquid may include, as an additive, a colorant, a penetrant, a pH adjuster, a preservative such as phenoxyethanol, a drying inhibitor such as glycerin, or a combination thereof. Furthermore, because water is used as a component of ink used for inkjet printers or ink used for water-based pens, such water or ink may be used for the “liquid application”.

The water is not limited to the specific examples described above. The water may be water in a broad sense such as hypochlorous acid water or an ethanol aqueous solution diluted for disinfection. However, tap water may be used simply to enhance the binding strength after the binding because tap water is easy to obtain and store. A liquid including water as a main component as exemplified above can enhance the binding strength of the sheet bundle Pb, as compared with a liquid of which the main component is not water.

As illustrated in FIG. 3 and FIG. 4, the liquid applier 31 can be moved in the main scanning direction together with the crimper 32 by the driving force transmitted from the edge-binder movement motor 50. The liquid applier 31 includes a lower pressure plate 33 that is an example of a placement table for the sheet P or the sheet bundle Pb, an upper pressure plate 34, a liquid-applier movement assembly 35, and a liquid application assembly 36. The components of the liquid applier 31, which include the lower pressure plate 33, the upper pressure plate 34, the liquid-applier movement assembly 35, the liquid application assembly 36, and the liquid-applier movement motor 37, are held by the liquid application frame 31a and the base 48.

As illustrated in FIG. 3, the liquid applier 31 is provided with a liquid-applier rotation assembly 252. The liquid-applier rotation assembly 252 includes a liquid-applier pivot motor 563, an output gear 563a, and a drive transmission gear 562a, which will be described later in detail. A liquid applier shaft 562 provided with a drive transmission gear 562a is fixed to a bottom face of the liquid application frame 31a that holds the components of the liquid applier 31. The liquid applier shaft 562 and the drive transmission gear 562a are held by the base 48 on which the liquid application frame 31a is disposed, so as to be rotatable in both forward and reverse directions.

The drive transmission gear 562a meshes with an output gear 563a of a liquid-applier pivot motor 563. The liquid applier 31 can be rotated in both forward and reverse directions about the liquid applier shaft 562 on the base 48 by a driving force transmitted from the liquid-applier pivot motor 563 to the liquid applier shaft 562 via the output gear 563a and the drive transmission gear 562a.

The lower pressure plate 33 and the upper pressure plate 34 are disposed downstream from the internal tray 22 in the conveyance direction. The sheets P or the sheet bundle Pb that is placed on the internal tray 22 is also placed on the lower pressure plate 33. The lower pressure plate 33 is disposed on a lower pressure plate holder 331. The upper pressure plate 34 is movable in the thickness direction of the sheet P or the sheet bundle Pb at a position where the upper pressure plate 34 faces the sheet P or the sheet bundle Pb placed on the internal tray 22.

In other words, the lower pressure plate 33 and the upper pressure plate 34 are disposed to face each other in the thickness direction of the sheet P or the sheet bundle Pb with the sheet P or the sheet bundle Pb placed on the internal tray 22 and interposed between the lower pressure plate 33 and the upper pressure plate 34. In the following description, the thickness direction of the sheet P or the sheet bundle Pb may be referred to simply as “thickness direction.” Further, the upper pressure plate 34 is provided with a through hole 34a passing through the upper pressure plate 34 in the thickness direction at a position opposite to the liquid application member 44 held via the joint 46 attached to the base plate 40. The liquid application member 44 is one end of a liquid supply member 45, which serves as a liquid absorber and will be described later in detail, and corresponds to a tip of the liquid supply member 45.

The liquid-applier movement assembly 35 moves the upper pressure plate 34, the base plate 40, a joint 46, and the liquid application member 44 in the thickness direction of the sheet P or the sheet bundle Pb. The liquid-applier movement assembly moves the upper pressure plate 34, the base plate 40, the joint 46, and the liquid application member 44 in conjunction with each other with a single liquid-applier movement motor 37. The liquid-applier movement assembly 35 includes, for example, the liquid-applier movement motor 37, a trapezoidal screw 38, a nut 39, the base plate 40, columns 41a and 41b, and coil springs 42a and 42b.

The liquid-applier movement motor 37 generates driving force to move the upper pressure plate 34, the base plate 40, the joint 46, and the liquid application member 44. The trapezoidal screw 38 extends in the thickness direction of the sheet P or the sheet bundle Pb and is provided with the liquid application frame 31a such that the trapezoidal screw 38 is rotatable in both forward and reverse directions. The trapezoidal screw 38 is coupled to an output shaft of the liquid-applier movement motor 37 via, for example, a pulley and a belt. The nut 39 is screwed to the trapezoidal screw 38. The trapezoidal screw 38 is rotated in both forward and reverse directions by the driving force transmitted from the liquid-applier movement motor 37. The rotation of the trapezoidal screw 38 causes the nut 39 to reciprocate on the trapezoidal screw 38.

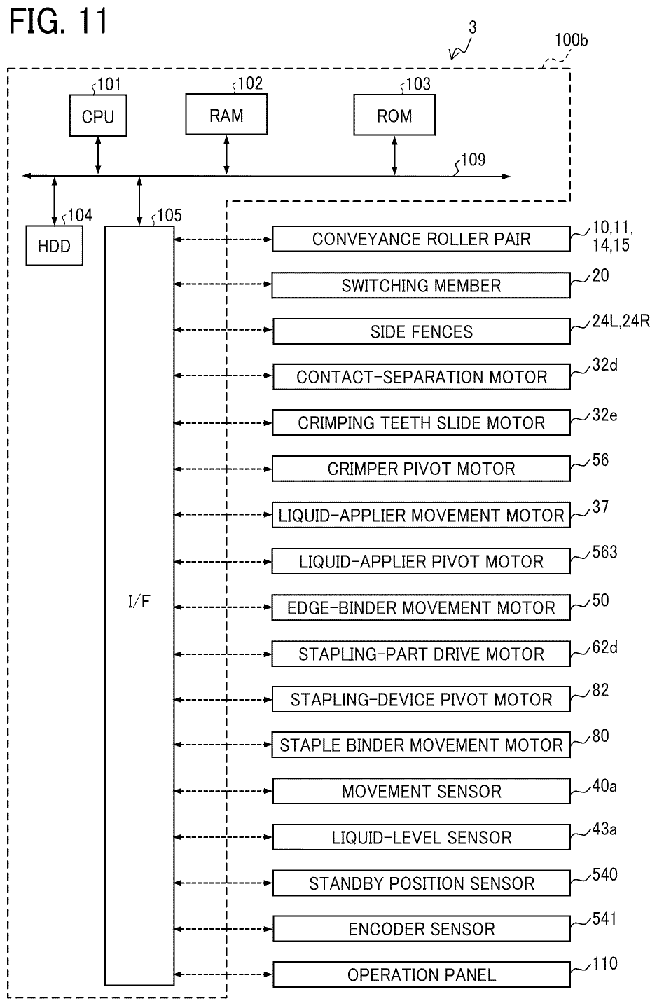

The base plate 40 is positioned apart from the upper pressure plate 34. The base plate 40 holds the liquid application member 44 with the tip of the liquid application member 44 protruding from the base plate 40 to the upper pressure plate 34. The base plate 40 is coupled to the trapezoidal screw 38 via the nut 39 such that base plate 40 can reciprocate along the trapezoidal screw 38 as the trapezoidal screw 38 rotates in both forward and reverse directions. The position of the base plate 40 in the vertical direction is detected by a movement sensor 40a (see FIG. 11).

The columns 41a and 41b project from the base plate 40 to the upper pressure plate 34 around the tip of the liquid application member 44. The columns 41a and 41b can be moved relative to the base plate 40 in the thickness direction. The columns 41a and 41b hold the upper pressure plate 34 with the respective ends closer to the lower pressure plate 33 than the other ends of the columns 41a and 41b. The other ends of the columns 41a and 41b opposite the ends closer to the lower pressure plate 33 are provided with stoppers that prevent the columns 41a and 41b from being removed from the base plate 40.

The coil springs 42a and 42b are fitted around the columns 41a and 41b, respectively, between the base plate 40 and the upper pressure plate 34. The coil springs 42a and 42b bias the upper pressure plate 34 and the columns 41a and 41b toward the lower pressure plate 33 with respect to the base plate 40.

The liquid application assembly 36 applies liquid to the sheet P or the sheet bundle Pb placed on the internal tray 22. Specifically, the liquid application assembly 36 brings the liquid application member 44 into contact with the sheet P or the sheet bundle Pb to apply the liquid to at least one sheet P of the sheet bundle Pb.

The liquid application assembly 36 includes the liquid application member 44, the liquid supply member 45, the first liquid storage tank 43, and the joint 46. The first liquid storage tank 43 stores the liquid to be supplied to the sheet P or the sheet bundle Pb. The liquid stored in the first liquid storage tank 43 is detected by a liquid level sensor 43a that is an example of a first liquid detector.

The liquid application member 44 applies the liquid stored in the first liquid storage tank 43 to the sheet P or the sheet bundle Pb. The liquid application member 44 is held by the base plate 40 with the tip of the liquid application member 44 facing the upper pressure plate 34.

Further, the liquid application member 44 includes a material having a relatively high liquid absorption rate. For example, the liquid application member 44 includes an open-cell foam that can contain liquid. The liquid application member 44 is not limited to a particular kind as long as the liquid application member 44 is made of a material having a property of absorbing and holding the liquid and has a property of being crushable in accordance with a pressing force applied when the liquid application member 44 is in contact with the sheet P. The pressing force corresponds to an amount of movement of the liquid application member 44 to the sheet P (or the sheet bundle Pb). For example, the liquid application member 451 may be a foam material such as a sponge or a fiber material that can absorb liquid by capillary action.

The liquid supply member 45, which serves as a liquid absorber, is a long member having an immersion portion 452 at a base end immersed in the liquid stored in the first liquid storage tank 43 and a tip coupled to the liquid application member 44. In a similar manner to the liquid application member 44, for example, the liquid supply member 45 is made of a material having a relatively high liquid absorption rate. As a result, the liquid absorbed from the immersion portion 452 of the liquid supply member is supplied to the liquid application member 44 by the capillary action. In other words, the liquid stored in the first liquid storage tank 43 is sucked up from the immersion portion 452 of the liquid supply member 45, and the sucked liquid is supplied to the liquid application member 44 that is coupled to the tip via the liquid supply member 45.

As described above, the liquid sucked up from the immersion portion 452 of the liquid supply member 45 is supplied to the liquid application member 44 through the liquid supply member 45, and the liquid application member 44 contacts the upper face of an uppermost sheet of the sheets P or the sheet bundle Pb to apply the liquid.

Although the case where the liquid supply member 45 and the liquid application member 44 are separate bodies has been described above, the liquid supply member 45 and the liquid application member 44 may be integrally formed of a material having the same properties (e.g., a material having a high liquid absorption rate). In other words, the liquid application member 44 may be part of the liquid supply member 45. In such a case, liquid can be supplied from the liquid supply member 45 to the liquid application member 44 more smoothly by the capillary action.

A protector 45a is an elongated cylindrical body (e.g., a tube) that is fitted around the liquid supply member 45. Such a configuration prevents the liquid absorbed by the liquid supply member 45 from leaking or evaporating. Each of the liquid supply member 45 and the protector 45a is made of a flexible material. The joint 46 holds the liquid application member 44 and is arranged on the base plate 40. Accordingly, even when the liquid application member 44 is moved by the liquid-applier movement assembly 35 in a direction orthogonal to the conveyance direction and the main scanning direction, the liquid application member 44 keeps projecting from the base plate 40 toward the upper pressure plate 34 with the tip of the liquid application member 44 facing the upper pressure plate 34.

In the liquid application process, the controller 100 controls the amount of movement (pressing amount) of the liquid application member 44 to the sheet P or the sheet bundle Pb by controlling the amount of driving force of the liquid-applier movement motor 37. By controlling the amount of movement of the liquid application member 44 relative to the sheet P or the sheet bundle Pb, the size of a contact area where the liquid application member 44 contacts the sheet P or the sheet bundle Pb is adjusted, or the length of time that the liquid application member 44 contacts the sheet P or the sheet bundle Pb, which may be referred to as contact time (208-c) in the following description, is adjusted. With this adjustment, the amount of liquid applied to the sheet P or the sheet bundle Pb and the spread of the liquid in the liquid application process can be adjusted.

As illustrated in FIG. 3, the crimper 32 that is an example of a postprocessor presses and deforms at least a portion (liquid application position) of the sheet bundle Pb, to which liquid has been applied by the liquid applier 31, by upper crimping teeth 32a and lower crimping teeth 32b that are serrated, and crimps the sheets P of the portion to bind the sheet bundle Pb. In short, the crimper 32 binds the sheet bundle Pb without staples. The components of the crimper 32 such as the upper crimping teeth 32a and the lower crimping teeth 32b are disposed on a crimper frame 32c. In the following description, such a way of pressing and deforming a given position on the sheet bundle Pb by the crimper 32 to bind the sheet bundle Pb may be referred to simply as crimping. The crimping and binding operation of the crimper 32 that involves control processes may be referred to as crimp binding or crimping in the following description.

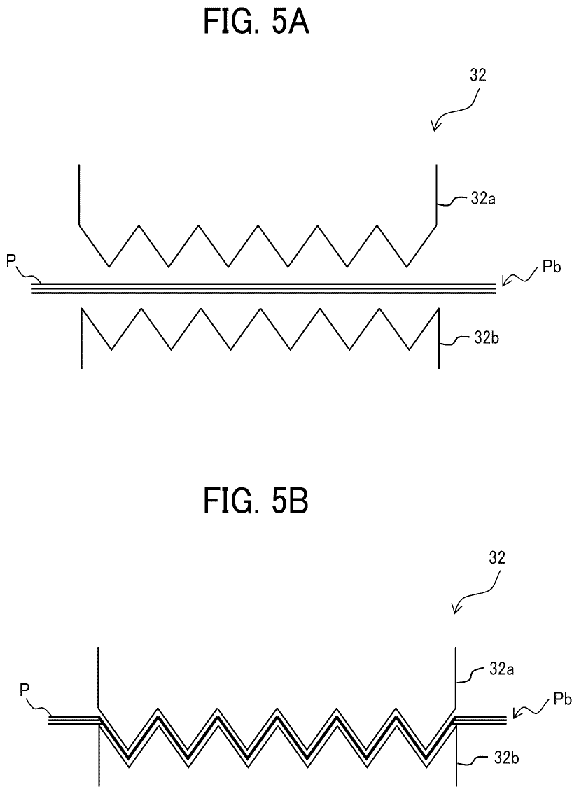

FIG. 5A and FIG. 5B are schematic diagrams illustrating a configuration of the crimper 32.

As illustrated in FIG. 5A and FIG. 5B, the crimper 32 includes the upper crimping teeth 32a and the lower crimping teeth 32b. The upper crimping teeth 32a and the lower crimping teeth 32b are disposed to face each other in the thickness direction of the sheet bundle Pb to sandwich the sheet bundle Pb placed on the internal tray 22. The upper crimping teeth 32a and the lower crimping teeth 32b have respective serrate faces facing each other. The serrate face of each of the upper crimping teeth 32a and the lower crimping teeth 32b includes concave portions and convex portions alternately formed. The concave portions and the convex portions of the upper crimping teeth 32a are shifted from those of the lower crimping teeth 32b such that the upper crimping teeth 32a are engaged with the lower crimping teeth 32b. The upper crimping teeth 32a and the lower crimping teeth 32b are brought into contact with and separated from each other by the driving force of a contact-separation motor 32d illustrated in FIG. 11.

In the process of supplying the sheets P of the sheet bundle Pb to the internal tray 22, the upper crimping teeth 32a and the lower crimping teeth 32b are separated from each other as illustrated in FIG. 5A. When all the sheets P of the sheet bundle Pb are placed on the internal tray 22, the upper crimping teeth 32a and the lower crimping teeth 32b are engaged with each other as illustrated in FIG. 5B by the driving force of the contact-separation motor 32d to press and deform the sheet bundle Pb in the thickness direction. As a result, the sheet bundle Pb that has been placed on the internal tray 22 is crimped and bound. The sheet bundle Pb thus crimped and bound is ejected to the second output tray 26 by the conveyance roller pair 15.

The configuration of the crimper 32 as a crimping assembly is not limited to the configuration of a moving assembly exemplified in the present embodiment, and may be any other suitable structure in which the upper crimping teeth 32a and the lower crimping teeth 32b of the crimping assembly engage with each other. For example, the crimping assembly may bring the upper crimping teeth 32a and the lower crimping teeth 32b into contact with each other and separate the upper crimping teeth 32a and the lower crimping teeth 32b from each other with a link mechanism and a driving source that simply rotates in the forward direction or rotates in both the forward and reverse directions. Alternatively, the crimping assembly may employ a linear motion system to linearly bring the upper crimping teeth 32a and the lower crimping teeth 32b into contact with each other and separate the upper crimping teeth 32a and the lower crimping teeth 32b from each other with a screw assembly that converts the forward and backward rotational motions of a driving source into linear reciprocating motion.

As illustrated in FIG. 3, the crimper 32 includes a crimping-teeth sliding assembly 322. The crimping-teeth sliding assembly 322 includes a crimping-teeth slide motor 32e, a pinion gear 32e1, a rack 32f1, and a crimping-teeth frame 32f, which will be described later in detail. The upper crimping teeth 32a and the lower crimping teeth 32b are arranged on the crimping-teeth frame 32f. As will be described later in detail, the crimping-teeth frame 32f has the pinion gear 32e1 and the rack 32f1 that engage with each other and are formed as a single integrated unit. The crimping-teeth frame 32f is attached to the crimper frame 32c so as to be movable in the main scanning direction. The crimping-teeth slide motor 32e generates a driving force to move the crimping-teeth frame 32f in the main scanning direction. The pinion gear 32e1 is attached to the output shaft of the crimping-teeth slide motor 32e. As the crimping-teeth slide motor 32e is driven to rotate in both the forward and reverse directions, the pinion gear 32e1 rotates in both the forward and reverse directions. As the pinion gear 32e1 rotates in both the forward and reverse directions, the rack 32f1 that engages with the pinion gear 32e1 reciprocates in the main scanning direction relative to the crimper frame 32c. As a result, the crimping-teeth frame 32f that is integrally arranged with the rack 32f1 also reciprocates in the main scanning direction relative to the crimper frame 32c. In other words, the upper crimping teeth 32a and the lower crimping teeth 32b provided for the crimping-teeth frame 32f can move in the main scanning direction as the crimping-teeth slide motor 32e is driven to rotate in both the forward and reverse directions. Accordingly, the upper crimping teeth 32a and the lower crimping teeth 32b can perform the binding operation several times with their positions moved in the main scanning direction relative to the sheet bundle Pb.

It is assumed in the present embodiment that the amount of movement of the upper crimping teeth 32a and the lower crimping teeth 32b, which make up the crimping assembly, in the main scanning direction is equivalent to the length of the crimping mark formed by the binding operation of the upper crimping teeth 32a and the lower crimping teeth 32b, and the crimping and binding operation is performed several times before and after the movement in the main scanning direction. In other words, when the length of the crimping mark formed by the binding operation of the upper crimping teeth 32a and the lower crimping teeth 32b is 10 millimeters (mm), it is assumed that the amount of movement in the main scanning direction is also 10 mm, and the length of the crimping mark can be made 20 mm by adding up the crimping operation for the first time before the movement in the main scanning direction and the crimping operation for the second time after the movement in the main scanning direction. Accordingly, the binding force of the crimper 32 increases about twofold.

As illustrated in FIG. 3, the crimper 32 includes a crimper rotation assembly 323 that serves as a postprocessor rotation assembly. The crimper rotation assembly 323 includes a crimper pivot motor 56, an output gear 56a, and a drive transmission gear 54a, which will be described later in detail. The crimper shaft 54 including a drive transmission gear 54a is fixed to the bottom face of the crimper frame 32c that holds the components of the crimper 32′.

The crimper shaft 54 and the drive transmission gear 54a are held by a base 48 on which the crimper frame 32c is disposed, so as to be rotatable in both forward and reverse directions. The drive transmission gear 54a meshes with an output gear 56a of a crimper pivot motor 56. The crimper 32 can be rotated in both forward and reverse directions about the crimper shaft 54 on the base 48 by a driving force transmitted from the crimper pivot motor 56 to the crimper shaft 54 via the output gear 56a and the drive transmission gear 54a.

As illustrated in FIG. 3, the edge binder 25 includes an edge-binder movement assembly 47. The edge-binder movement assembly 47 moves the edge binder 25, i.e., the liquid applier 31 and the crimper 32, in the main scanning direction along a downstream end in the conveyance direction of the sheet P placed on the internal tray 22. The edge-binder movement assembly 47 includes, for example, the base 48, a guide shaft 49, the edge-binder movement motor 50, and a driving force transmission assembly 551 that transmits the driving force of the edge-binder movement motor 50 to the base 48, and a standby position sensor 540 (see FIG. 11).

The liquid applier 31 and the crimper 32 are attached to the base 48 such that the liquid applier 31 and the crimper 32 are adjacent to each other in the main scanning direction. As illustrated in FIG. 4, the guide shaft 49 is held by multiple guide shaft brackets 49a disposed in the main scanning direction at a position on the upstream side of a binding assembly base 116 in the conveyance direction of the sheet P. As illustrated in FIG. 3, the guide shaft 49 extends in the main scanning direction on the binding assembly base 116. The guide rail 115 is disposed in the main scanning direction on the downstream side of the binding assembly base 116 in the conveyance direction of the sheet P. As illustrated in FIG. 4, the guide rail 115 includes a fitting target portion 115a that fits to a fitting portion 48a of the base 48 in the main scanning direction. In other words, the base 48 is movably held by the guide shaft 49 and the guide rail 115 in the main scanning direction on the binding assembly base 116.

The edge-binder movement motor 50 generates a driving force to move the edge binder 25. The driving force transmission assembly 551 transmits the driving force of the edge-binder movement motor 50 to the base 48 via pulleys 551a and 551b, a timing belt 551c, and a fastening portion 48b that fastens the base 48 and the timing belt 551c. As a result, the liquid applier 31 and the crimper 32 integrated by the base 48 move in the main scanning direction along the guide shaft 49.

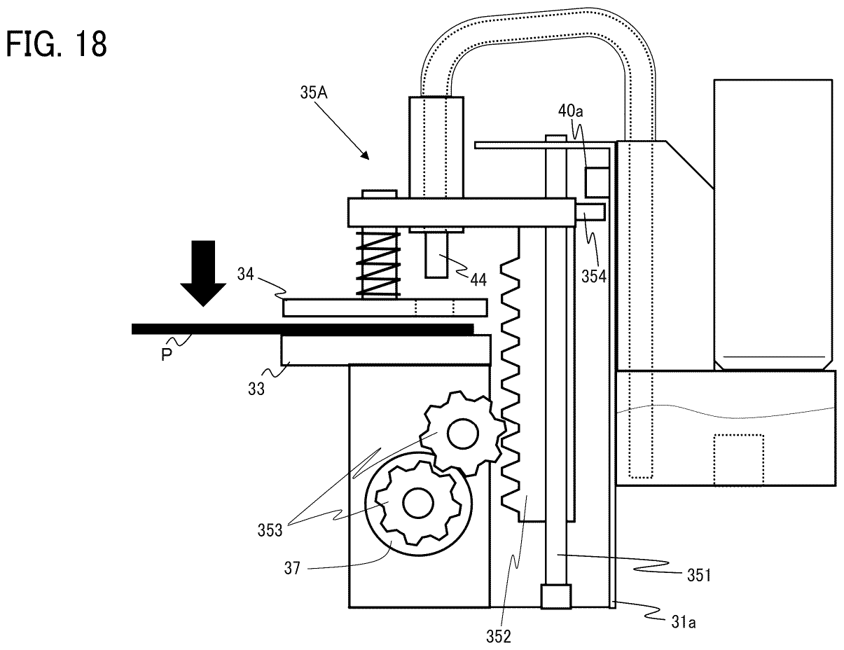

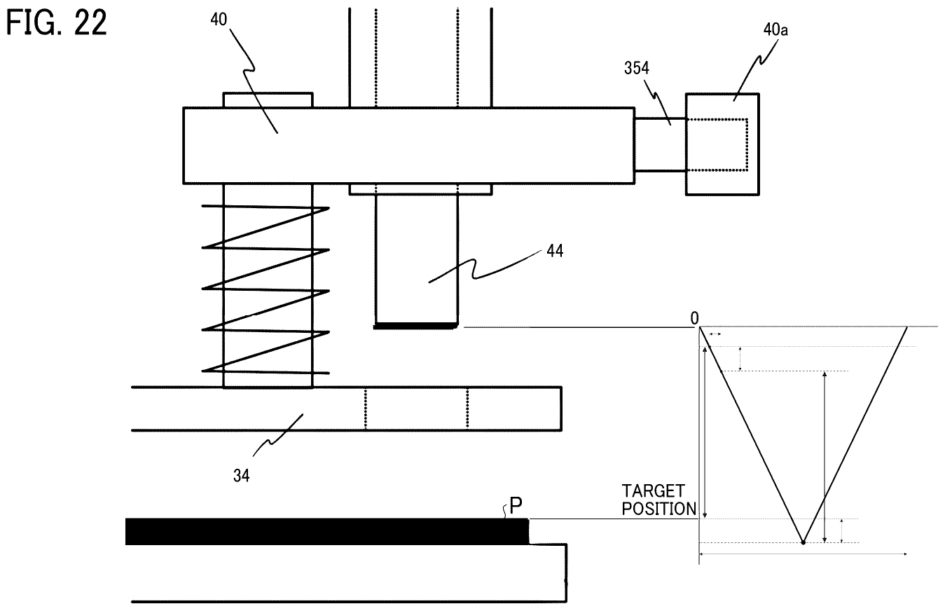

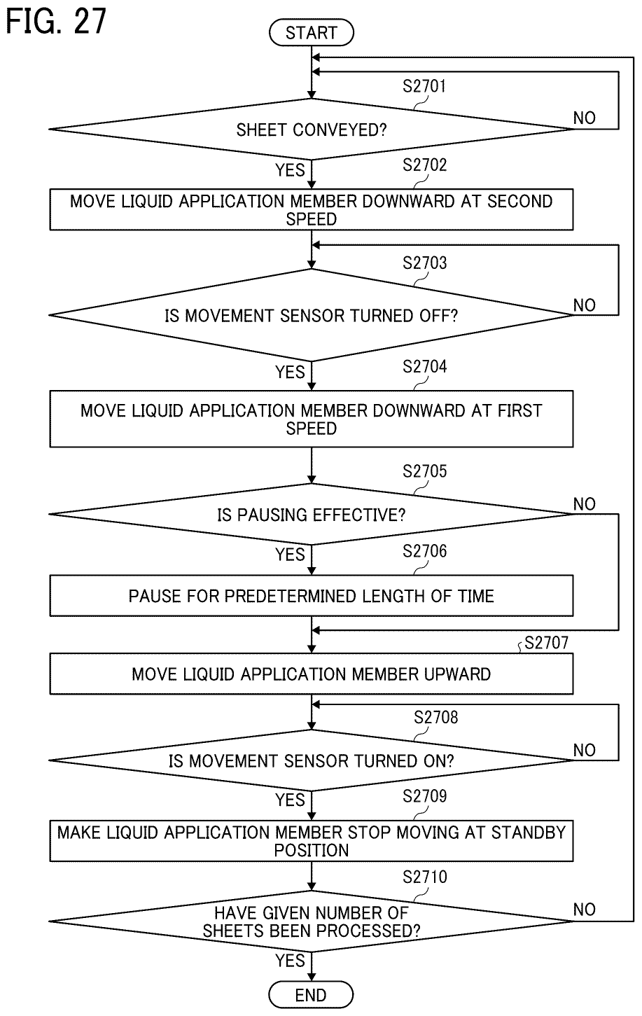

The edge-binder movement motor 50 is, for example, a servo motor that can stop the edge binder 25 at a desired position without returning the edge binder 25 to a starting point such as a standby home position (HP), which will be described later in detail, every time the edge binder 25 is moved. The target position of the edge binder is a position at which the crimper 32 binds the sheet bundle Pb. When binding is performed at a plurality of points of a single sheet bundle Pb, such points are referred to as, for example, a first binding position B1a and a second binding position B2a (see FIG. 18 to FIG. 20, FIG. 22 to FIG. 25, and FIG. 27 to FIG. 32). Those binding positions will be described later in detail.

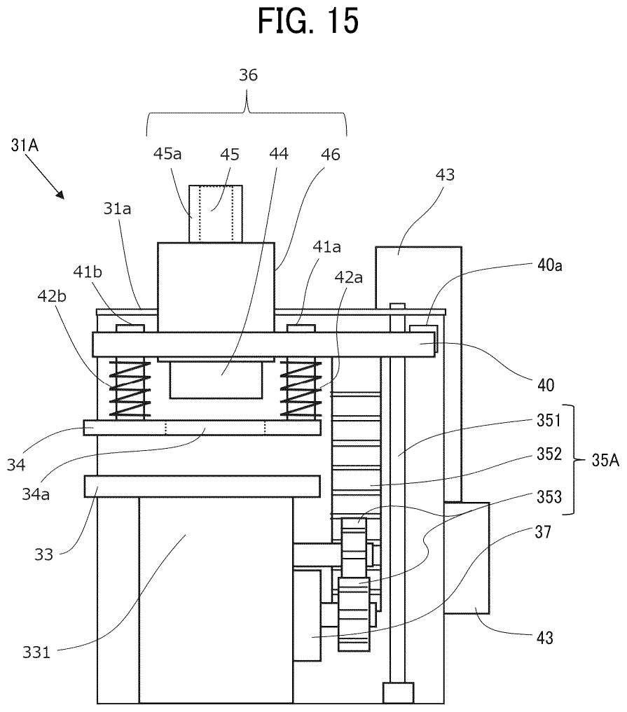

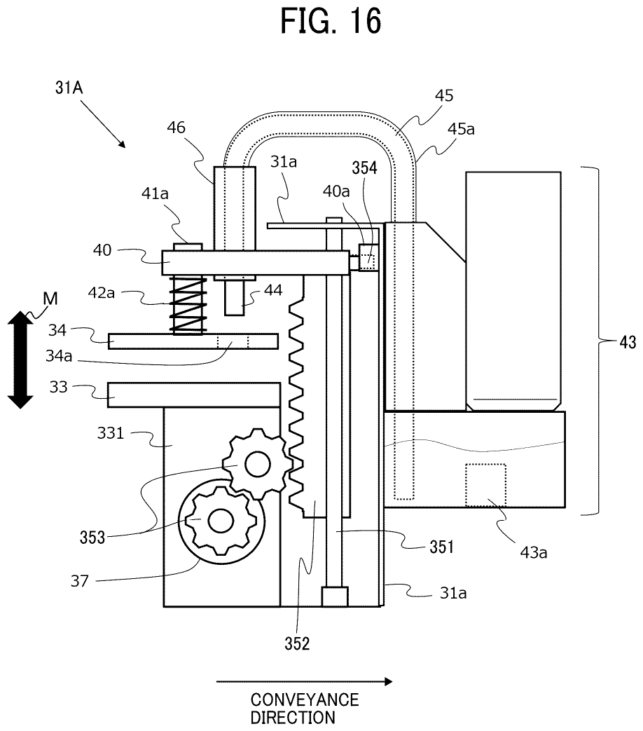

The post-processing apparatus 3 further includes a standby position sensor 540 and an encoder sensor 541. The standby position sensor 540 is, for example, a light-shielding optical sensor (see FIG. 11) to detect that the edge binder 25 has reached a standby home position (HP) (see FIG. 15A). The encoder sensor 541 (see FIG. 11) is attached to an output shaft of the edge-binder movement motor 50. The controller 100b, which is described below, detects that the edge binder 25 has reached the standby position HP, based on a detection result of the standby position sensor 540. The controller 100b also counts pulse signals output from the encoder sensor 541 to ascertain the current position of the edge binder 25 moved from the standby position HP.

However, a specific method of stopping the edge binder 25 at the target position without returning the edge binder 25 to the origin position is not limited to the above-described example. As another example, the post-processing apparatus 3 may include a sensor that detects the arrival of the edge binder 25 at a given target position determined in advance.

In other words, the controller 100b causes the edge-binder movement assembly 47 to move the edge binder 25 by the shortest distance between the position at which the liquid applier 31 faces the first liquid application position B1 and the position at which the liquid applier 31 faces the second liquid application position B2 without passing through the standby position HP. The edge-binder movement assembly 47 can also move the edge binder 25 by the shortest distance between the position at which the crimper 32 faces the first binding position B1 and the position at which the crimper 32 faces the second binding position B2 without passing through the standby position HP. Further, the controller 100b causes the edge-binder movement assembly 47 to move the edge binder 25 by the shortest distance between the position at which the liquid applier 31 faces the first liquid application position B1 (or the second liquid application position B2) and the position at which the crimper 32 faces the first binding position B1 (or the second binding position B2) without passing through the standby position HP.

In the above description, the edge binder 25 moves along the guide shaft 49 with the crimper 32 and the liquid applier 31 integrated. However, no limitation is intended thereby. For example, the crimper 32 and the liquid applier 31 may have a configuration of moving separately from each other.

The position on a sheet P or a sheet bundle Pb to which liquid is applied by the liquid applier 31, which may be referred to as liquid application position in the following description, corresponds to the binding position on the sheet bundle Pb to be crimped by the crimper 32. For this reason, as described above, the first liquid application position and the first binding position share reference sign B1 and the second liquid application position and the second binding position share reference sign B2.

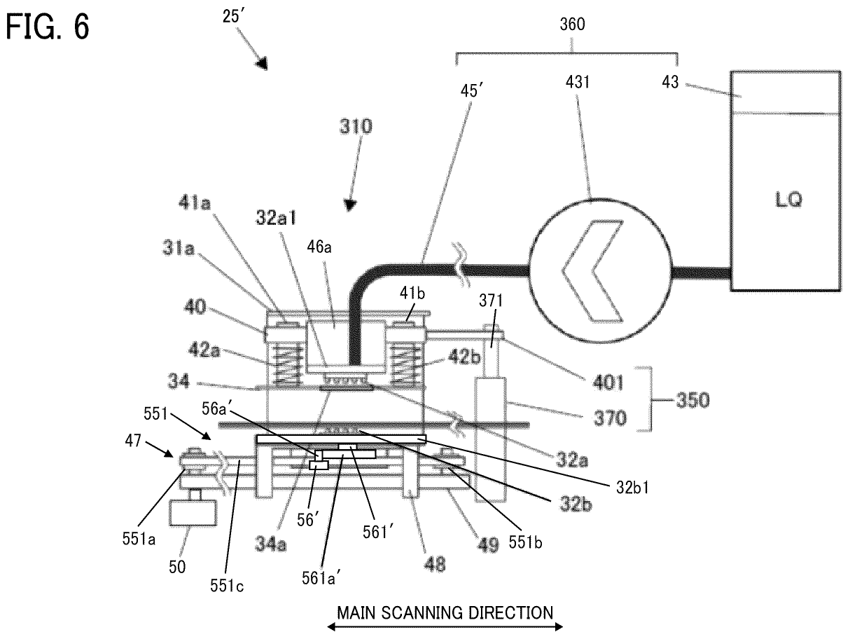

An edge binder 25′ that is a modification of the edge binder 25 included in the post-processing apparatus 3 is described below with reference to FIG. 6 to FIG. 8C. A difference of the edge binder 25′ from the edge binder 25 according to the first embodiment is that the liquid applier 31 and the crimper 32 are integrated as a single unit. In the following description, the same or like components as those of the edge binder 25 described above are denoted by the same or like reference signs, and redundant descriptions thereof may be omitted.

FIG. 6 is a schematic view of the edge binder 25′ viewed from the upstream side in the conveyance direction.

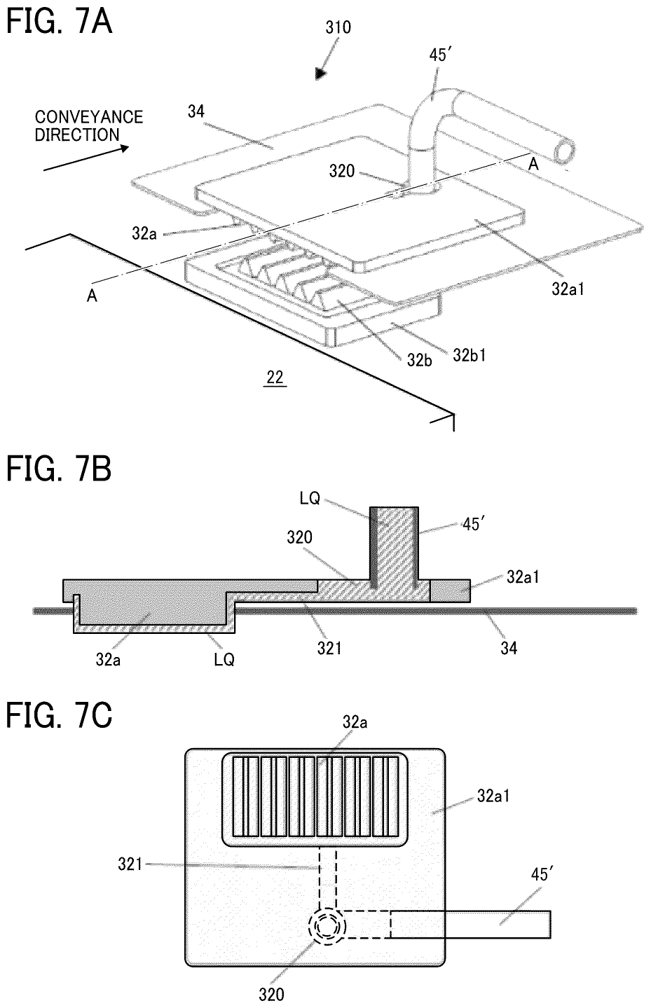

FIG. 7A is a perspective view of a liquid application crimper 310.

FIG. 7B is a sectional view of the liquid application crimper 310 taken along line A-A in FIG. 7A.

FIG. 7C is a plan view of the upper crimping teeth 32a of FIG. 7A as viewed from the side at which the lower crimping teeth 32b are disposed.

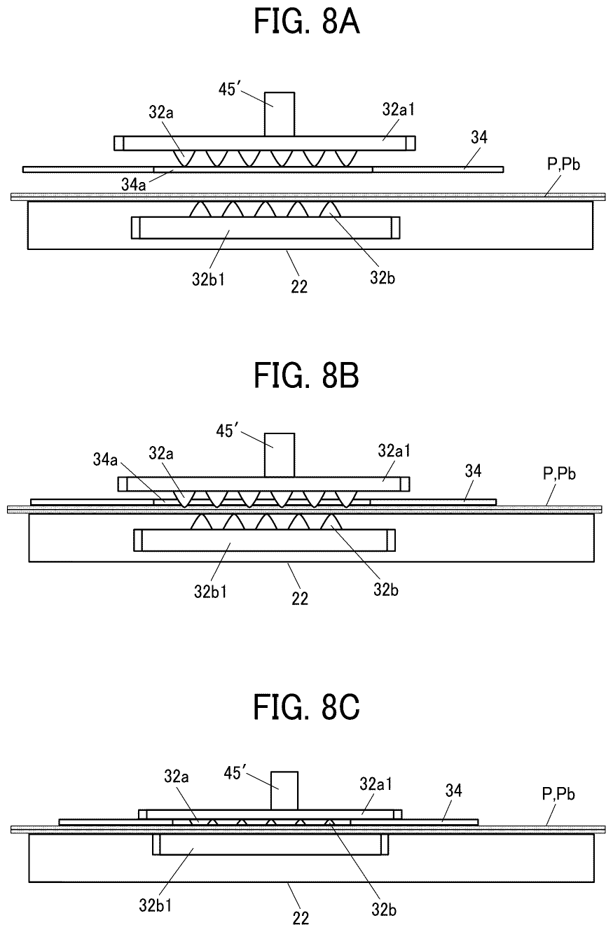

FIG. 8A to FIG. 8C illustrate the liquid applying operation and crimping and binding operation performed by the liquid application crimper 310 and are schematic views of the liquid application crimper 310 viewed from the downstream side in the conveyance direction.

As illustrated in FIG. 6, the edge binder 25′ includes the liquid application crimper 310 in which the liquid applier 31 and the crimper 32, which is an example of a postprocessor, of the edge binder 25 according to the first embodiment are integrated as a single unit. The liquid application crimper 310 is disposed downstream from the internal tray 22 in the conveyance direction.

The liquid application crimper 310 applies the liquid stored in the first liquid storage tank 43 to the sheet P or the sheet bundle Pb placed on the internal tray 22. The liquid application crimper 310 can be moved in the main scanning direction by the driving force that is transmitted from the edge-binder movement motor 50 to the base 48 by the driving force transmission assembly 551. The liquid application crimper 310 includes the upper pressure plate 34, the upper crimping teeth (upper binding teeth) 32a, the lower crimping teeth (lower binding teeth) 32b, a liquid application crimper movement assembly 350, and a liquid supply assembly 360. Components of the liquid application crimper 310 are held by the liquid application frame 31a and the base 48.

A liquid application crimper shaft 561′ provided with a drive transmission gear 561a′ is fixed to a bottom face of the liquid application frame 31a. The liquid application crimper shaft 561′ and the drive transmission gear 561a′ are held by the base 48 on which the liquid application frame 31a is disposed, so as to be rotatable in both forward and reverse directions. The drive transmission gear 561a′ meshes with an output gear 56a′ of a liquid application crimper pivot motor 56′. The liquid application crimper 310 can be rotated in both forward and reverse directions about the liquid application crimper shaft 561′ on the base 48 by a driving force transmitted from the liquid application crimper pivot motor 56′ to the liquid application crimper shaft 561′ via the output gear 56a′ and the drive transmission gear 561a′.

The liquid application crimper movement assembly 350 moves the upper pressure plate 34, the base plate 40, and the upper crimping teeth 32a in cooperation with each other in the thickness direction of the sheet P or the sheet bundle Pb by an electric cylinder 370. The base plate 40 holds the upper crimping teeth holder 32al and the upper crimping teeth 32a via a holder 46a. The base plate 40 movably holds the upper pressure plate 34 via the columns 41a and 41b. The base plate 40 is attached to an end of a rod 371 of the electric cylinder 370 through a coupler 401.

The columns 41a and 41b hold the upper pressure plate 34 at the lower ends of the columns 41a and 41b. The coil springs 42a and 42b are fitted around the columns 41a and 41b, respectively, between the base plate 40 and the upper pressure plate 34. The coil springs 42a and 42b bias the upper pressure plate 34 and the columns 41a and 41b in a direction away from the base plate 40.

The liquid supply assembly 360 includes the first liquid storage tank 43, a liquid supply pump 431, and a liquid supply member 45′. The liquid supply pump 431 supplies the liquid to the liquid reservoir 320 disposed in the upper crimping teeth holder 32al as illustrated in FIG. 7A via the liquid supply member 45′. The liquid supply member 45′ is coupled to the liquid supply pump 431 at the base end and is coupled to the liquid reservoir 320 at an end. The liquid supply member 45′ includes a long and elastic member.

As illustrated in FIG. 7B, the upper crimping teeth 32a are integrated with the upper crimping teeth holder 32a1. The upper crimping teeth holder 32al is provided with the liquid reservoir 320 and a liquid supply path 321 for supplying the liquid stored in the liquid reservoir 320 to the upper crimping teeth 32a. The surfaces of the upper crimping teeth 32a are subjected to a hydrophilic treatment so that the liquid supplied from the liquid supply path 321 uniformly spreads over the surfaces of the upper crimping teeth 32a. On the other hand, the portions of the upper crimping teeth holder 32al other than the upper crimping teeth 32a are subjected to a hydrophobic treatment so that the liquid efficiently spreads over the surfaces of the upper crimping teeth 32a.

As illustrated in FIG. 6, the lower crimping teeth 32b are integrated with a lower crimping teeth holder 32b1, which is a part of the liquid application frame 31a. The lower crimping teeth 32b are attached to the base 48 via the lower crimping teeth holder 32b1.

The liquid applying operation and crimping and binding operation of the liquid application crimper 310 are described below with reference to FIG. 8A to FIG. 8C. In the process of supplying a sheet P to the internal tray 22, as illustrated in FIG. 8A, the upper crimping teeth 32a and the lower crimping teeth 32b are separated from each other. When the sheet P is placed on the internal tray 22, the electric cylinder 370 is contracted to move the upper crimping teeth 32a and the upper pressure plate 34 toward the sheet P. Then, as illustrated in FIG. 8B, the upper pressure plate 34 first comes into contact with the sheet P, and then the upper crimping teeth 32a pass through the through hole 34a of the upper pressure plate 34 and come into contact with the sheet P. At this time, since the liquid is spread over the surfaces of the upper crimping teeth 32a, bringing the upper crimping teeth 32a into contact with the sheet P allows the liquid to be applied to the liquid application position on the sheet P. When liquid application to the liquid application position is completed, the electric cylinder 370 is extended to separate the upper crimping teeth 32a and the upper pressure plate 34 from the sheet P. The above-described contact and separation operation of the upper crimping teeth 32a and the upper pressure plate 34 with respect to the sheets P, which corresponds to the liquid applying operation, is repeatedly performed on sheets P of the sheet bundle Pb.

When the sheet bundle Pb including a predetermined number of sheets P is placed on the internal tray 22, the electric cylinder 370 is further contracted to move the upper crimping teeth 32a toward the lower crimping teeth 32b. Then, as illustrated in FIG. 8C, in a state in which the sheet bundle Pb is sandwiched between the upper crimping teeth 32a and the lower crimping teeth 32b, the upper crimping teeth 32a further move toward the lower crimping teeth 32b. Thus, the upper crimping teeth 32a and the lower crimping teeth 32b press and deform the sheet bundle Pb to crimp and bind the sheet bundle Pb (crimping and binding operation).

Details of the staple binder 55 having the function of executing the stapling process are described below.

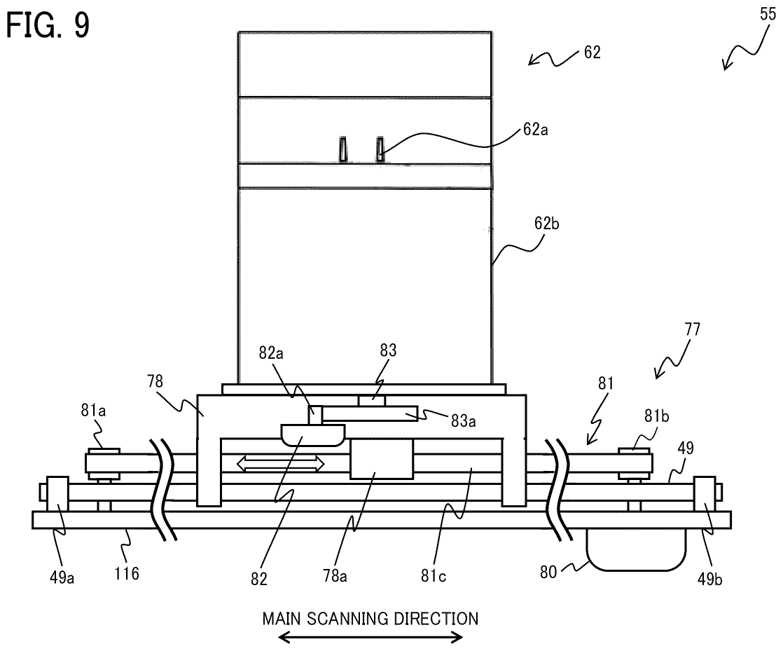

FIG. 9 is a schematic diagram illustrating the staple binder 55, viewed from the upstream side of the staple binder 155 in the conveyance direction.

The staple binder 55 includes a stapler 62 that binds the sheet bundle Pb with staples. The stapler 62 is disposed downstream from the internal tray 22 in the conveyance direction of the sheet P and spaced apart from the edge binder 25 in the main scanning direction.

The stapler 62 that is an example of a postprocessor performs so-called stapling to bind a sheet bundle Pb with a staples. More specifically, the stapler 62 includes a stapling-part drive motor 62d (see FIG. 11) that drives the stapling part 62a. The stapling part 62a binds the sheet bundle Pb by causing the binding staple loaded in the stapling part 62a to penetrate the sheet bundle Pb by the driving force of the stapling-part drive motor 62d.

As illustrated in FIG. 9, the staple binder 55 includes a staple-binder movement assembly 77. The staple-binder movement assembly 77 moves the staple binder 55 in the main scanning direction along a downstream end in the conveyance direction of the sheet P or the sheet bundle Pb placed on the internal tray 22. The staple-binder movement assembly 77 includes, for example, a base 78, the guide shaft 49, a staple-binder movement motor 80, and a driving force transmission assembly 81. The driving force transmission assembly 81 transmits a driving force of the staple-binder movement motor 80 to the base 78 via pulleys 81a and 81b, a timing belt 81c, and a fastening portion 78a that fastens the base 78 and the timing belt 81c. A stapler shaft 83 including a drive transmission gear 83a is fixed to a bottom face of a stapling frame 62b that holds the components of the stapler 62.

The stapler shaft 83 and the drive transmission gear 83a are held by the base 78 on which the stapling frame 62b is disposed, so as to be rotatable in both forward and reverse directions. The drive transmission gear 83a meshes with an output gear 82a of a stapler pivot motor 82. The stapler 62 is rotatable in both forward and reverse directions about the stapler shaft 83 on the base 78 by a driving force transmitted from the stapler pivot motor 82 to the stapler shaft 83 via the output gear 82a and the drive transmission gear 83a.

The edge binder 25 and the staple binder 55 are supported by the common guide shaft 49. In other words, the edge-binder movement assembly 47 and the staple-binder movement assembly 77 move the edge binder 25 and the staple binder 55 in the main scanning direction along the common guide shaft 49. The edge-binder movement assembly 47 and the staple-binder movement assembly 77 can independently move the edge binder 25 and the staple binder 55.

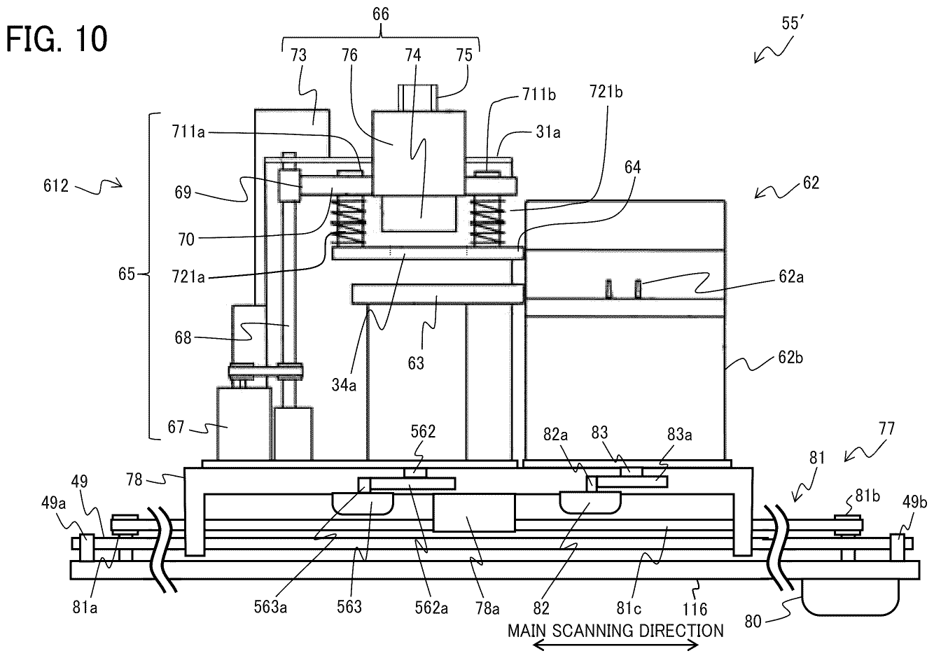

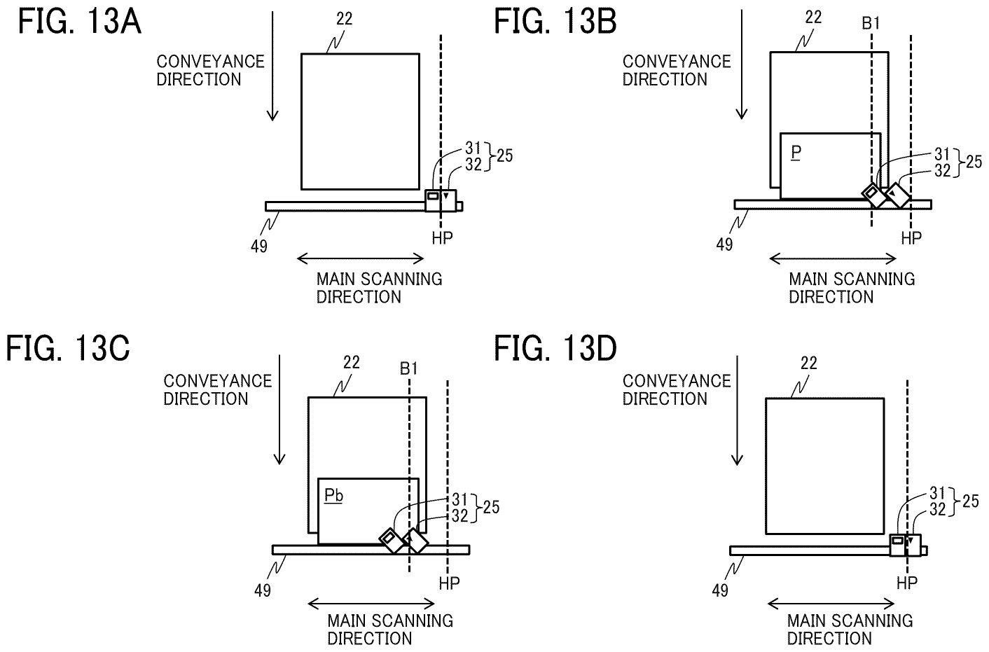

FIG. 10 illustrates a staple binder 55′ as a modification of the staple binder 55. More specifically, FIG. 13 is a schematic diagram illustrating the staple binder 55′ as viewed from the upstream side in the conveyance direction of the sheet P.

The staple binder 55′ is different from the staple binder 55 in that the staple binder 55′ includes a second liquid applier 612 in addition to the stapler 62. As illustrated in FIG. 10, the staple binder 55′ includes the second liquid applier 612 and the stapler 62. The second liquid applier 612 and the stapler 62 are disposed adjacent to each other in the main scanning direction on the downstream side of the internal tray 22 in the conveyance direction.

The second liquid applier 612 applies the liquid stored in a second liquid storage tank 73 to the sheet P or the sheet bundle Pb placed on the internal tray 22. A certain area including a position to which the liquid is applied on the sheet P or the sheet bundle Pb by the second liquid applier 612 is an example of a binding position to be stapled by the stapler 62. As illustrated in FIG. 10, the second liquid applier 612 includes a second lower pressure plate 63, a second upper pressure plate 64 having the through hole 34a, a second liquid-applier movement assembly 65, and a second liquid application assembly 66.

The second liquid-applier movement assembly 65 includes, for example, a second liquid-applier movement motor 67, a second trapezoidal screw 68, a second nut 69, a second base plate 70, second columns 711a and 711b, and second coil springs 721a and 721b. The second liquid application assembly 66 includes the second liquid storage tank 73, a second liquid application member 74, a second liquid supply portion 75, and a second joint 76.

The second liquid application assembly 66 and the liquid application assembly 36 of the liquid applier 31 described above with reference to FIG. 3 and FIG. 4 have configurations in common. The configuration of the stapler 62 illustrated in FIG. 10 is equivalent to the configuration of the stapler 62 illustrated in FIG. 9. The second liquid applier 612 and the liquid applier 31 that are illustrated in FIG. 3 have common pivot mechanisms. The pivot mechanism of the second liquid applier 612 includes a liquid-applier pivot motor 563, an output gear 563a, a drive transmission gear 562a, and a liquid applier shaft 562.

In the binding, the staple binder 55′ that is illustrated in FIG. 10 performs the liquid application process on the sheet P to loosen and soften the binding position, allowing the staple to easily pass through the sheet bundle Pb. As a result, the number of sheets to be bound per sheet bundle Pb can be increased as compared with a case where the stapling process is performed without performing the liquid application.

Control blocks of the post-processing apparatus 3 according to the first embodiment are described below with reference to FIG. 11.

FIG. 11 is a block diagram illustrating a hardware configuration of the post-processing apparatus 3 according to the first embodiment, which is used to perform control processes in the post-processing apparatus 3.

As illustrated in FIG. 11, the post-processing apparatus 3 includes a central processing unit (CPU) 101, a random-access memory (RAM) 102, a read-only memory (ROM) 103, a hard disk drive (HDD) 104, and an interface (I/F) 105 that are connected to each other through a common bus 109.

The CPU 101 is an arithmetic device and controls the overall operation of the post-processing apparatus 3. The RAM 102 is a volatile storage medium that allows high-speed reading and writing of data, and is used as a working area when the CPU 101 processes information. The ROM 103 is a read-only non-volatile storage medium, and stores programs such as firmware. The HDD 104 is a nonvolatile data readable/writable memory and has a relatively large storage capacity. The HDD 104 stores, for example, an operating system (OS), various kinds of control programs, and application programs.

By an arithmetic function of the CPU 101, the post-processing apparatus 3 processes, for example, a control program stored in the ROM 103 and an information processing program (application program) loaded into the RAM 102 from a storage medium such as the HDD 104. Such processing configures a software controller including various functional modules of the post-processing apparatus 3. The software controller thus configured cooperates with hardware resources of the post-processing apparatus 3 to construct functional blocks that implement functions of the post-processing apparatus 3. In other words, the CPU 101, the RAM 102, the ROM 103, the HDD 104, and the interface 105 make up at least part of a controller 100b, which is an example of a control device, to control the operation of the post-processing apparatus 3.

The interface 105 is an interface circuit that connects the conveyance roller pairs 10, 11, 14, and 15, the switching member 20, the side fences 24L and 24R, the contact-separation motor 32d, the crimping-teeth slide motor 32e, the crimper pivot motor 56, the liquid-applier movement motor 37, the liquid-applier pivot motor 563, the edge-binder movement motor 50, the stapling-part drive motor 62d, the stapler pivot motor 82, the staple-binder movement motor 80, the movement sensor 40a, the liquid level sensor 43a, the standby position sensor 540, the encoder sensor 541, and an operation panel 110 to the common bus 109.

The controller 100b controls, through the interface 105, the operations of the conveyance roller pairs 10, 11, 14, and 15, the switching member 20, the side fences 24L and 24R, the contact-separation motor 32d, the crimping-teeth slide motor 32e, the crimper pivot motor 56, the liquid-applier movement motor 37, the liquid-applier pivot motor 563, the edge-binder movement motor 50, the stapling-part drive motor 62d, the stapler pivot motor 82, and the staple-binder movement motor 80. The controller 100b acquires detection results from the movement sensor 40a, the liquid level sensor 43a, the standby position sensor 540, and the encoder sensor 541. Although FIG. 11 illustrates only the components related to the edge binder 25 and the staple binder 55 that perform the edge binding, the components related to the saddle binder 28 that performs the saddle binding are also controlled by the controller 100b.

As illustrated in FIG. 1, the image forming apparatus 2 includes the operation panel 110. The operation panel 110 includes an operation section that receives instructions input by an operator and a display (which is an example of a notifier) that notifies the operator of information. The operation section includes, for example, hard keys and a touch screen overlaid on the display. The operation panel 110 acquires information from the user through the operation section and provides information to the user through the display. A specific example of the notifier is not limited to the display and may be a light-emitting diode (LED) lamp or a loudspeaker. The post-processing apparatus 3 may include an operation panel 110 similar to the above-described operation panel 110 of the image forming apparatus 2.

As described above, the post-processing apparatus 3 includes the edge binder that can perform post-processing such as crimp binding and stapling after the liquid is applied. When the number of sheets P that make up the sheet bundle Pb is small, the edge binder 25 may perform crimping with no liquid application (i.e., crimp binding using the crimper 32 only) in a similar manner to the crimp binding in the related art.

In the edge binder 25, the liquid applier 31 and the crimper 32 can be moved in the main scanning direction by the crimping-teeth sliding assembly 322 and/or the edge-binder movement assembly 47. Due to such a configuration, the liquid application position of the liquid applier 31 and/or the binding position of the crimper 32 can be moved in the main scanning direction to perform crimping at a plurality of points. As a result, two or more crimping marks can be formed by the binding operation of the upper crimping teeth 32a and the lower crimping teeth 32b, and those crimping marks are adjacent to each other. Accordingly, the binding strength of the sheet bundle Pb can be enhanced.

Methods of changing how the post-processing such as binding is performed or the number of times the crimp binding is performed for one sheet bundle Pb, depending on the condition of binding such as the number of sheets P that make up the sheet bundle Pb for which post-processing such as binding is performed and the binding posture of the crimper 32 relative to the sheet bundle Pb, are described below.

The processes of binding that are executed by the edge binder 25 included in the post-processing apparatus 3 are described below.

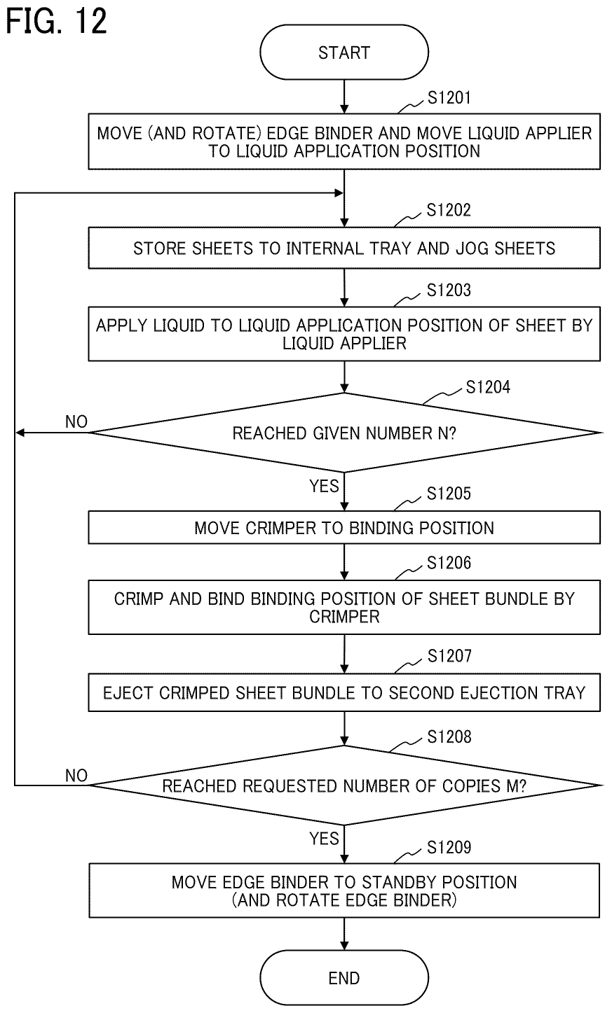

FIG. 12 is a flowchart of a process of the one-point binding performed by the edge binder 25.

FIG. 13A to FIG. 13D are diagrams each of which illustrates the positions of the edge binder 25 (the liquid applier 31 and the crimper 32) during the one-point binding.

The position (liquid application position) to which liquid is applied on a sheet P or a sheet bundle Pb by the liquid applier 31 corresponds to the binding position on the sheet bundle Pb to be crimped by the crimper 32. For this reason, in the following description, the liquid application position and the binding position are denoted by the same reference sign (B1 or B2).

For example, the controller 100b starts the binding illustrated in FIG. 12 when the controller 100b acquires an execution command of the binding from the image forming apparatus 2. In the following description, the execution command of the binding may be referred to as a binding command.

The binding command includes, for example, the type of the sheet P (including information affecting the spread of liquid, such as material and thickness), the number of sheets P of the sheet bundle Pb, the number of sheet bundles Pb to be bound, the binding position on the sheet bundle Pb, and the binding posture of the edge binder 25. In the following description, the number of sheets P of the sheet bundle Pb may be referred to as “given number of sheets N” whereas the number of sheet bundles Pb to be bound may be referred to as “requested number of copies M.”

The liquid applier 31 and the crimper 32 are assumed to be in a parallel binding posture and located at a standby position HP (FIG. 13A) that is a position shifted in the width direction from the sheets P placed on the internal tray 22 at the start of the binding.

When the posture that is instructed by the binding command is the oblique binding posture, in step S1201, the controller 100b drives the liquid-applier pivot motor 563 and the crimper pivot motor 56 to rotate the liquid applier 31 and the crimper 32 of the edge binder 25 into the oblique binding posture. Alternatively, when the posture that is instructed by the binding command is the “inclined binding posture,” the crimper 32 alone may be pivoted to the inclined binding posture and the liquid applier 31 may not be pivoted in both forward and reverse directions. Such a configuration can simplify the driving mechanism as compared with a configuration in which both the liquid applier 31 and the crimper 32 are rotated in both forward and reverse directions. Thus, the effects of cost reduction, the downsizing of the apparatus, and the reduction of a failure of devices are obtained.

On the other hand, when the posture that is instructed by the binding command is the “parallel binding posture,” the controller 100b omits the aforementioned operation of rotating the liquid applier 31 and the crimper 32 of the edge binder 25 to the oblique binding posture.

In step S1201, the controller 100b drives the edge-binder movement motor 50 to move the edge binder 25 in the main scanning direction so that the liquid applier 31 faces the first liquid application position B1 instructed by the binding command. The controller 100b executes the operation of step S1101 before a first sheet P is conveyed to the internal tray 22 by the conveyance roller pairs 10, 11, 14, and 15.

In step S1202, the controller 100b rotates the conveyance roller pairs 10, 11, 14, and 15 to store the sheet P, on which the image has been formed by the image forming apparatus 2, onto the internal tray 22. In step S1202, the controller 100b also moves the side fences 24L and 24R in the main scanning direction to align the position of the sheet P or the sheet bundle Pb placed on the internal tray 22 in the main scanning direction. In short, the controller 100b performs so-called jogging.

In step S1203, the controller 100b causes the liquid applier 31 facing the first liquid application position B1 to apply liquid to the first liquid application position B1 of the sheet P placed on the internal tray 22 in the immediately preceding step S1102, based on the liquid application control data adjusted in advance. In other words, the controller 100b drives the liquid-applier movement motor 42 to bring the liquid application member 501 into contact with the first liquid application position B1 on the sheet P placed on the internal tray 22 (see FIG. 13B). In the liquid application process in step S1103, the controller 100b adjusts the position at which the liquid application member 501 applies liquid to the sheet P in accordance with the type of the sheet P and the binding position included in the binding command. The controller 100b adjusts the amount of pressing the liquid application member 501 against the sheet P. In other words, the controller 100b controls the operation of the liquid-applier movement motor 42 based on the adjusted control data, and adjusts the amount of movement of the liquid application member 501 with respect to the first liquid application position B1 of the sheet P placed on the internal tray 22.

In step S1204, the controller 100b determines whether the number of sheets P placed on the internal tray 22 has reached the given number of sheets N instructed by the binding command. When the controller 100b determines that the number of sheets P placed on the internal tray 22 has not reached the given number of sheets N (NO in step S1204), the controller 100b executes the operations of steps S1202 to S1204 again until the number of sheets P placed on the internal tray 22 reaches the given number of sheets N (YES in step S1204). In other words, the controller 100b executes the processes of step S1202 to step S1204 each time the sheet P is conveyed to the internal tray 22 by the conveyance roller pairs 10, 11, 14, and 15. The liquid application by the liquid applier 31 may be performed not only on all of the plurality of sheets P included in the sheet bundle Pb but also on only some of the plurality of sheets P included in the sheet bundle Pb.

When the controller 100b determines that the number of sheets P placed on the internal tray 22 has reached the given number of sheets N (YES in step S1204), in step S1205, the controller 100b drives the edge-binder movement motor 50 to move the edge binder 25 in the main scanning direction such that the crimper 32 faces the first binding position B1 as illustrated in FIG. 13C.

In step S1206, the controller 100b causes the crimper 32 to crimp the sheet bundle Pb placed on the internal tray 22. In step S1207, the controller 100b causes the conveyance roller pair 15 to eject the sheet bundle Pb thus crimped and bound by the crimper 32 to the second output tray 26. More specifically, the controller 100b drives the contact-separation motor 32d to cause the upper crimping teeth 32a and the lower crimping teeth 32b to clamp the first binding position B1 on the sheet bundle Pb placed on the internal tray 22. The sheet bundle Pb is pressed and deformed between the upper crimping teeth 32a and the lower crimping teeth 32b, and thus the sheet bundle Pb is crimped. Then, the controller 100b rotates the conveyance roller pair 15 to eject the sheet bundle Pb thus crimped and bound to the second output tray 26.

The sheet bundle Pb that is supported on the internal tray 22 has a crimping area (corresponding to the first binding position B1) sandwiched between the upper crimping teeth 32a and the lower crimping teeth 32b in step S1206. The crimping area overlaps a liquid application area (corresponding to the first liquid application position B1) contacted by the end of the liquid application member 501 in step S1203. In other words, the crimper 32 crimps an area to which liquid is applied by the liquid applier 31 on the sheet bundle Pb placed on the internal tray 22. The crimping area that is clamped by the upper crimping teeth 32a and the lower crimping teeth 32b may completely or partially overlap with the liquid application area contacted by the front end of the liquid application member 501, to obtain a sufficient binding strength.

In step S1208, the controller 100b determines whether the number of sheet bundles Pb thus ejected to the second output tray 26 has reached the requested number of copies M indicated by the binding command. When the controller 100b determines that the number of sheet bundles Pb thus ejected has not reached the requested number M of copies (NO in step S1208), the controller 100b executes the operations of step S1202 and subsequent steps again. In other words, when the controller 100b determines that the number of sheet bundles Pb thus ejected has not reached the requested number of copies M (NO in step S1208), the controller 100b repeats the operations of step S1202 to step S1208 until the number of sheet bundles Pb ejected to the second output tray 26 reaches the requested number of copies M.

On the other hand, when the controller 100b determines that the number of sheet bundles Pb output to the second output tray 26 has reached the requested number of copies M (YES in step S1208), in step S1209, the controller 100b drives the edge-binder movement motor 50 to move the edge binder 25 (the liquid applier 31 and the crimper 32) to the standby position HP as illustrated in FIG. 13D. When the posture that is instructed by the binding command is the “oblique binding posture,” in step

S1209, the controller 100b drives the liquid-applier pivot motor 563 and the crimper pivot motor 56 to rotate the liquid applier 31 and the crimper 32 into the parallel binding posture. On the other hand, when the posture that is instructed by the binding command is the “parallel binding posture,” the controller 100b skips the aforementioned operation of rotating the liquid applier 31 and the crimper 32 to the parallel binding posture. As a result, the edge binder 25 (the liquid applier 31 and the crimper 32) returns to the standby position HP position illustrated in FIG. 13D. In step S1201 and step S1209, the execution order of the movement in the main scanning direction and the rotation in both forward and reverse directions of the liquid applier 31 and the crimper 32 is not limited to the aforementioned order and may be reversed.

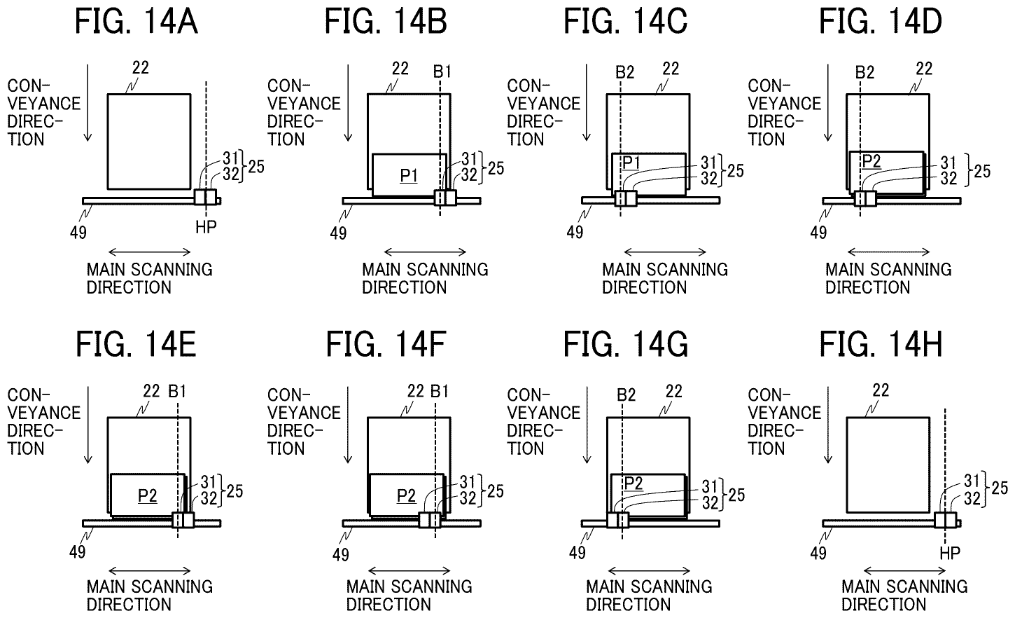

FIG. 14A to FIG. 14H are diagrams illustrating the positions of the edge binder during the operation of a two-point binding.

As illustrated in FIG. 14A, it is assumed that the edge binder 25 is located at the standby position HP at the start point of the two-point binding. The first binding position B1 and the second binding position B2 are positions separated from each other in the main scanning direction. Cases in which two sheets P are crimped and bound (i.e., N=2) are described with reference to FIG. 14A to FIG. 14H. In the case of executing the two-point binding, the number of sheets P included in the sheet bundle Pb is not limited to two, and the two-point binding can be performed on a sheet bundle Pb having the same number of sheets as the number of sheets that can be bound in one-point binding.

Before a first sheet P1 for a sheet bundle Pb is supplied to the internal tray 22, the controller 100b moves the edge binder 25 in the main scanning direction such that the liquid applier 31 can face the first liquid application position B1 (see FIG. 14B). As illustrated in FIG. 14B, the liquid applier 31 is disposed at a position at which the liquid applier 31 can face the first crimp binding position B1. In such a state, the controller 100b causes the first sheet P1, on which an image has been formed by the image forming apparatus 2, to be placed on the internal tray 22 and performs a jogging process on the first sheet P1. In response to the placement of the first sheet P1 on the internal tray 22, the controller 100b causes the liquid applier 31 to apply the liquid to the first liquid application position B1 of the first sheet P1.

Then, as illustrated in FIG. 14C, the controller 100b causes the edge binder 25 to move in the main scanning direction such that the liquid applier 31 faces the second liquid application position B2 of the first sheet P1. Then, the controller 100b causes the liquid applier 31 to apply the liquid to the second liquid application position B2 of the first sheet P1.

In response to the application of the liquid to the first liquid application position B1 and the second liquid application position B2 of the first sheet P1, the controller 100b causes a second sheet P2 for the sheet bundle Pb to be placed on the internal tray 22 and performs the jogging process on the second sheet P2 in a state where the liquid applier 31 is disposed at a position which the liquid applier 31 can face the second liquid application position B2 as illustrated in FIG. 14D. In response to the placement of the second sheet P2 on the internal tray 22, the controller 100b causes the liquid applier 31 to apply the liquid to the second liquid application position B2 of the second sheet P2.

Then, as illustrated in FIG. 14E, the controller 100b causes the edge binder 25 to move in the main scanning direction such that the liquid applier 31 faces the first liquid application position B1 of the second sheet P2. Subsequently, the controller 100b causes the liquid applier 31 to apply the liquid at the first liquid application position B1 of the second sheet P2.

In other words, the controller 100b controls the conveyance roller pairs 10, 11, 14, and 15 and the liquid applier 31 to repeat the conveyance of the sheet P and the liquid application to the first liquid application position B1 and the second liquid application position B2 until the number of sheets P placed on the internal tray 22 reaches the given number of sheets N. In so doing, the controller 100b causes the liquid applier 31 to apply the liquid to the B-th sheet P (B<N) in the order of the first liquid application position B1 and the second liquid application position B2.

The controller 100b also causes the liquid applier 31 to apply the liquid to the (B+1)-th sheet P in the order of the second liquid application position B2 and the first liquid application position B1. In other words, the controller 100b changes the order in which the liquid applier 31 applies the liquid to the first liquid application position B1 and the second liquid application position B2 for each sheet P. The controller 100b also causes the edge binder 25 to move from one side of the first liquid application position B1 and the second liquid application position B2 to the other side of the first liquid application position B1 and the second liquid application position B2 in the shortest distance without passing through the standby position HP.

Subsequently, in response to a determination that the number of sheets P placed on the internal tray 22 has reached the given number of sheets N, the controller 100b causes the edge binder 25 to move in the main scanning direction such that the crimper 32 faces the first binding position B1 as illustrated in FIG. 14F. The controller 100b causes the crimper 32 to perform crimp binding on the first binding position B1 of the sheet bundle Pb placed on the internal tray 22.

Then, as illustrated in FIG. 14G, the controller 100b causes the edge binder 25 to move in the main scanning direction such that the crimper 32 faces the second binding position B2. The controller 100b causes the crimper 32 to perform crimp binding on the second binding position B2 of the sheet bundle Pb placed on the internal tray 22.

In the example illustrated in FIG. 14A to FIG. 14H, the liquid is finally applied to the first crimp binding position B1, and the crimp binding is performed in the order of the first binding position B1 and the second binding position B2. On the other hand, when the liquid is finally applied to the second binding position B2, the crimp binding is performed in the order of the second binding position B2 and the first binding position B1.

The controller 100b ejects the sheet bundle (sheet bundle) Pb crimped and bound at the first binding position B1 and the second binding position B2 to the second output tray 26. Further, as illustrated in FIG. 14H, the controller 100b causes the edge binder 25 to move to the standby position HP.

According to the present embodiment, one or two positions of the sheet bundle Pb are crimped and bound. However, no limitation is indicated thereby, and three or more positions of the sheet bundle Pb spaced apart from each other in the main scanning direction may be crimped and bound. In such cases, the controller 100b causes the liquid applier 31 to apply the liquid to three or more liquid application positions (corresponding to the crimp binding positions) and causes the crimper 32 to perform crimp binding. Even when three or more positions are crimped and bound, the productivity of the crimp binding can be increased.

However, it is not necessary to apply the liquid to all the liquid application positions (corresponding to crimp binding positions) for all the sheets P included in the sheet bundle Pb. For example, when crimp binding is performed on three liquid application positions (corresponding to crimp binding positions) apart from each other in the main scanning direction, the controller 100b may cause the liquid applier 31 to apply the liquid to three liquid application positions (corresponding to crimp binding positions) of an E-th sheet P1 (E<N−2), apply the liquid to two liquid application positions (corresponding to crimp binding positions) of an (E+1)-th sheet P2, and apply the liquid to one liquid application position (corresponding to a crimp binding position) of an (E+2)-th sheet P2.

A liquid applier 31A that is a modification of the liquid applier 31 is described below.

FIG. 15 is a diagram illustrating the liquid applier 31A viewed in the conveyance direction of the sheet P.

In the following description, identical or similar components as those of the liquid applier 31 according to the first embodiment described above are denoted by identical or similar reference signs, and overlapping descriptions may be omitted.

The liquid-applier movement assembly 35A that is an example of a movement mechanism moves the upper pressure plate 34, the base plate 40, and the liquid application member 44 in the thickness direction of the sheet P or the sheet bundle Pb.

In other words, the liquid-applier movement assembly 35A moves the liquid application member 44 so as to get close to or be separated from the sheet P or the sheet bundle Pb conveyed to the gap between the upper pressure plate 34 and the lower pressure plate 33.

The liquid-applier movement assembly 35A moves the upper pressure plate 34, the base plate 40, and the liquid application member 44 in conjunction with each other with a single liquid-applier movement motor 37. For example, the liquid-applier movement assembly 35A includes the liquid-applier movement motor 37, the base plate 40, a liquid-applier guide shaft 351, a rack gear 352, and a gear 353.

The shutter 354 is attached to, for example, the base plate 40 that is moved by the liquid-applier movement assembly 35A. The shutter 354 makes up a part of the member that changes the output of the movement sensor 40a that is an example of a liquid-application sensor to determine whether the liquid application member 44 has passed through a predetermined detection area of the range of movement. In other words, when the shutter 354 is at the position of the movement sensor 40a, the liquid application member 44 is at the uppermost position of the range of movement and is separated from the sheet P or the sheet bundle Pb. Such a position of the liquid application member 44 is referred to as an initial position or home position (HP).

When the liquid application is performed, the liquid application member 44 is moved downward by the liquid-applier movement assembly 35A. In other words, the liquid application member 44 moves in a direction towards the sheet P or the sheet bundle Pb. Due to this movement, the shutter 354 moves in the same direction. After the shutter 354 moves from the position of the movement sensor 40a and reaches a position where how the movement sensor 40a can perform detection changes, the movement sensor 40a changes the detection signal output to the controller 100b. After the shutter 354 has passed through the detection area of the movement sensor 40a and the response time of the movement sensor 40a has passed, the controller 100b obtains the changes in the detection signal output from the movement sensor 40a.

The liquid-applier movement motor 37 generates a driving force to move the upper pressure plate 34, the base plate 40, and the liquid application member 44.

The liquid-applier guide shaft 351 is attached to the liquid application frame 31a. The rack gear 352 is provided for the structure that is moved by the liquid-applier movement assembly 35A, and is attached to, for example, the base plate 40.

The gear 353 transmits the driving force of the liquid-applier movement motor 37 to the rack gear 352. Typically, the gear 353 includes a pair of gears, but no limitation is indicated thereby. The gear 353 may be a single gear or a plurality of gears, and other parts such as a timing belt may be used together to transmit the driving force. As the driving force of the liquid-applier movement motor 37 is transmitted to the rack gear 352 through the gear 353, for example, the liquid application member 44 moves along the liquid-applier guide shaft 351.

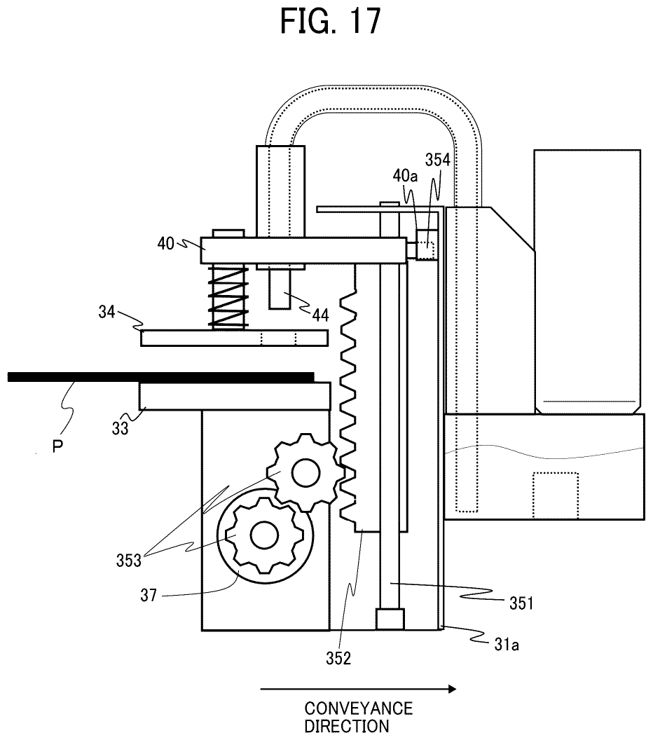

An example of a liquid applying operation in the liquid application is described below with reference to FIG. 17 to FIG. 20.

FIG. 17 is a diagram illustrating the position of the liquid application member 44 before the liquid application starts.

As illustrated in FIG. 17, the liquid application member 44 is at the standby position until the liquid application starts.

When the liquid application member 44 is at the standby position, the shutter 354 that is fixed to the base plate 40 is at the installed position of the movement sensor 40a. For example, the movement sensor 40a includes a pair of light emitter and light receiver that are arranged to face each other, and the light receiver receives the light emitted from the light emitter. In view of this configuration, a detection signal is output from the light receiver to the controller 100b.

When the liquid application member 44 is at the standby position, the shutter 354 is placed in the gap between the light emitter and the light receiver. Moreover, the shutter 354 blocks the light emitted from the light emitter, and the controller 100b detects the detection signal output from the light receiver.

As will be described later in detail, when the liquid application member 44 moves from the standby position and then the radiation intensity of the light changes as the shutter 354 blocks off the light emitter and the light receiver, the detection signal that is output from the light receiver to the controller 100b changes depending on the radiation intensity of the light. However, it is to be noted that the changes in the detection signal output from the movement sensor 40a is influenced by the response characteristics of the movement sensor 40a.

Accordingly, when the liquid application member 44 is moved from the standby position and the shutter 354 is moved relative to the movement sensor 40a, the amount of movement of the liquid application member 44 and the determination of the position of the liquid application member 44 are influenced by changes in the output value of the detection signal from the movement sensor 40a and the responsiveness of the controller 100b that detects such changes and make a determination based on the detected changes.

When the liquid application member 44 is at the standby position and the sheet P or the sheet bundle Pb is conveyed to an area where the liquid application can be performed, the liquid application starts. In other words, when a predetermined number of sheets P are conveyed to the gap between the upper pressure plate 34 and the lower pressure plate 33 to form a sheet bundle Pb, the liquid application starts.

When the liquid application starts, the state shifts from the one illustrated in FIG. 17 to the one illustrated in FIG. 18.

FIG. 18 is a diagram illustrating a state where the liquid application has started and the liquid application member 44 has just started moving downward.

In other words, FIG. 18 illustrates a moment when the liquid application member 44 has started moving so as to get close to the sheet P or the sheet bundle Pb. As illustrated in FIG. 18, when the liquid application starts, the base plate 40 is moved downward by the liquid-applier movement assembly 35A. The liquid application member 44 and the shutter 354 that are held by the base plate 40 move downward as the base (78, 48) moves downward. When the base plate 40 moves downward, the upper pressure plate 34 moves downward through the pair of coil springs 42a and 42b. Accordingly, the output signal from the movement sensor 40a changes as the shutter 354 moves. From the point in time when the controller 100b detected such changes, the liquid application member 44 is controlled to move for given time.

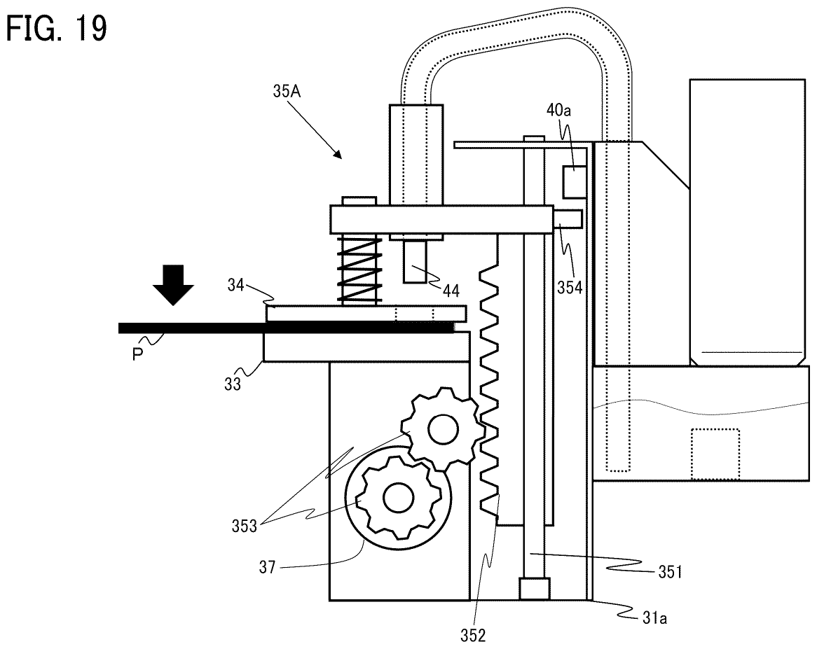

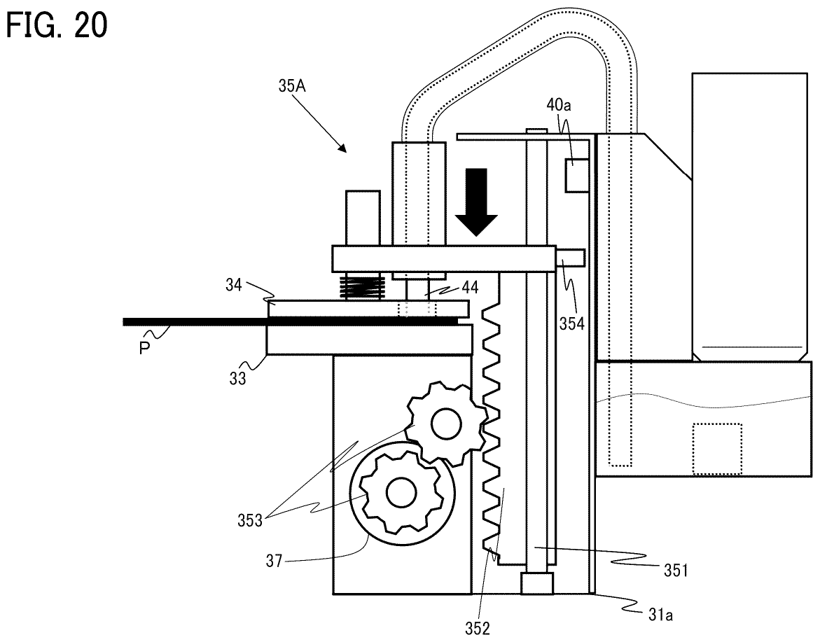

Subsequently, as illustrated in FIG. 19, the upper pressure plate 34 contacts the sheet P or the sheet bundle Pb. Further, as illustrated in FIG. 20, when the base plate continue moving downward after the upper pressure plate 34 contacts the sheet P or the sheet bundle Pb, the coil springs 42a and 42b are pressed by the base plate 40, and the liquid application member 44 is moved downward to a position to touch or press down the sheet P or the sheet bundle Pb.

When the liquid application member 44 is moved downward to a position to touch or press down the sheet P or the sheet bundle Pb as illustrated in FIG. 20, the liquid application is performed and the liquid that is included in the liquid application member 44 is transmitted to and spread over the sheet P or the sheet bundle Pb.

As described above with reference to FIG. 17 to FIG. 20, liquid application is performed after the liquid application member 44 moves downward from the initial position or standby position and has moved a predetermined distance. At this moment in time, the amount of liquid applied to the sheet P or the sheet bundle Pb changes depending on the pressing distance between the liquid application member 44 and the sheet P or the sheet bundle Pb.

When the amount of the liquid applied to the sheet P in the liquid application and crimp binding is greater or less than a desired amount, the binding strength may become poor or unstable. In order to avoid such a situation, the amount of liquid applied to the sheet P is managed with a desired pressing distance to enhance or stabilize the binding strength.

After the liquid application member 44 has moved downward to the state as illustrated in FIG. 20 and the liquid application has been performed, the liquid-applier movement motor 37 is driven to rotate in a reverse direction to the direction when the liquid application member 44 moves downward. Accordingly, the liquid application member 44 moves upward. As a result, the liquid application member 44 is separated from the sheet P or the sheet bundle Pb, and the liquid application member 44 returns to a specified position, i.e., the standby position as illustrated in FIG. 17. When the liquid application member 44 returns to a specified position, the series of processes to apply the liquid to the sheet P or the sheet bundle Pb, which is an object to be processed, is completed.

As described above, a plurality of sheets P are stacked on top of each other and the liquid is applied to each one of the sheets P in a continuous manner. In such cases, as the number of sheets P that make up the sheet bundle Pb increases, the distance before the liquid application member 44 start pressing the sheet P becomes shorter due to the thickness of the sheets P. In order to handle such a situation, the moving distance of the liquid application member 44 in the liquid application is adjusted depending on the thickness of the sheet P that is an object to which the liquid is to be applied and the number of sheets P that make up the sheet bundle Pb. By so doing, a desired pressing distance is maintained. The liquid application is terminated after the liquid is applied to a given number of sheets (N).

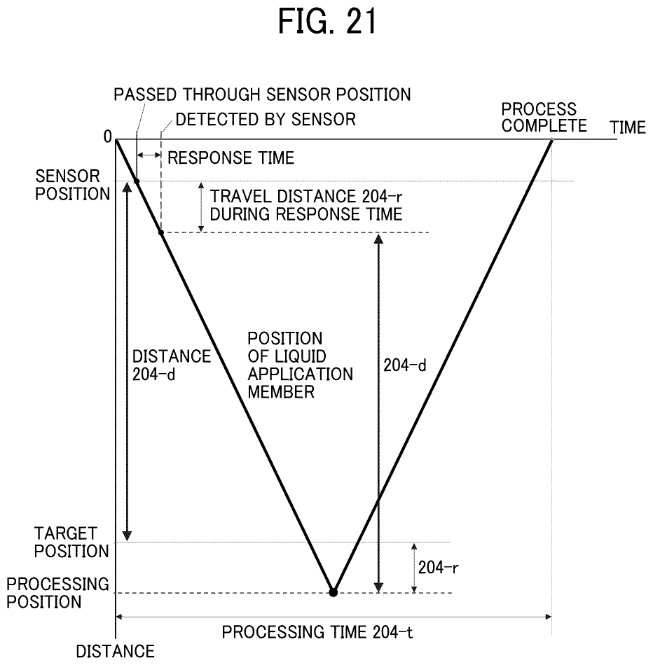

FIG. 21 is a graph illustrating the correlation between the moving distance of the liquid application member 44 and the time elapsed since the movement starts in a case that speed control is performed to increase the travel speed of the liquid application member 44 immediately after the liquid application starts.

FIG. 22 is a diagram illustrating the relative positions of the liquid application member 44 and the sheet P when no liquid is applied and the relative positions of the liquid application member 44 and the target position in the speed control described above with reference to FIG. 21.

In the graph of speed control described above with reference to FIG. 21, distance 0 (zero) indicates the position of the plate where the liquid application member 44 contacts the sheet P when no liquid is applied and the liquid application member 44 is at, for example, a position as illustrated in FIG. 17, and the target position indicates a position at which the liquid is applied to the sheet P as the liquid application member 44 contacts the sheet P or presses down the sheet P. It is assumed that, when the liquid application has just started, the moving distance of the liquid application member 44 and the time elapsed since the liquid application member 44 has started moving are 0 (zero).

In the speed control described above with reference to FIG. 21, the speed of the liquid application member 44 until reaching the processing position is referred to as the first speed.

When the liquid application member 44 is moved so as to contact the sheet P, the liquid application member 44 is moved by a predetermined distance such as a distance 204-d after detecting that the liquid application member 44 has passed through a detection field of the movement sensor 40a. By so doing, the moving distance to the target position and the pressing distance between the liquid application member 44 and the sheet P are managed.

When the liquid application member 44 passes through a detection field of the movement sensor 40a, the shutter 354 at the position of the movement sensor 40a when the liquid application member 44 is at the standby position moves to a position where the light emitted from the light emitter to the light receiver of the movement sensor 40a is not blocked. The output value of the detection signal from the movement sensor 40a changes when the liquid application member 44 is passing through a detection field of the movement sensor 40a. For example, the detection signal reaches a peak when the liquid application member 44 has just passed through a detection field of the movement sensor 40a.

By specifications, the movement sensor 40a has a slight time lag before an object passes through a detection field and the output value of the detection signal changes. Such a time lag is referred to as a response time. The response time slightly varies depending on the movement sensor 40a.

When the amount of movement of the liquid application member 44 or the contact time (208-c) for which the liquid application member 44 contacts or presses the sheet P is controlled in the liquid application, it is desired that the movement of the liquid application member 44 be stopped at the position to which the liquid application member 44 has moved from the standby position by a predetermined distance such as the distance 204-d. However, in the actual operation, after the shutter 354 has moved downward and reached a position where the value of the detection signal output from the movement sensor 40a reaches a peak and a response time has passed, a detection signal is detected, and it is determined that the shutter 354 has moved downward from the standby position. After such a determination, the liquid application member 44 is moved by a predetermined distance, i.e., the distance 204-d. As a result, the liquid application member 44 moves to a position exceeding a target position by an increased moving distance, i.e., the moving distance 204-r, to be added to a predetermined distance, i.e., the distance 204-d, during the response time.

Due to such a configuration, as the moving speed, i.e., the first speed in the present example, when the liquid application member 44 passes through a detection field of the movement sensor 40a is faster, the amount of movement exceeds a desired amount, and the moving distance becomes longer. Accordingly, as illustrated in FIG. 22, the pressing distance of the liquid application member 44 increases in the thickness direction of the sheet P, and the amount of the liquid applied to the sheet P increases. Accordingly, the speed of the liquid application member 44 when the liquid application member 44 passes through a detection field of the movement sensor 40a affects the amount of the liquid applied to the sheet P.

When the amount of the liquid applied to the sheet P in the liquid application and crimp binding is greater or less than a desired amount, the binding strength may become poor or unstable. Accordingly, an increase in the precision of the moving distance of the liquid application member 44 increases the stability of the liquid application and crimp binding.

The predetermined distance, i.e., the distance 204-d, may be adjusted in view of the increased moving distance, i.e., the moving distance 204-r, during the response time, that depends on the speed of the liquid application member 44. However, the increased moving distance, i.e., the moving distance 204-r, during the response time and the processing position vary due to a variation in response time. In view of these circumstances, even if the predetermined distance, i.e., the distance 204-d, is adjusted, the precision of the processing position may still be insufficient.

### First Embodiment

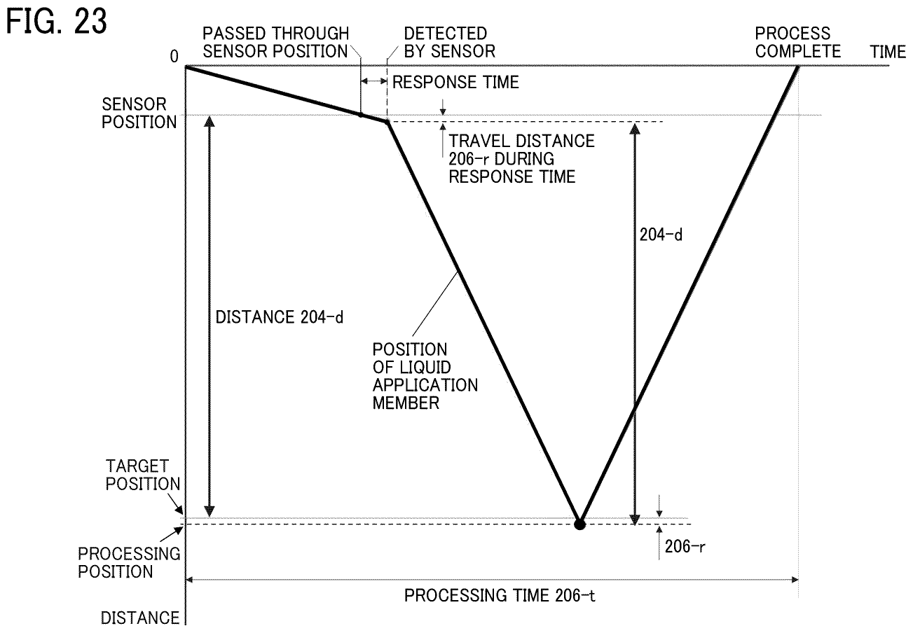

FIG. 23 is a diagram illustrating speed control of the edge binder 25, according to a first example. In the speed control according to the first example, the liquid application member 44 passes by a sensor at low speed in the liquid application.

The relative positions of the liquid application member 44 and the target position in the speed control described with reference to FIG. 23 are equivalent to those described above with reference to FIG. 22. It is assumed that when the liquid application has just started, the moving distance of the liquid application member 44 and the time elapsed since the liquid application member has started moving are 0 (zero).

In the speed control according to the present example described with reference to FIG. 23, the speed of the liquid application member 44 between the instant when the process starts and the detection by the sensor (when the liquid application member 44 has just passed through a detection field of the movement sensor 40a) is changed to the second speed. The speed between the instant when the shutter 354 passes through a detection field of the movement sensor 40a after the controller 100b makes a determination on the detection signal from the movement sensor 40a and the instant when the liquid application member 44 reaches the processing position is referred to as the first speed. In the present example, it is assumed that the second speed is slower than the first speed.

As the speed of the movement sensor 40a during the response time is changed to the second speed, the increased moving distance, i.e., the moving distance 206-r, during the response time becomes shorter than the increased moving distance, i.e., the moving distance 204-r. Accordingly, the difference between the target position and the processing position can be reduced, and the precision of the moving distance can be increased.

In the speed control described above with reference to FIG. 23, the processing time 206-t is made longer than the processing time 204-t. In order to handle such a situation, the speed of the liquid application member 44 is increased to the first speed after the detection is made by the sensor. By so doing, an increase in the processing time due to the movement at the second speed can be minimized, and the precision of the moving distance can be increased while a reduction in productivity is reduced.

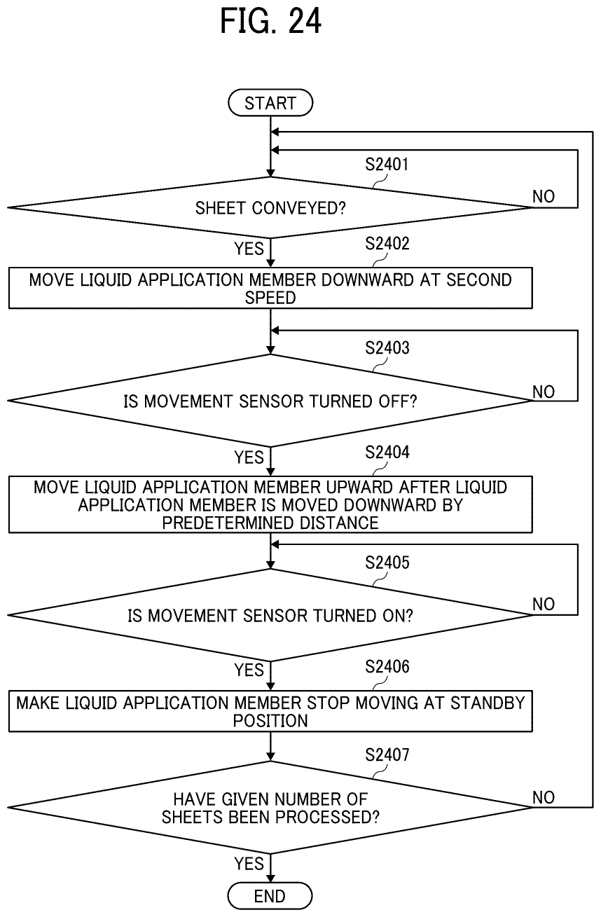

FIG. 24 is a flowchart of the speed control of the liquid application described above with reference to FIG. 23.

Firstly, the liquid application starts, and the process loops until the sheet P is conveyed to an area where the liquid application can be performed (NO in step S2401). When the sheet P is conveyed to an area where the liquid application can be performed (YES in step S2401), in step S2402, the liquid application member 44 moves downward from the position of distance zero (0) at the second speed.

Subsequently, the value of the detection signal output from the movement sensor 40a is monitored while the liquid application member 44 is moving downward, and the monitoring loops until the output value of the detection signal is switched to OFF (NO in step S2403). After the output value of the detection signal is switched to OFF (YES in step S2403), the speed of the liquid application member 44 is increased to the first speed. In step S2404, the liquid application member 44 is moved downward by the predetermined distance 204-d, and then the liquid application member 44 is moved upward. The speed of upward movement does not matter. However, in view of productivity, it is desired that the speed be equal to or higher than a certain level so as not to affect the productivity.

Subsequently, the output of the detection signal output from the movement sensor 40a is monitored while the liquid application member 44 is moving upward, and the monitoring loops until the output value of the detection signal is switched to ON (NO in step S2405). After the output value of the detection signal is switched to ON (YES in step S2405), in step S2406, the movement of the liquid application member 44 is stopped at the standby position.

After the liquid application member 44 returns to the standby position, in step S2407, it is determined whether the liquid application to the given number of sheets P has been completed. When it is determined that the number of treated sheets P has not reached a given number of sheets (NO in step S2407), the process is returned to step S2401. When it is determined that the number of treated sheets P has reached a given number of sheets (YES in step S2407), the liquid application ends.

### Second Embodiment

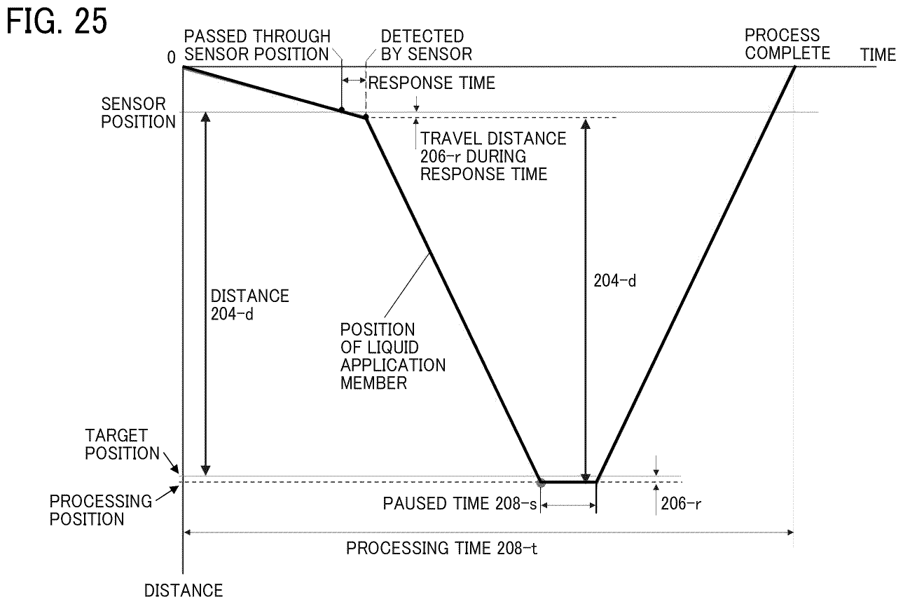

FIG. 25 is a graph illustrating speed control according to a second example, where the liquid application member 44 is moved to pass by a sensor at low speed in the liquid application.

The relative positions of the liquid application member 44 and the target position in the speed control described with reference to FIG. 25 are equivalent to those described above with reference to FIG. 22. In the speed control described with reference to FIG. 25, in addition to the speed control according to the first example described above with reference to FIG. 23, a paused time 208-s is arranged between the instant when the liquid application member 44 reaches the processing position and the instant when the liquid application member 44 starts moving upward.

In the liquid application, the liquid application member 44 is brought into contact with or pressed against the sheet P, and the liquid contained in the liquid application member 44 is transmitted to the sheet P. In so doing, the contact time where the liquid application member 44 keeps contacting the sheet P may be extended to increase the length of time for which the liquid is transmitted to and spread over the sheet P. In the contact time, the liquid application member 44 contacts and then presses the sheet P before moving away from the sheet P. As the length of time for which the liquid is transmitted to and spread over the sheet P is extended, a reduction in the degree of variation in the amount of liquid applied to the sheet P can be expected.

As the contact time is longer, the degree of variation in the amount of liquid applied to the sheet P can further be reduced. However, it is to be noted that the amount of the liquid applied to the sheet P may increase depending on the properties or characteristics of the liquid application member 44 or the sheet P. For this reason, a paused time needs to be taken into consideration in view of productivity or a desired amount of liquid in the liquid application.

In the speed control according to the second example, the paused time 208-s is arranged when the liquid application member 44 is at the processing position. Due to such a configuration, the length of time for the liquid application member 44 is contacting the sheet P is extended, and the amount of liquid applied to the sheet P is increased. During the paused time 208-s, the liquid application member 44 keeps contacting the sheet P. The length of time of the paused time 208-s is not determined by any rules, and the length of time of the paused time 208-s may be changed depending on, for example, the amount of the liquid applied to a targeted sheet P or the data of the sheet P to which the liquid is to be applied. After the paused time 208-s has passed, the liquid application member 44 is moved away from the sheet P. Then, the liquid application member 44 is moved to the point of distance zero (0), and the liquid application is terminated.

In the paused time 208-s described with reference to FIG. 25, the liquid application member 44 stops moving at the contacting the sheet P, and the liquid application member 44 is kept contacting the sheet P for given time. Accordingly, the paused time 208-s corresponds to the extension of the contact time.

In the second example, the contact time for which the liquid application member 44 contacts the sheet P is extended. In so doing, it is satisfactory as long as the liquid application member 44 contacts the sheet P for the paused time 208-s described with reference to FIG. 25, and it is not necessary for the liquid application member 44 to stop moving during this time. In other words, the length of time for which the liquid is transmitted to and spread over the sheet P can be extended by controlling the movement of the liquid application member 44 such that the length of time elapsed between the instant when the liquid application member 44 contacts the sheet P and the instant when the liquid application member 44 is separated from the sheet P will be equal to the length of the paused time 208-s.

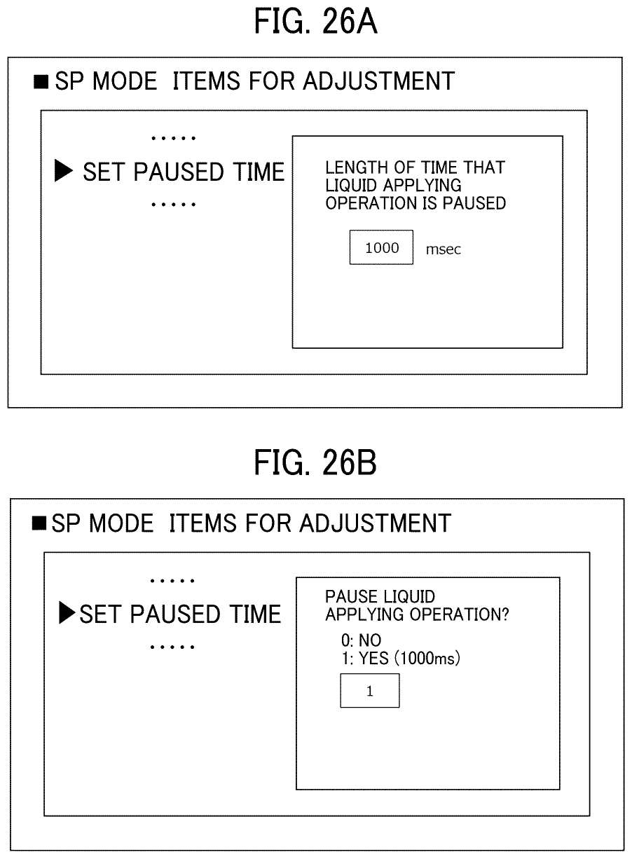

FIG. 26A and FIG. 26B are diagrams illustrating a user interface used for setting the paused time 208-s, according to the second example.

As illustrated in FIG. 26A, when a setting screen is used on the operation panel 110, a selected paused time is displayed in a frame. By changing the input value, the paused time 208-s of the liquid applying operation is set.

As illustrated in FIG. 26B, set items and the corresponding texts are displayed on the setting screen. When texts are input in the frame, a matched pause setting is applied. Whether or not the time is displayed when a pause is applied does not matter. As illustrated in FIG. 26B, only two kinds including “0: NO” and “1: YES (1000 ms)” are available as the pause setting in the present example. However, no limitation is indicated thereby, and varying kinds of setting may be applied to the pause. For example, a larger number of items may be set, and “2: YES (500 ms)” or “3: YES (100 ms)” may be made available.

FIG. 27 is a flowchart of the speed control of the liquid application described above with reference to FIG. 25.

Firstly, the liquid application starts, and the process loops until the sheet P is conveyed to an area where the liquid application can be performed (NO in step S2701). When the sheet P is conveyed to an area where the liquid application can be performed (YES in step S2701), in step S2702, the liquid application member 44 moves downward from the position of distance zero (0) at the second speed.

Subsequently, the value of the detection signal output from the movement sensor 40a is monitored while the liquid application member 44 is moving downward, and the monitoring loops until the output value of the detection signal is switched to OFF (NO in step S2703). After the output value of the detection signal is switched to OFF (YES in step S2703), in step S2704, the speed of the liquid application member 44 is increased to the first speed and the liquid application member 44 is moved downward by a predetermined distance 204-d, i.e., the distance 204-d, at the first speed.

Subsequently, the pause setting is referred to. When pausing is effective (YES in step S2705), in step S2706, pausing is carried out for predetermined length of time. Subsequently, in step S2707, the liquid application member 44 is moved upward. When pausing is not effective (NO in step S2705), in step S2707, the liquid application member 44 is moved upward without carrying out pausing. The speed of upward movement does not matter. However, in view of productivity, it is desired that the speed be equal to or higher than a certain level so as not to affect the productivity.

Subsequently, the value of the detection signal output from the movement sensor 40a is monitored while the liquid application member 44 is moving upward, and the monitoring loops until the output value of the detection signal is switched to ON (NO in step S2708). After the output value of the detection signal is switched to ON (YES in step S2708), in step S2709, the liquid application member 44 is made stop moving at the standby position.

After the liquid application member 44 returns to the standby position, in step S2710, it is determined whether the liquid application to the given number of sheets P has been completed. When it is determined that the liquid application to the given number of sheets P has not been completed (NO in step S2710), the process is returned to step S2701. When it is determined that the liquid application to the given number of sheets P has been completed (YES in step S2710), the liquid application ends.

In the present example, the pause setting is referred to in step S2705. However, no limitation is indicated thereby. As long as an operation equivalent to that in step S2705 can be carried out, the timing at which the pause setting is referred to does not matter.

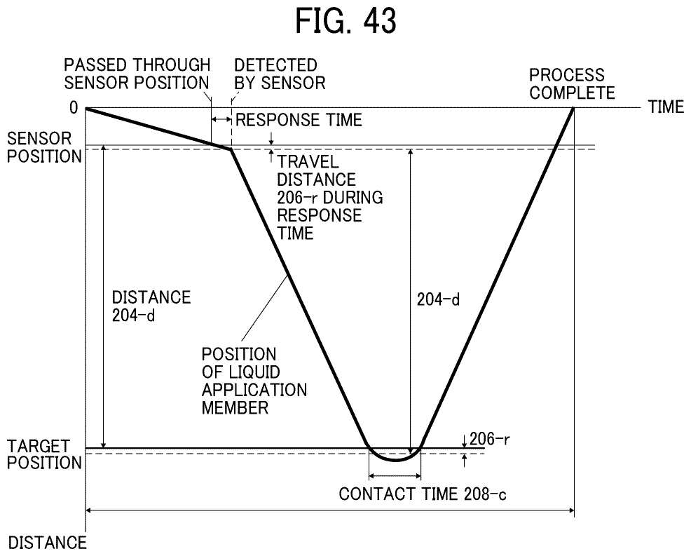

FIG. 43 is another diagram illustrating the speed control according to the second example.

The relative positions of the liquid application member 44 and the target position in the speed control described with reference to FIG. 43 are equivalent to those described above with reference to FIG. 22. In the speed control described with reference to FIG. 43, in addition to the speed control according to the second example described above with reference to FIG. 25, the speed of the liquid application member 44 is increased or decreased while the liquid application member 44 is contacting the sheet P. In so doing, a contact time 208-c whose length is equivalent to the paused time 208-s is arranged.

Typically, when the liquid application member 44 contacts the sheet P for a longer time, the degree of variation in the amount of liquid applied to the sheet P can be reduced. However, the amount of the liquid applied to the sheet P may increase to an amount greater than a desired amount depending on the properties or characteristics of the liquid application member 44 or the sheet P or the amount of movement of the liquid application member 44 that is contacting the sheet P. For this reason, the length of time for which the liquid application member 44 contacts the sheet P, which corresponds to the length of the contact time (208-c), needs to be taken into consideration in view of productivity or a desired amount of liquid in the liquid application.

In the speed control described with reference to FIG. 43, the contact time 208-c where the liquid application member 44 keeps contacting the sheet P is arranged to increase the amount of liquid applied to the sheet P.

In the speed control described with reference to FIG. 43, the liquid application member 44 in the contact time 208-c gradually reduces the speed from the first speed, and then gradually increases the speed so as to move away from the sheet P. The length of the contact time 208-c and the speed or control speed of the liquid application member 44 in the contact time 208-c are not necessarily limited to any particular length or speed, and may be changed depending on, for example, a desired amount of liquid applied to the sheets in the liquid applying operation or the properties or characteristics of the sheet P to which the liquid is to be applied.

In the speed control described with reference to FIG. 43, reduction in speed is started after the liquid application member 44 has reached the processing position, and acceleration to move away from the sheet P is started immediately after the speed of the liquid application member 44 has become zero. However, the timings at which the liquid application member 44 starts increasing or decreasing the speed is not limited to any particular timing. As long as the liquid application member 44 keeps contacting the sheet P, the liquid application member 44 may stop moving and the speed may be zero for some time.

After the contact time 208-c has passed, the liquid application member 44 is moved away from the sheet P. Then, the liquid application member 44 is moved to the point of distance zero (0), and the liquid application ends.

### Third Embodiment

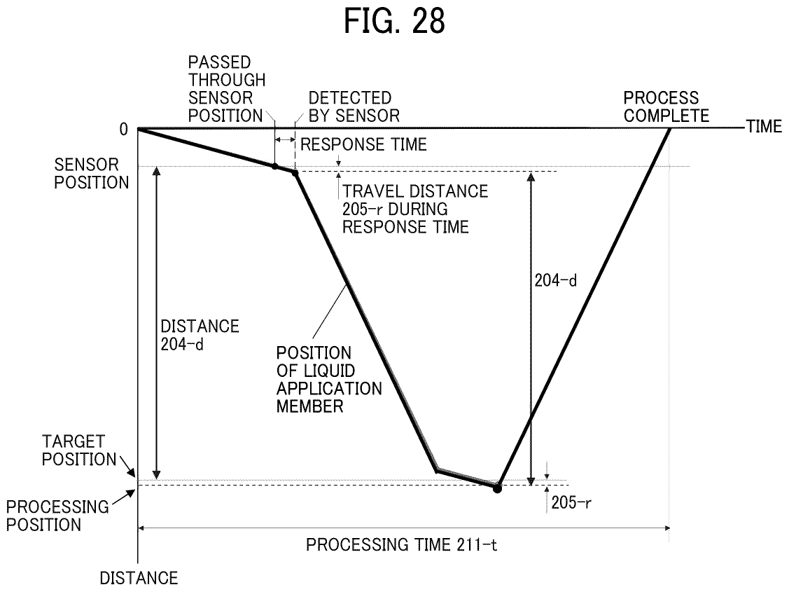

FIG. 28 is a diagram illustrating speed control according to a third example, where the speed is reduced before the liquid application member 44 reaches the processing position in the liquid application.

The relative positions of the liquid application member 44 and the target position in the speed control described with reference to FIG. 28 are equivalent to those described above with reference to FIG. 22. In the speed control described with reference to FIG. 28, the speed between the instant when the process starts and the detection by the sensor is controlled to be the second speed, and the speed after the detection by the sensor is increased to the first speed. The speed of the liquid application member 44 is then controlled to be the third speed, which is decelerated from the first speed, before the liquid application member 44 reaches the processing position. The second speed and the third speed are slower than the first speed, and the third speed may be equivalent to the second speed. In other words, the liquid application member 44 moves towards the target position at the first speed, and then reaches the processing position through the movement at the third speed.

Depending on the structure or configuration of the liquid applier 31A, the liquid application member 44 has a gap, backlash, or play in the thickness direction of the sheet P. When the speed is abruptly reduced from the first speed and the liquid application member 44 stops moving speed when the liquid application member 44 reaches the processing position, the liquid application member 44 may rattle through inertia in the thickness direction of the sheet P, and the processing position may vary.

In the third example, the speed of the liquid application member 44 is changed from the first speed to the third speed before the liquid application member 44 reaches the processing position. Due to such a configuration, the influence of inertia can be reduced, and the liquid application member 44 can be prevented from rattling. Accordingly, the precision of the processing position can be increased.

### Fourth Embodiment

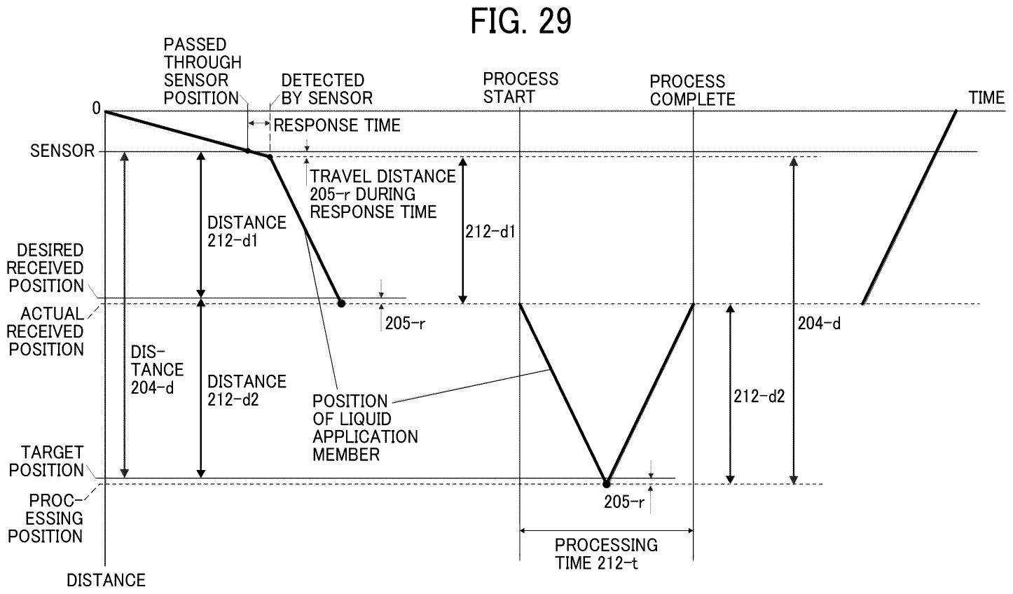

FIG. 29 is a diagram illustrating speed control according to a fourth example, where the speed control of the liquid application member 44 starts at the position where the sheet P is received.

The relative positions of the liquid application member 44 and the target position in the speed control described with reference to FIG. 29 are equivalent to those described above with reference to FIG. 22.

When the sheet P is received, preferably, the liquid application member 44 gests closer to the sheet P than the point of distance zero (0), and the difference in height between the upper pressure plate 34 and the lower pressure plate 33 is sufficient to accept the sheet P as illustrated in, for example, FIG. 18.

Regarding the position of the liquid application member 44 in the speed control according to the fourth example, the point of distance zero (0) is referred to as the first standby position (see FIG. 17), and the position at which the sheet P is received is referred to as the second standby position (see FIG. 18). When no liquid is to be applied, the liquid application member 44 is at the first standby position.

Before the liquid application is performed, the liquid application member 44 is moved from the first standby position to the second standby position, and goes on standby. Then, the process starts from the second standby position. Due to such a configuration, the moving distance and the processing time in the liquid application can be shortened, and the productivity can be increased.

The processes can be done with a processing time 212-t shorter than the processing time 206-t and the processing time 204-t where the process starts from the first standby position.

In the movement from the first standby position to the second standby position, it is desired that the speed of the liquid application member 44 before the movement sensor 40a detects the liquid application member 44 be the second speed in order to increase the precision of the processing position. In the present example, the speed of the liquid application member 44 between the instant when the movement sensor 40a has detected the liquid application member 44 and the instant when the liquid application member 44 reaches the second standby position does not matter because that speed does not influence the productivity and the precision of the processing position. The distance from the movement sensor 40a to the target position is referred to as the distance 204-d, and the distance from the movement sensor 40a to the second standby position is referred to as the distance 212-d1. The moving distance from the second standby position in the liquid application is obtained by subtracting the distance 212-d1 from the distance 204-d, and such a moving distance is referred to as a distance 212-d2.

Also in the liquid application where the liquid application member 44 goes on standby at the second standby position, the liquid application member 44 goes beyond the second standby position or the target position in an unintentional manner by the moving distance during the response time. In order to handle such a situation, the liquid application member 44 is moved at the second speed until the movement sensor 40a detects the liquid application member 44. By so doing, the moving distance during the response time can be shortened, and the precision of the moving distance can be increased.

When the liquid is applied to a plurality of sheets P in a continuous manner, the liquid application member 44 reciprocates from the second standby position with the distance 212-d2. Due to such a configuration, the liquid application can be performed while maintaining an increase in the productivity or the precision of the moving distance according to the present embodiment.

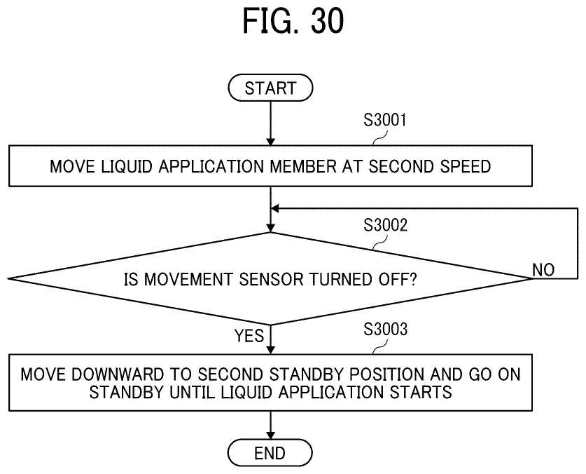

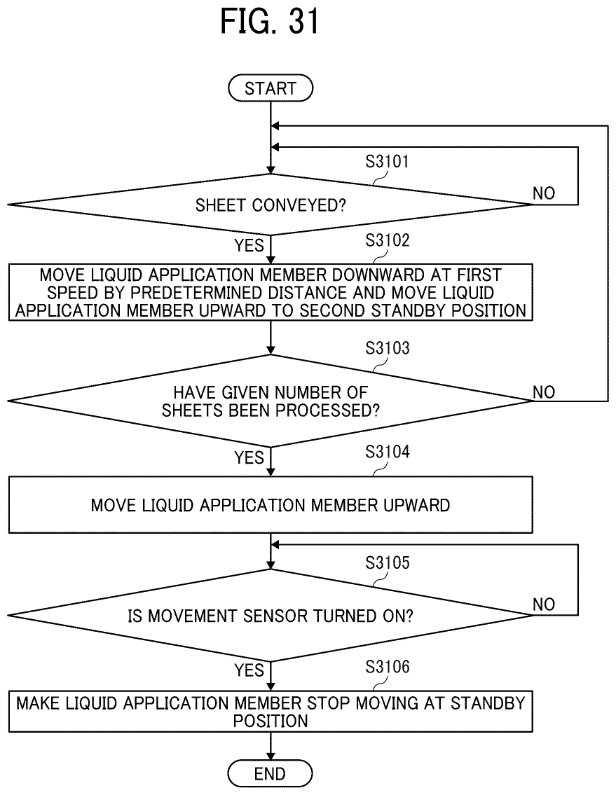

FIG. 30 and FIG. 31 are flowcharts of the speed control of the liquid application described above with reference to FIG. 29.

Firstly, when no liquid is applied, in order to increase the precision of the processing position, in step S3001, the liquid application member 44 is moved downward from the position of distance zero (0) to the second standby position at the second speed. The value of the detection signal output from the movement sensor 40a is monitored while the liquid application member 44 is moving downward, and the monitoring loops until the output value of the detection signal is switched to OFF (NO in step S3002). After the output value of the detection signal is switched to OFF (YES in step S3002), in step S3003, the speed of the liquid application member 44 is increased to the first speed, and the liquid application member 44 is moved downward by a predetermined distance in a continuous manner. For example, the liquid application member 44 moves downward to the second standby position by a predetermined distance, i.e., the distance 212-d1, and then stops moving and goes on standby until liquid application starts.

Subsequently, as illustrated in FIG. 31, the process loops until the sheet P is conveyed to an area where the liquid application can be performed (NO in step S3101). When the sheet P is conveyed to an area where the liquid application can be performed (YES in step S3101), the liquid application member 44 is moved downward at the first speed by a predetermined distance, e.g., a distance 212-d2, from the second standby position to the processing position. In step S3102, the liquid application member 44 is moved downward by the predetermined distance, e.g., the distance 212-d2, and then the liquid application member 44 is moved upward by the predetermined distance, e.g., the distance 212-d2, that corresponds to the total amount of downward movement from the point where the liquid application starts. The speed of upward movement does not matter. However, in view of productivity, it is desired that the speed be equal to or higher than a certain level so as not to affect the productivity.

Subsequently, in step S3103, it is determined whether the liquid application to the given number of sheets P has been completed. When it is determined that the number of treated sheets P has not reached a given number of sheets (NO in step S3103), return the process to step S3101. When it is determined that the liquid application to the given number of sheets P has been completed (YES in step S3103), in step S3104, the liquid application member 44 is moved upward.

The value of the detection signal output from the movement sensor 40a is monitored while the liquid application member 44 is moving upward, and the monitoring loops until the output value of the detection signal is switched to ON (NO in step S3105). After the output value of the detection signal is switched to ON (YES in step S3105), in step S3106, the liquid application member 44 is made stop moving at the standby position.

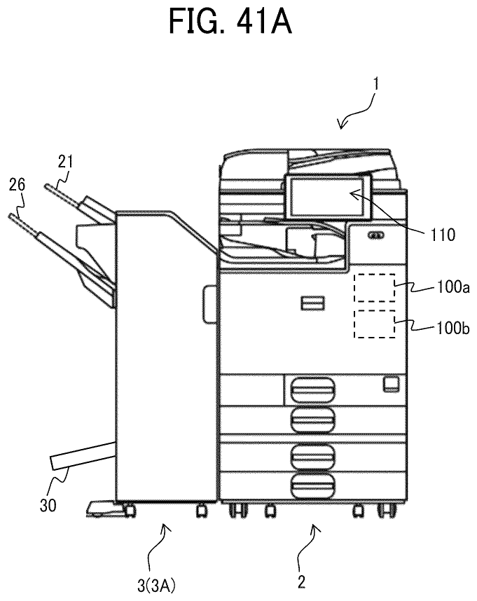

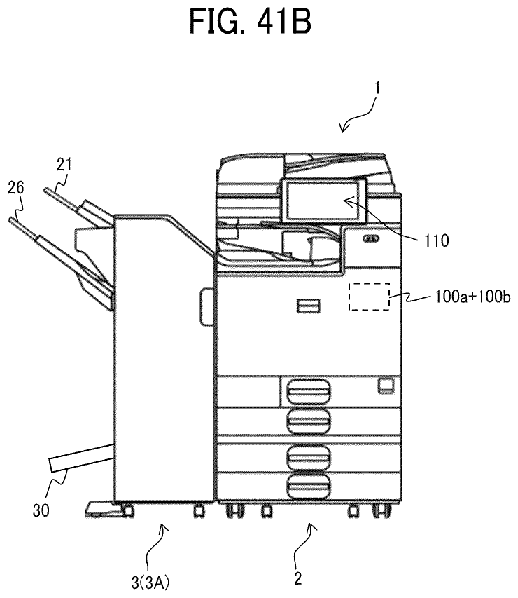

In the above description, the controller 100b of the post-processing apparatus 3 is provided separately from the controller 100a of the image forming apparatus 2 as illustrated in FIG. 1. However, the present disclosure is not limited to the above-described configuration. For example, as illustrated in FIG. 41A, the controller 100b of the post-processing apparatus 3 may be disposed in the image forming apparatus 2. Further, as illustrated in FIG. 41B, the controller 100b of the post-processing apparatus 3 may be integrated with the controller 100a of the image forming apparatus 2.

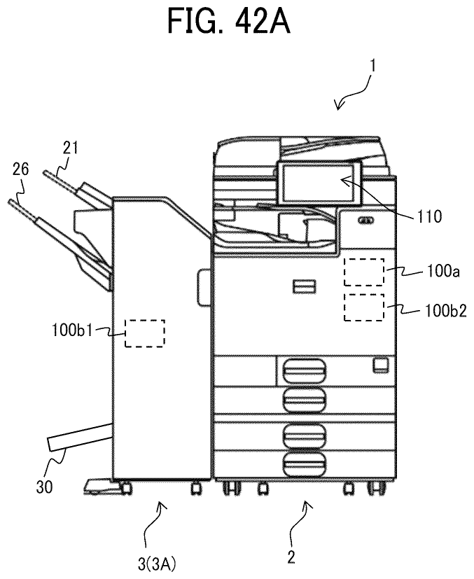

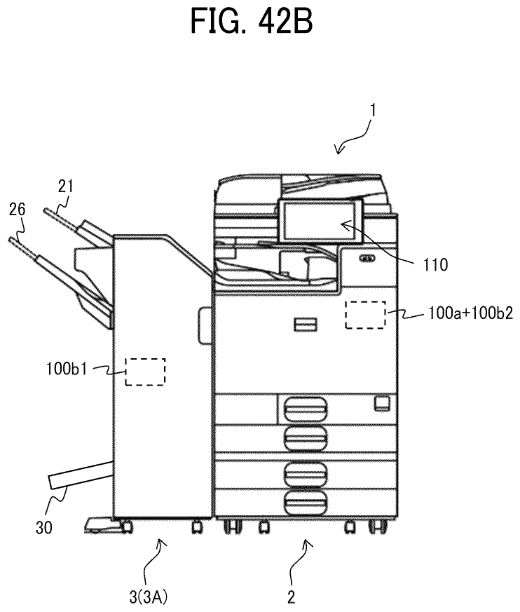

As illustrated in FIG. 42A, the controller 100b of the post-processing apparatus 3 may be divided into a controller 100b1 (e.g., a driver system such as a motor) and a controller 100b2 (e.g., a sensor system including a sensor) according to the functions, and only the controller 100b2 of the post-processing apparatus 3 may be disposed in the image forming apparatus 2. Further, as illustrated in FIG. 42B, the controller 100b2 of the post-processing apparatus 3 disposed in the image forming apparatus 2 may be integrated with the controller 100a of the image forming apparatus 2.

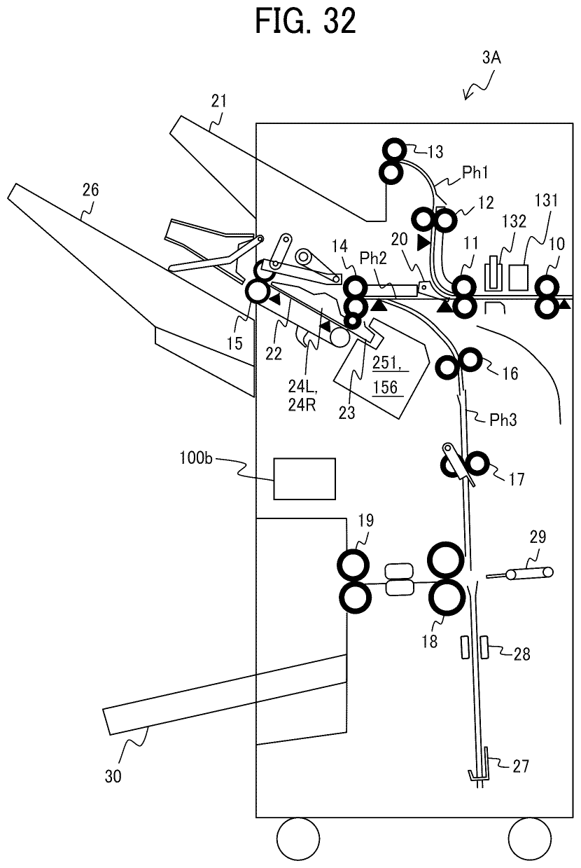

The post-processing apparatus 3A according to the second embodiment is described below with reference to FIG. 32 to FIG. 40. In the following description, the same or similar components as those of the post-processing apparatus 3 according to the first embodiment are denoted by the identical or similar reference signs, and redundant descriptions thereof may be omitted.

The post-processing apparatus 3A according to the second embodiment includes an edge binder 251. The edge binder 251 is different from the edge binder 25 of the post-processing apparatus 3 according to the first embodiment, in which the liquid applier 31 and the crimper 32 are arranged side by side, in that the edge binder 251 includes a crimper 32′ and a liquid applier 131 is disposed at an upstream position in a direction in which a sheet P is conveyed. Such a configuration allows a given number of sheets P to be stacked in advance after the liquid application process and conveyed to the crimper 32′ of the edge binder 251 disposed at a downstream position in the direction in which the sheet P is conveyed. Accordingly, the productivity of the binding performed by the crimper 32′ is enhanced.

Since the direction in which the conveyance roller pairs 10, 11, and 14 convey the sheet P is opposite to the “conveyance direction” defined above, the direction in which the conveyance roller pairs 10, 11, and 14 convey the sheet P is defined as an “opposite conveyance direction” in the following description. A direction that is orthogonal to both the reverse conveyance direction and the thickness direction of the sheet P is defined as the “main scanning direction” or the “width direction of the sheet P.”

The liquid application position to which the liquid is applied on the sheet P or the sheet bundle Pb by the liquid applier 131 corresponds to the binding position on the sheet bundle Pb to be crimped and bound by the crimper 32′. For this reason, in the following description, the liquid application position and the binding position are described with the same reference sign.

FIG. 32 is a diagram illustrating an internal structure of the post-processing apparatus 3A according to the second embodiment.

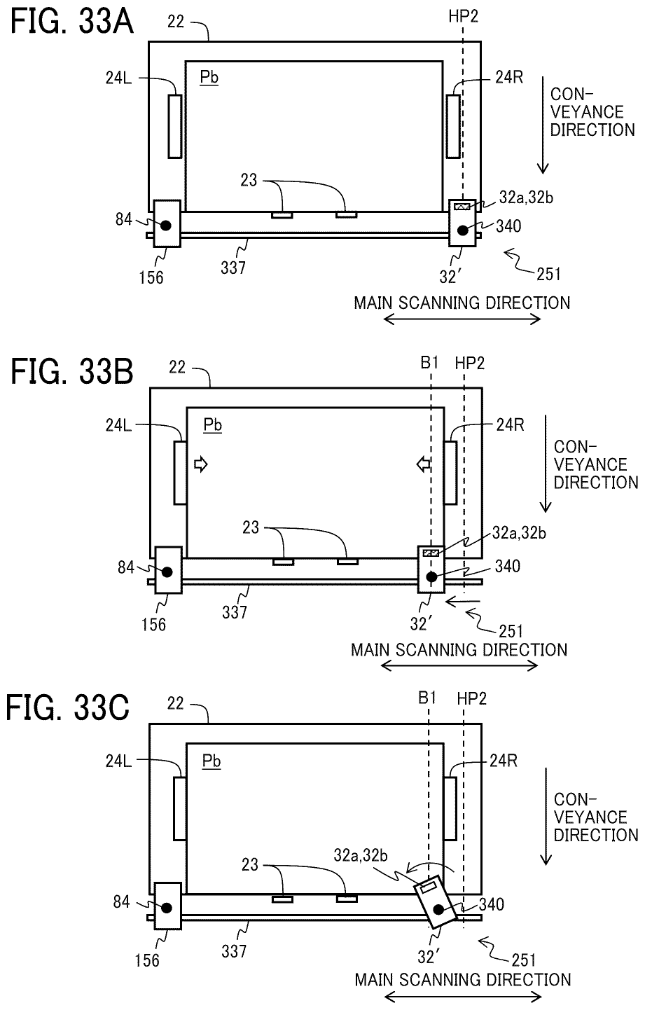

As illustrated in FIG. 33A to FIG. 33C, the edge binder 251 includes the crimper 32′. As illustrated in FIG. 33A to FIG. 33C, the crimper 32′ and the staple binder 156 are disposed downstream from the internal tray 22 in the conveyance direction. In addition, the crimper 32′ and the staple binder 156 are located to face a downstream end, in the conveyance direction, of the sheet bundle Pb placed on the internal tray 22 and is movable in the main scanning direction.

Further, the crimper 32′ and the staple binder 156 are rotatable in both forward and reverse directions about a crimper shaft 340 and a stapler shaft 84 both extending in the thickness direction of the sheet bundle Pb placed on the internal tray 22. In other words, the crimper 32′ and the staple binder 156 bind, at a desired angle, any desired position in the main scanning direction on the sheet bundle Pb placed on the internal tray 22 in, for example, corner oblique binding, parallel one-point binding, or parallel two-point binding.

The crimper 32′ presses and deforms the sheet bundle Pb with the serrate upper crimping teeth 32a and the serrate lower crimping teeth 32b to bind the sheet bundle Pb. In the following description, such a binding way may be referred to as “crimping.” In other words, the crimper 32′ crimps and binds the sheet bundle Pb or performs the crimping on the sheet bundle Pb. On the other hand, the staple binder 156 passes the staple through a binding position on the sheet bundle Pb placed on the internal tray 22, thus allowing the sheet bundle Pb to be stapled.

FIG. 33A to FIG. 33C are schematic diagrams of the internal tray 22 viewed in the thickness direction of the sheet bundle Pb.

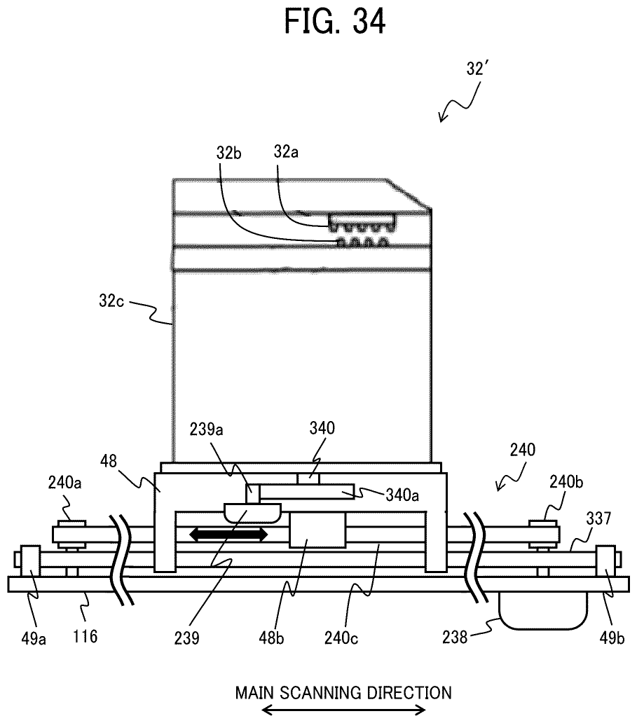

FIG. 34 is a schematic diagram illustrating a downstream side of the crimper 32′ in the conveyance direction.

As illustrated in FIG. 33A to FIG. 33C, the crimper 32′ and the staple binder 156 are disposed downstream from the internal tray 22 in the conveyance direction. The crimper 32′ is movable in the main scanning direction along the surface of the sheet bundle Pb placed on the internal tray 22. Further, the crimper 32′ is rotatable in both forward and reverse directions about a crimper shaft 340 extending in the thickness direction of the sheet bundle Pb placed on the internal tray 22.

In a similar manner to the above, the staple binder 156 is movable in the main scanning direction of the sheet bundle Pb. Further, the staple binder 156 is rotatable in both forward and reverse directions about a stapler shaft 84 extending in thickness direction of the sheet bundle Pb. The other configurations of the staple binder 156 are equivalent to those of the staple binder 55 of the post-processing apparatus 3 according to the first embodiment (see FIG. 9).

As illustrated in FIG. 34, the crimper 32′ includes a guide rail 337 extending in the main scanning direction at a position downstream from the internal tray 22 in the conveyance direction. The crimper 32′ includes a crimper movement motor 238 as a driving source. A base 48 supporting a crimper frame 32c has a fastening portion 48b for a timing belt 240c at the bottom of the base 48. The driving force of the crimper movement motor 238 is transmitted to the base 48 by the drive transmission assembly 240 that includes the pulleys 240a and 240b, the timing belt 240c, and the fastening portion 48b. By so doing, the crimper 32′ is moved in the main scanning direction along the surface of the sheet bundle Pb placed on the internal tray 22, in other words, along the guide rail 337. The crimper shaft 340 including a drive transmission gear 340a is fixed to a bottom face of the crimper frame 32c that holds the components of the crimper 32′.

The crimper shaft 340 and the drive transmission gear 340a are held by a base 48 on which the crimper frame 32c is disposed, so as to be rotatable in both forward and reverse directions. The drive transmission gear 340a meshes with an output gear 239a of a crimper pivot motor 239. When the driving force of the crimper pivot motor 239 is transmitted to the crimper shaft 340 via the output gear 239a and the drive transmission gear 340a, the crimper 32′ rotates in both forward and reverse directions on the base 48 about the crimper shaft 340 extending in the thickness direction of the sheet P placed on the internal tray 22. The guide rail 337, the crimper movement motor 238, the crimper pivot motor 239, the crimper shaft 340, and the drive transmission assembly 240 makes up at least part of the driving mechanism of the crimper 32′.

The crimper 32′ is movable between a standby position HP2 illustrated in FIG. 33A and a position where the crimper 32′ faces the first binding position B1 illustrated in FIG. 33B and FIG. 33C. The standby position HP2 is a position away in the main scanning direction from the sheet bundle Pb placed on the internal tray 22. The first binding position B1 is a position on the sheet bundle Pb placed on the internal tray 22. However, the specific position of the first binding position B1 is not limited to the position illustrated in FIG. 33A to FIG. 33C. The first binding position B1 may be one or more positions along the main scanning direction at the downstream end, in the conveyance direction, of the sheet P.

The posture of the crimper 32′ changes or is pivoted between a parallel binding posture illustrated in FIG. 33B and an oblique binding posture illustrated in FIG. 33C. In other words, the crimper 32′ is rotatable in both forward and reverse directions about the crimper shaft 340. The parallel binding posture is a posture of the crimper 32′ in which the length of the upper crimping teeth 32a and the lower crimping teeth 32b (in other words, a rectangular crimp binding trace) is along the main scanning direction. The oblique binding posture is a posture of the crimper 32′ in which the longer-side direction of the upper crimping teeth 32a and the lower crimping teeth 32b (i.e., the rectangular crimping trace) is inclined with respect to the main scanning direction.

The pivot angle in the inclined binding posture, which an angle of the upper crimping teeth 32a and the lower crimping teeth 32b with respect to the main scanning direction, is not limited to the example of FIG. 33C, and may be any angle provided that the upper crimping teeth 32a and the lower crimping teeth 32b face the sheet bundle Pb placed on the internal tray 22.

The post-processing apparatus 3A includes the liquid applier 131 and a hole punch 132, which is an example of a processor. The liquid applier 131 and the hole punch 132 are disposed upstream from the internal tray 22 in the opposite conveyance direction. Moreover, the liquid applier 131 and the hole punch 132 are disposed at different positions in the reverse conveyance direction to simultaneously face one sheet P that is conveyed by the conveyance roller pairs 10 to 19.

The liquid applier 131 and the hole punch 132 according to the present embodiment are disposed between the conveyance roller pairs 10 and 11. However, the arrangement of the liquid applier 131 is not limited to the example of FIG. 32. For example, in a case where an inserter 6 is disposed between the image forming apparatus 2 and the post-processing apparatus 3A as illustrated in FIG. 40, the liquid applier 131 may be disposed inside the inserter 6 located upstream from the post-processing apparatus 3A in a direction in which the sheet P is conveyed from the image forming apparatus 2 to the post-processing apparatus 3A. Examples of the inserter 6 include, but are not limited to, an apparatus that allows a pre-printed medium, which is to be conveyed to the post-processing apparatus 3A together with the sheet P conveyed from the image forming apparatus 2, to be fed as a cover sheet, an insertion sheet, or a partition sheet without passing through the image forming apparatus 2.

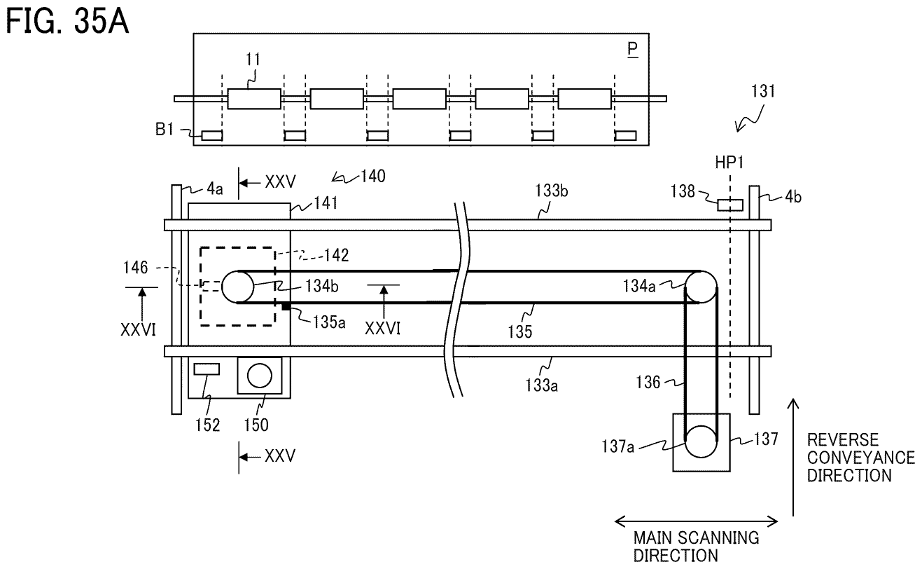

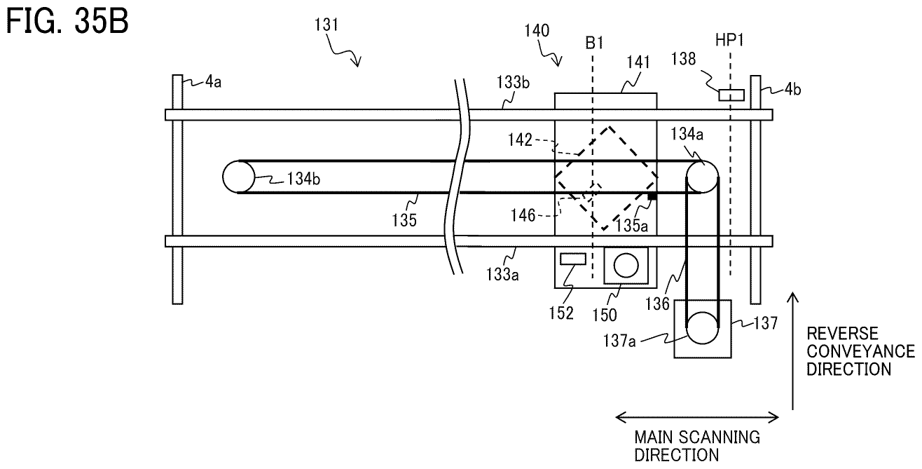

As illustrated in FIG. 35A, the conveyance roller pair 11 is located so as not to overlap, in the main scanning direction, the first liquid application position B1 on the sheet P to which the liquid has been applied by a liquid application head 146 of the liquid applier 131. This arrangement is to prevent the amount of liquid at the first liquid application position B1 from decreasing due to the multiple roller pairs pressing the first liquid application position B1 when the conveyance roller pair 11 conveys the sheet P. As a result, when the sheet P reaches the crimper 32′ disposed downstream from the liquid applier 131 in the opposite conveyance direction, the amount of liquid at the first liquid application position B1 is sufficient to maintain the binding strength. Accordingly, the binding strength of the sheet bundle Pb is prevented from decreasing due to a decrease in the amount of liquid at the first liquid application position B1 (corresponding to the first binding position B1) while the sheet P is conveyed.

In addition, the multiple roller pairs of the conveyance roller pair 11 that is located so as not to overlap the first liquid application position B1 on the sheet P in the main scanning direction prevents the conveying performance of the sheet P from being worse due to the adhesion of liquid to the multiple roller pairs and further prevents a conveyance jam caused by the worsened conveying performance of the sheet P.

Although only the conveyance roller pair 11 has been described above, the multiple roller pairs of the conveyance roller pairs 14 and 15 are preferably located so as not to overlap the first liquid application position B1 on the sheet P in the main scanning direction, like the multiple roller pairs of the conveyance roller pair 11.

The liquid applier 131 applies liquid to the sheet P that is conveyed by the conveyance roller pairs 10 and 11. In the following description, the application of liquid may be referred to as “liquid application.” The hole punch 132 punches a hole in the sheet P that is conveyed by the conveyance roller pairs 10 and 11 such that the hole penetrates the sheet P in the thickness direction of the sheet P. The processor disposed near the liquid applier 131 is not limited to the hole punch 132. Alternatively, the processor may be an inclination corrector that corrects an inclination or skew of the sheet P that is conveyed by the conveyance roller pairs 10 and 11.

FIG. 35A and FIG. 35B are diagrams illustrating the liquid applier 131 according to the second embodiment, viewed in the thickness direction of the sheet P.

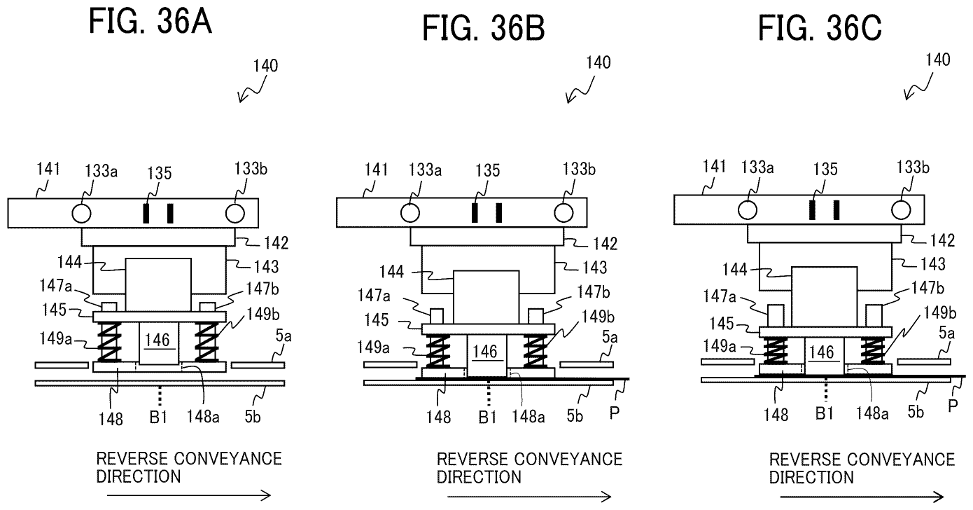

FIG. 36A to FIG. 36C are sectional views of the liquid applier 131, taken along a line XXV-XXV of FIG. 35A.

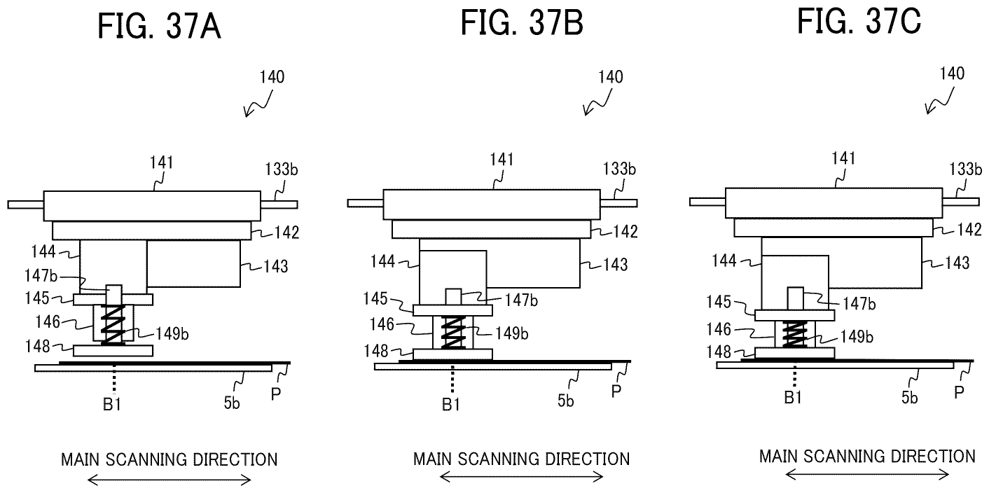

FIG. 37A to FIG. 37C are sectional views of the liquid applier 131, taken along a line XXVI-XXVI of FIG. 35A.

As illustrated in FIG. 35A to FIG. 37C, the liquid applier 131 includes a pair of guide shafts 133a and 133b, a pair of pulleys 134a and 134b, annular seamless belts 135 and 136, a liquid-applier movement motor 137, a standby position sensor 138, and the liquid application unit 140.

The pair of guide shafts 133a and 133b each extend in the main scanning direction at positions spaced apart from each other in the opposite conveyance direction. The pair of guide shafts 133a and 133b are supported by a pair of side plates 4a and 4b of the post-processing apparatus 3A. The pair of guide shafts 133a and 133b support the liquid application unit 140 such that the liquid application unit 140 can move in the main scanning direction.

The pair of pulleys 134a and 134b is disposed between the guide shafts 133a and 133b in the opposite conveyance direction. Moreover, the pair of pulleys 134a and 134b are spaced from each other in the main scanning direction. The pulleys 134a and 134b are supported by a frame of the post-processing apparatus 3A so as to be rotatable in both forward and reverse directions about the respective rotary shafts extending in the thickness direction of the sheet P.

The annular seamless belt 135 is looped around the pair of pulleys 134a and 134b. The annular seamless belt 135 is coupled to the liquid application unit 140 by a connection 135a. The annular seamless belt 136 is entrained around the pulley 134a and a driving pulley 137a that is fixed to an output shaft of the liquid-applier movement motor 137. The liquid-applier movement motor 137 generates a driving force to move the liquid application unit 140 in the main scanning direction.

As the liquid-applier movement motor 137 rotates, the annular seamless belt 136 circulates around the pulley 134a and the driving pulley 137a to rotate the pulley 134a. As the pulley 134a rotates, the annular seamless belt 135 circulates around the pair of pulleys 134a and 134b. Thus, the liquid application unit 140 moves in the main scanning direction along the pair of guide shafts 133a and 133b. The liquid application unit 140 reciprocates in the main scanning direction in response to the rotation direction of the liquid-applier movement motor 137 being switched.

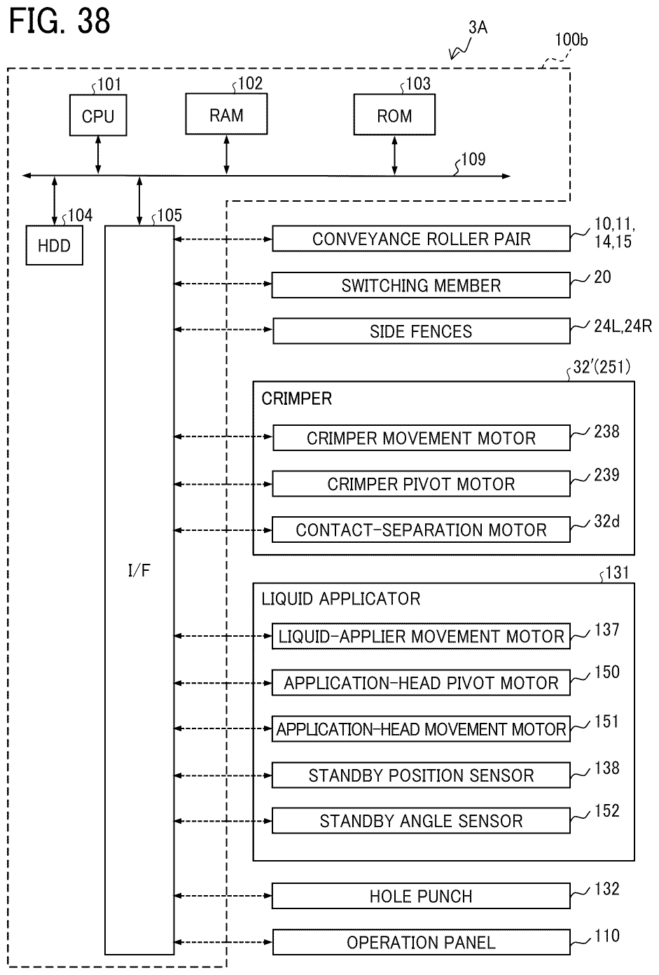

The standby position sensor 138 detects that the liquid application unit 140 has reached a standby position HP1 (see FIG. 35A and FIG. 35B) in the main scanning direction. The standby position sensor 138 then outputs a standby position signal indicating the detection result to the controller 100b, which will be described below with reference to FIG. 38. The standby position sensor 138 is, for example, an optical sensor including a light emitter and a light receiver. At the standby position HP1, the liquid application unit 140 blocks the optical path between the light emitter and the light receiver. The standby position sensor 138 outputs the standby position signal in response to the light output from the light emitter not being received by the light receiver. The specific configuration of the standby position sensor 138 is not limited to the configuration described above.

As illustrated in FIG. 36A and FIG. 36B, the conveyance path inside the post-processing apparatus 3A is defined by an upper guide plate 5a and a lower guide plate 5b, which are disposed away from each other in the thickness direction of the sheet P. The liquid application unit 140 is located at a position to face an opening of the upper guide plate 5a. In other words, the liquid application unit 140 is disposed to face the conveyance path (a position at which the liquid application unit 140 can face the sheet P) through the opening of the upper guide plate 5a.

As illustrated in FIG. 35A to FIG. 37C, the liquid application unit 140 includes a base 141, a rotary bracket 142, a liquid storage tank 143, a liquid-application-head mover 144, a holder 145, the liquid application head 146, columns 147a and 147b, a pressure plate 148, coil springs 149a and 149b, the application-head pivot motor 150, the application-head movement motor 151 (see FIG. 38), and a standby angle sensor 152 (see FIG. 38).

The base 141 is supported by the pair of guide shafts 133a and 133b so as to be slidable in the main scanning direction. The base 141 is coupled to the annular seamless belt 135 by the connection 135a. The base 141 supports the components 142 to 152 of the liquid application unit 140.

The rotary bracket 142 is attached to the lower face of the base 141 so as to be rotatable in both forward and reverse directions about a rotary shaft extending in the thickness direction of the sheet P. The rotary bracket 142 is rotated in both forward and reverse directions with respect to the base 141 by the driving force transmitted from the application-head pivot motor 150. The rotary bracket 142 retains the liquid storage tank 143, the liquid-application-head mover 144, the holder 145, the liquid application head 146, the columns 147a and 147b, the pressure plate 148, and the coil springs 149a and 149b.

The standby angle sensor 152, which is also illustrated in FIG. 38, detects that the rotary bracket 142 has reached a standby angle. The standby angle sensor 152 then outputs a standby angle signal indicating the detection result to the controller 100b. The standby angle is, for example, an angle at the time of performing parallel binding. The standby angle sensor 152 is, for example, an optical sensor including a light emitter and a light receiver. The rotary bracket 142 at the standby angle blocks an optical path between the light emitter and the light receiver. The standby angle sensor 152 outputs the standby angle signal in response to the light output from the light emitter not being received by the light receiver. However, the specific configuration of the standby angle sensor 152 is not limited to the above-described example.

FIG. 35A illustrates the rotary bracket 142 in a position for the parallel binding that is performed by the crimper 32′ disposed downstream from the liquid applier 131 in a direction in which the sheet P is conveyed. FIG. 35B illustrates the rotary bracket 142 in a position for the oblique binding (i.e., corner binding) that is performed by the crimper 32′ disposed downstream from the liquid applier 131 in the direction in which the sheet P is conveyed.

The liquid storage tank 143 stores liquid to be applied to the sheet P. The liquid-application-head mover 144 is attached to the liquid storage tank 143 so as to be movable (e.g., up and down) in the thickness direction of the sheet P. The liquid-application-head mover 144 moves with respect to the liquid storage tank 143 by a driving force transmitted from the application-head movement motor 151. The holder 145 is attached to a lower end of the liquid-application-head mover 144. The liquid application head 146 projects from the holder 145 toward the conveyance path (downward in the present embodiment). The liquid that is stored in the liquid storage tank 143 is supplied to the liquid application head 146. The liquid application head 146 is made of a material having a high liquid absorption (e.g., sponge or fiber).

The columns 147a and 147b project downward from the holder 145 around the liquid application head 146. The columns 147a and 147b can be moved relative to the holder 145 relatively in the thickness direction. The columns 147a and 147b hold the pressure plate 148 at lower ends thereof. The pressure plate 148 has a through hole 148a at a position to face the liquid application head 146. The coil springs 149a and 149b are fitted around the columns 147a and 147b, respectively, between the holder 145 and the pressure plate 148. The coil springs 149a and 149b bias the columns 147a and 147b and the pressure plate 148 downward with respect to the holder 145.

As illustrated in FIG. 36A and FIG. 37A, at the stage before the sheet P is conveyed to the position where the sheet P faces the opening of the upper guide plate 5a, the pressure plate 148 is positioned at or above the opening. Subsequently, when the sheet P that is conveyed by the conveyance roller pairs 10 and 11 stops at a position where the first liquid application position B1 on the sheet P faces the opening, the application-head movement motor 151 is rotated in a first direction. As a result, the liquid-application-head mover 144, the holder 145, the liquid application head 146, the columns 147a and 147b, the pressure plate 148, and the coil springs 149a and 149b move down together, and the pressure plate 148 contacts the sheet P. The first liquid application position B1 corresponds to the first binding position B1 to be crimped and bound by the edge binder 251, specifically, the crimper 32′.

As the application-head movement motor 151 keeps rotating in the first direction even after the pressure plate 148 contacts the sheet P, the coil springs 149a and 149b are compressed to further move down the liquid-application-head mover 144, the holder 145, the liquid application head 146, and the columns 147a and 147b. As a result, as illustrated in FIGS. 36B and 37B, a lower face of the liquid application head 146 contacts the sheet P through the through hole 148a. As a result, the liquid contained in the liquid application head 146 is applied to the sheet P.

Further rotation of the application-head movement motor 151 in the first direction further strongly presses the liquid application head 146 against the sheet P as illustrated in FIG. 36C and FIG. 37C. Accordingly, the amount of liquid applied to the sheet P increases. In short, the liquid applier 131 changes the pressing force of the liquid application head 146 against the sheet P to adjust the amount of liquid that is applied to the sheet P.

On the other hand, the rotation of the application-head movement motor 151 in the second direction opposite to the first direction moves up the liquid-application-head mover 144, the holder 145, the liquid application head 146, the columns 147a and 147b, the pressure plate 148, and the coil springs 149a and 149b together. As a result, as illustrated in FIGS. 36A and 37A, the liquid application head 146 and the pressure plate 148 are separated from the sheet P. In other words, the liquid applier 131 includes the liquid application head 146 that can be separated from the sheet P.

FIG. 38 is a block diagram illustrating a hardware configuration of the post-processing apparatus 3A to control the operation of the post-processing apparatus 3A according to the second embodiment.

As illustrated in FIG. 38, the post-processing apparatus 3A includes a central processing unit (CPU) 101, a random-access memory (RAM) 102, a read-only memory (ROM) 103, a hard disk drive (HDD) 104, and an interface (I/F) 105 that are connected to each other through a common bus 109.

The CPU 101 is an arithmetic device and controls the overall operation of the post-processing apparatus 3A. The RAM 102 is a volatile storage medium that allows high speed reading and writing of information, and is used as a working area when the CPU 101 processes information. The ROM 103 is a read-only non-volatile storage medium, and stores programs such as firmware. The HDD 104 is a nonvolatile data readable/writable memory and has a relatively large storage capacity. The HDD 104 stores, for example, an operating system (OS), various kinds of control programs, and application programs.

The post-processing apparatus 3 processes, by an arithmetic function of the CPU 101, e.g., a control program stored in the ROM 103 and an information processing program (or application program) loaded into the RAM 102 from a storage medium such as the HDD 104. With such processing, a software controller including various functional modules of the post-processing apparatus 3A is configured. The software controller thus configured is combined with hardware resources of the post-processing apparatus 3A mounted in the post-processing apparatus 3A to configure functional blocks that implement functions of the post-processing apparatus 3A. In other words, the CPU 101, the RAM 102, the ROM 103, the HDD 104, and the interface 105 constitute at least part of a controller 100b that is an example of a control device that controls the operation of the post-processing apparatus 3A.

The interface 105 is an interface that connects the conveyance roller pairs 10, 11, 14, and 15, the switching member 20, the side fences 24L and 24R, the crimper movement motor 238, the crimper pivot motor 239, a contact-separation motor 32d, a liquid-applier movement motor 137, an application-head pivot motor 150, an application-head movement motor 151, a standby position sensor 138, a standby angle sensor 152, a hole punch 132, and an operation panel 110 to the common bus 109.

The controller 100b controls, via the interface 105, the operations of the conveyance roller pairs 10, 11, 14, and 15, the switching member 20, the side fences 24L and 24R, the crimper movement motor 238, the crimper pivot motor 239, the contact-separation motor 32d, the liquid-applier movement motor 137, the application-head pivot motor 150, the application-head movement motor 151, and the hole punch 132. The controller 100b acquires detection results from the standby position sensor 138 and the standby angle sensor 152 through the interface 105.

Although FIG. 38 illustrates the components of the liquid applier 131 and the edge binder 251 (the crimper 32′) that executes the edge binding, the components of the saddle binder 28 that executes the saddle binding are controlled by the controller 100b like the components of the liquid applier 131 and the edge binder 251 (the crimper 32′) that executes the edge binding.

As illustrated in FIG. 40, the image forming apparatus 2 includes the operation panel 110. The operation panel 110 includes an operation section that receives an input operation from the user and a display serving (a notification unit) that notifies the user of information. The operation section includes, for example, hard keys and a touch screen overlaid on the display. The operation panel 110 acquires information from the user through the operation section and provides information to the user through the display. The post-processing apparatus 3A may include an operation panel 110 similar to the above-described operation panel 110 of the image forming apparatus 2.

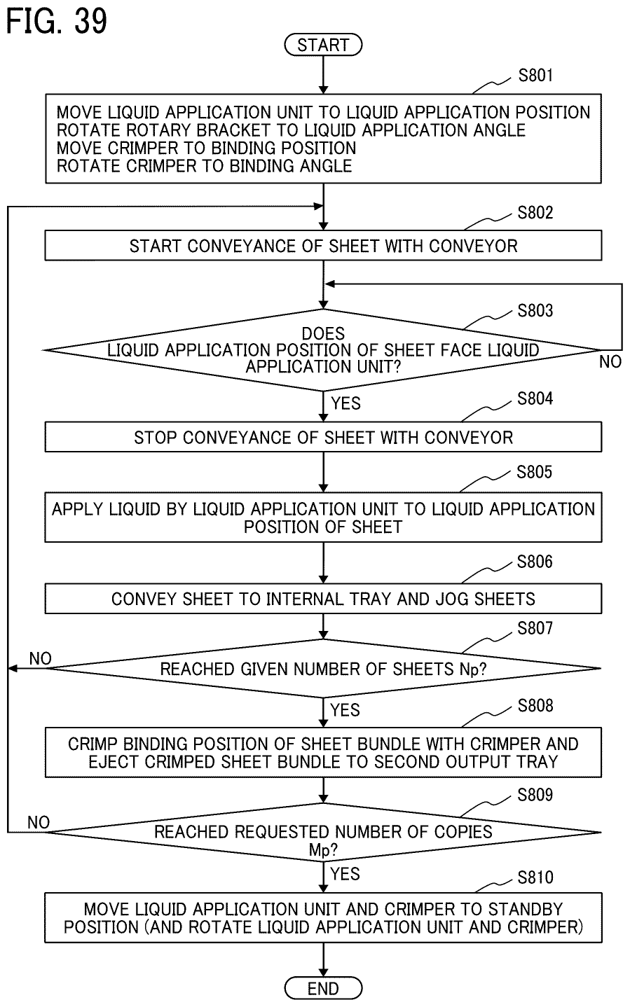

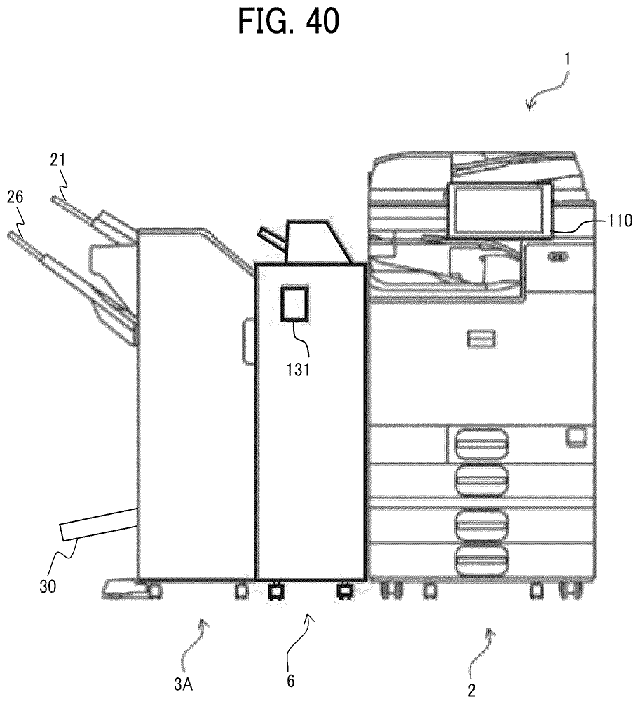

FIG. 39 is a flowchart of post-processing performed by the post-processing apparatus 3A according to the second embodiment.

More specifically, FIG. 39 is a flowchart of a process to execute the one-point binding illustrated in FIG. 33A to FIG. 33C.

For example, the controller 100b executes the post-processing illustrated in FIG. 39 in response to acquisition of an instruction (denoted below as “post-processing command”) of executing the post-processing from the image forming apparatus 2. The post-processing command includes, for example, the number of sheets P of the sheet bundle Pb, which may be referred to as a given number of sheets Np in the following description), the number of sheet bundles Pb to be subjected to binding, the first binding position B1 (corresponding to the first liquid application position B1), the angle of the first binding position B1 (corresponding to the angle of the first liquid application position B1), the type of binding (parallel binding or oblique binding), and a process that is executed in parallel with the liquid application process (i.e., punching a hole in the present embodiment). In the following description, the number of sheets P of the sheet bundle Pb may be referred to as a given number of sheets Np, and the number of sheet bundles Pb to be subjected to binding may be referred to as a requested number of copies Mp. At the start of the post-processing, the liquid application unit 140 is at the standby position HP1 illustrated in FIG. 35A and FIG. 35B, and the rotary bracket 142 is held at the standby angle (corresponding to the parallel binding posture) at the standby position HP1.

First, the controller 100b drives the liquid-applier movement motor 137 to move the liquid application unit 140 (corresponding to a liquid application device) in the main scanning direction, thus causing the liquid application head 146 to move from the standby position HP1 to the position where the liquid application head 146 can face the first liquid application position B1 (see FIG. 35B, the position corresponding to the first binding position B1 illustrated in FIG. 33B and FIG. 33C). If the type of the binding instructed by the post-processing command is oblique binding, in step S801, the controller 100b drives the application-head pivot motor 150 to rotate the rotary bracket 142. Thus, the liquid application head 146 is rotated from the standby angle to the liquid application angle corresponding to the “oblique binding posture.” It can be ascertained, based on pulse signals output from rotary encoders of the liquid-applier movement motor 137 and the application-head pivot motor 150, that the liquid application head 146 has reached the position where the liquid application head 146 can face the first liquid application position B1. If the type of the binding instructed by the post-processing command is parallel binding, the controller 100b omits the above-described operation of rotating the rotary bracket 142. In other words, the liquid application unit 140 moves in the main scanning direction while holding the rotary bracket 142 at the standby angle.

Further, in step S801, the controller 100b drives the crimper movement motor 238 to move the crimper 32′ from the standby position HP2 to the position where the crimper 32′ can face the first binding position B1 as illustrated in FIG. 33A and FIG. 33B. Alternatively, if the type of the binding instructed by the post-processing command is “oblique binding,” in step S801, the controller 100b drives the crimper pivot motor 239 to rotate the crimper 32′ from the standby angle to the crimping angle corresponding to the “oblique binding posture.” It is ascertained based on a pulse signal output from a rotary encoder of the crimper movement motor 238 that the crimper 32 has reached the position where the crimper 32 can face the first binding position B1. In a similar manner, it is ascertained based on a pulse signal output from a rotary encoder of the crimper pivot motor 239 that the crimper 32 has reached the crimp binding angle. If the type of the binding instructed by the post-processing command is “parallel binding,” the controller 100b omits the above-described operation of rotating the crimper 32′. In other words, the crimper 32′ moves in the main scanning direction while maintaining the standby angle.

In step S802, the controller 100b drives the conveyance roller pairs 10 and 11 to start conveying the sheet P on which an image is formed by the image forming apparatus 2. In step S803, the controller 100b determines whether the first liquid application position B1 on the sheet P faces first the liquid application unit 140 (more specifically, the liquid application head 146). In other words, the controller 100b determines whether the liquid application unit 140 has faced the first liquid application position B1 on the sheet P. When the first liquid application position B1 on the sheet P has not faced the liquid application unit 140 (NO in step S803), the controller 100b repeats the processing in step S803. In other words, the controller 100b continues driving the conveyance roller pairs 10 and 11 until the first liquid application position B1 on the sheet P faces the liquid application head 146 (YES in step S803). When the controller 100b determines that the first liquid application position B1 on the sheet P has faced the liquid application head 146 (YES in step S803), in step S804, the controller 100b causes the conveyance roller pairs 10 and 11 to stop conveying the sheet P. It is ascertained, based on a pulse signal output from a rotary encoder of a motor that drives the conveyance roller pairs 10 and 11, that the first liquid application position B1 on the sheet P has faced the liquid application head 146.

In step S805, the controller 100b causes the liquid application unit 140 to execute the process of applying liquid to the first liquid application position B1 on the sheet P. More specifically, the controller 100b rotates the application-head movement motor 151 in the first direction to bring the liquid application head 146 into contact with the first liquid application position B1 on the sheet P. The controller 100b changes the pressing force of the liquid application head 146 (i.e., the amount of rotation of the application-head movement motor 151) depending on the amount of liquid to be applied to the sheet P.

The amount of liquid that is applied to the sheet P may be the same for all the sheets P of the sheet bundle Pb or may be different for each sheet P. For example, the controller 100b may decrease the amount of liquid applied to a sheet P conveyed later. The amount of rotation of the application-head movement motor 151 can be ascertained based on a pulse signal output from a rotary encoder of the application-head movement motor 151.

In step S806, the controller 100b drives the conveyance roller pairs 10, 11, 14, and 15 to place a sheet P on the internal tray 22. In step S806, the controller 100b also moves the side fences 24L and 24R in the main scanning direction to align the position of the sheet P or the sheet bundle Pb placed on the internal tray 22 in the main scanning direction. In short, the controller 100b performs so-called jogging.

In step S807, the controller 100b determines whether the number of sheets P placed on the internal tray 22 has reached the given number of sheets Np indicated by the post-processing command. When the controller 100b determines that the number of sheets P placed on the internal tray 22 has not reached the given number of sheets Np (NO in step S807), the controller 100b executes the operations of steps S802 to S807 again until the number of sheets P placed on the internal tray 22 reaches the given number of sheets Np (YES in step S807).

By contrast, when the controller 100b determines that the number of the sheets P placed on the internal tray 22 has reached the given number of sheets Np (YES in step S807), in step S808, the controller 100b causes the crimper 32′ to crimp the binding position B1 (corresponding to the first liquid application position B1) on the sheet bundle Pb to which the liquid has been applied by the liquid application unit 140. In step S808, the controller 100b also rotates the conveyance roller pair 15 to eject the crimped sheet bundle Pb to the second output tray 26.

In step S809, the controller 100b determines whether the number of sheet bundles Pb thus ejected to the second output tray 26 has reached the requested number of copies Mp indicated by the post-processing command. When the controller 100b determines that the number of the sheet bundles Pb ejected to the second output tray 26 has not reached the requested number of copies Mp (NO in step S809), the controller 100b repeats the processing of steps S802 to S809 until the number of the sheet bundles Pb ejected to the second output tray 26 reaches the requested number of copies Mp (YES in step S809).

By contrast, when the controller 100b determines that the number of sheet bundles Pb ejected to the second output tray 26 reaches the requested number of copies Mp (YES in step S809), in step S810, the controller 100b drives the liquid-applier movement motor 137 to move the liquid application unit 140 to the standby position HP1 (see FIG. 35A and FIG. 35B) and drives the crimper movement motor 238 to move the crimper 32′ to the standby position HP2 (see FIG. 33A to FIG. 33C). When the posture that is instructed by the post-processing operation is the “oblique binding posture,” in step S810, the controller 100b drives the application-head pivot motor 150 and the crimper pivot motor 239 to rotate the liquid application unit 140 and crimper 32′ and the parallel binding posture (standby angle) into the parallel binding posture. By contrast, when the posture that is instructed by the post-processing command is the “parallel binding posture,” the controller 100b skips the aforementioned operation of rotating the liquid application unit 140 and the crimper 32′ to the parallel binding posture (standby angle). In steps S801 and S810, the execution order of the movement in the main scanning direction and the rotation in both forward and reverse directions of the liquid application unit 140 and the crimper 32′ is not limited to the aforementioned order and may be reversed.

The present disclosure can be applied to not only the edge binder 251 that executes edge binding but also to the saddle binder 28 that executes saddle stitching.

The controller 100b of the post-processing apparatus 3A according to the second embodiment illustrated in FIG. 32 is provided separately from the controller 100a of the image forming apparatus 2 as in the configuration of FIG. 1. However, no limitation is indicated thereby. For example, as illustrated in FIG. 41A, the controller 100b of the post-processing apparatus 3A may be disposed in the image forming apparatus 2. Further, as in the configuration of FIG. 41B, the controller 100b of the post-processing apparatus 3A may be integrated with the controller 100a of the image forming apparatus 2.

In a similar manner to FIG. 42A, the controller 100b of the post-processing apparatus 3A may be divided into a controller 100b1 (e.g., a driver system such as a motor) and a controller 100b2 (a sensor system such as a sensor) according to the function, and the controller 100b2 of the post-processing apparatus 3A may be disposed in the image forming apparatus 2. Further, as in the configuration of FIG. 42B, the controller 100b2 of the post-processing apparatus 3A disposed in the image forming apparatus 2 may be integrated with the controller 100a of the image forming apparatus 2.

As described above, the control method by the controller 100b described above is implemented by cooperation between hardware resources of a computer and a program as computer software. In other words, the control method may be executed by causing an arithmetic device, a storage device, an input device, an output device, and a control device to operate in cooperation with each other based on a program. The program may be written in, for example, a storage device or a storage medium and distributed with the storage device or the storage medium, or may be distributed through, for example, an electric communication line.

The above-described embodiments are illustrative and do not limit the present disclosure. Thus, numerous additional modifications and variations are possible in light of the above teachings. For example, elements and/or features of different illustrative embodiments may be combined with each other and/or substituted for each other within the scope of the present disclosure. It is therefore to be understood that the above-described embodiments of the present disclosure may be practiced otherwise by those skilled in the art than as specifically described herein. Such modifications are included in the technical scope described in the scope of claims.

As described above, with the medium processing apparatus according to the embodiments of the present disclosure, the number of times binding is performed for one sheet bundle Pb can be changed depending on the type or kind of post-processing, and the binding force or binding strength and the speed of binding, which corresponds to the productivity, can be adjusted to have a desired value depending on the type of binding. Accordingly, the customer convenience and the productivity of binding increase.

### ASPECTS

Aspects of the present disclosure are, for example, as follows.

### First Aspect

A medium processing apparatus applies liquid to a sheet medium and perform given processing on a medium bundle including at least one medium to which liquid has been applied. The medium processing apparatus includes a liquid application member to contact the medium to apply liquid to the medium, a movement mechanism to move the liquid application member close to or away from the medium, and a liquid-application sensor to determine whether the liquid application member has passed through a given detection area when the liquid application member is moved close to or away from the medium. When the liquid application member is moved close to the medium, the movement mechanism moves the liquid application member at a first speed to get close to the medium after the liquid application member has passed through the detection area, and moves the liquid application member at a second speed slower than the first speed to get close to the medium until the liquid application member passes through the detection area.

### Second Aspect

In the medium processing apparatus according to the first aspect, the movement mechanism maintains the speed of the liquid application member at the second speed after the liquid application member has reached the detection area of the liquid-application sensor and until the liquid-application sensor detects that the liquid application member has passed through the detection area.

### Third Aspect

In the medium processing apparatus according to the first or second aspect, the movement mechanism moves the liquid application member at the first speed toward the medium by a given distance after the liquid-application sensor detects that the liquid application member has passed through the detection area.

### Fourth Aspect

In the medium processing apparatus according to any one of the first to third aspects, the movement mechanism controls movement of the liquid application member for the liquid application member to keep contacting the medium for given time.

### Fifth Aspect

In the medium processing apparatus according to any one of the first to fourth aspects, the movement mechanism moves the liquid application member at the first speed, and changes speed to a third speed slower than the first speed before the liquid application member contacts the medium.

### Sixth Aspect

In the medium processing apparatus according to any one of the first to fifth aspects, the liquid application member is at a first standby position before the liquid is to be applied to the medium, and the movement mechanism starts moving the liquid application member from a second standby position closer to the medium than the first standby position.

### Seventh Aspect

In the medium processing apparatus according to any one of the first to sixth aspects, the movement mechanism adjusts a moving distance to make the liquid application member contact the medium based on a number of a plurality of media that make up the medium bundle including the at least one medium to which the liquid has been applied.

### Eighth Aspect

An image forming system includes an image forming apparatus to form an image on a medium, and the medium processing apparatus according to any one of the first to seventh aspects to perform the given processing on the medium on which the image is formed by the image forming apparatus.

Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a compact disc-read-only memory (CD-ROM) or a digital versatile disk (DVD), and/or the memory of an FPGA or ASIC.

What is claimed is:

1. A medium processing apparatus comprising:
a liquid application member to contact a medium to apply liquid to the medium;
a movement mechanism to move the liquid application member close to or away from the medium; and
a liquid-application sensor to determine whether the liquid application member has passed through a detection area of the liquid-application sensor when the liquid application member is moved close to or away from the medium,
wherein when the liquid application member is moved close to the medium, the conveyor
moves the liquid application member at a first speed to get close to the medium after the liquid application member has passed through the detection area, and
moves the liquid application member at a second speed slower than the first speed to get close to the medium until the liquid application member passes through the detection area.

2. The medium processing apparatus according to claim 1,
wherein the movement mechanism maintains the second speed of the liquid application member after the liquid application member has reached the detection area of the liquid-application sensor and until the liquid-application sensor detects that the liquid application member has passed through the detection area.

3. The medium processing apparatus according to claim 1,
wherein the movement mechanism moves the liquid application member at the first speed toward the medium by a given distance after the liquid-application sensor detects that the liquid application member has passed through the detection area.

4. The medium processing apparatus according to claim 1,
wherein the movement mechanism controls movement of the liquid application member for the liquid application member to keep contacting the medium for given time.

5. The medium processing apparatus according to claim 1,
wherein the conveyor
moves the liquid application member at the first speed, and
changes speed of the liquid application member to a third speed slower than the first speed before the liquid application member contacts the medium.

6. The medium processing apparatus according to claim 1,
wherein the liquid application member is at a first standby position before the liquid is to be applied to the medium, and
wherein the movement mechanism starts moving the liquid application member from a second standby position closer to the medium than the first standby position.

7. The medium processing apparatus according to claim 1,
wherein the movement mechanism adjusts a moving distance to make the liquid application member contact the medium based on a number of a plurality of media that make up a medium bundle including the medium to which the liquid has been applied.

8. An image forming system comprising:
an image forming apparatus to form an image on a medium; and
the medium processing apparatus according to claim 1 to perform given processing on the medium on which the image is formed by the image forming apparatus.
